(19) United States
(12) Patent Application Publication
(10) Pub. No.: US 2004/0017355 A1
(43) Pub. Date: Jan. 29, 2004

(54) Cursor control systems and methods

(76) Inventor: Youngtack Shim, Sunnyvale, CA (US)

Correspondence Address: Eunmi Shim, c/o Youngtack Shim, 2433 Main Ave. No. H-1, North Port, AL, 35476, US

(21) Appl. No.: 10/383,480

(22) Filed: Mar. 7, 2003

Related U.S. Application Data
(60) Provisional application No. 60/398,643, filed on Jul. 24, 2002.

(51) Int. Cl. G09G 5/08

(52) U.S. Cl. 345/157

(57) ABSTRACT

The present invention relates to cursor control systems and methods therefore for providing coarse and fine control in positioning cursors used on display screens of display units for information processing devices. In particular, the cursor control systems and related methods allow the user to move the cursor to a vicinity of a target position at a fast speed through an initial coarse maneuver, and then to precisely position the cursor in the target position at a slow or manual speed through a subsequent fine maneuver. An exemplary cursor control system typically includes a body, at least one fine controller, and at least one coarse controller. In general, the fine controller couples with the body, receives a first input signal from the user, and moves the cursor at the slow or manual speed as determined by the first input signal, while the coarse controller couples with the body, receives a second input signal from the user independently of the first input signal, and moves the cursor at the fast speed. Another exemplary cursor control system typically includes a cursor controller and an adjustor. In general, the cursor controller receive a first input signal from the user and generate an original output signal in response to the first input signal, while the adjustor has at least two settings, receives the original output signal from the cursor controller, receives a second input signal from the user independently of the first input signal to select one of the settings, processes the original output signal based on one of the settings selected by the user, and generates a final output signal based on the original output signal and the setting selected by the user. The information processing device receives the final output signal from the adjustor and moves the cursor on the display screen at the fast speed or at the slow or manual speed based on the final output signal.

This application claims the benefit of an earlier filing date of a U.S. Provisional Application bearing Serial No. 60/398,643, entitled “Cursor Control Systems and Methods” which was filed on Jul. 24, 2002.

### FIELD OF THE INVENTION

The present invention generally relates to various cursor control systems capable of moving a pointer or a cursor defined on a display screen of an information processing device effectively to a target position defined on the display screen. More particularly, such cursor control systems may be provided with multiple cursor controllers for moving the cursor at different speeds or with an adjustor for setting different ranges of the speeds of the cursor so that an user can advantageously move the cursor coarsely or roughly to a vicinity of the target position at a faster speed (i.e., coarse controlling) and then to precisely position the cursor in the target position at a slower speed (i.e., fine controlling). The cursor control systems and methods therefor of this invention may advantageously configure the cursor controller to control movement patterns of the cursor as well. Furthermore, the cursor control systems and methods therefor of this invention allow the user to directly and physically access such cursor controllers and/or adjustor and apply separate input signals thereto independently. Therefore, the user can advantageously manipulate the speed of the cursor and/or the movement pattern of the cursor at least substantially independently. Various exemplary aspects and/or embodiments of such cursor control systems and methods therefor of the present invention are provided hereinafter in reference to accompanied figures.

### BACKROUND OF THE INVENTION

With the advent of computer hardware and software technology, a massive amount of digital information (or data) may be processed rapidly by various digital information processing devices. In order to facilitate handling or manipulation of huge information, such information processing devices employ various display units such that an user can select desirable information displayed on screens thereof. FIG. 1 is a schematic view of a conventional display screen with graphical objects displayed thereon, where a rectangular domain 10 of the figure generally represents a display screen having a preset length and a preset height which is typically less than the length. Such a screen 10 is used to display information provided to, stored in, and/or processed by digital information processing devices examples of which may include, but not limited to, computers and other electronic, electrical, and/or optical devices each of which may be equipped with integrated circuits, microchips, optical chips or biological chips capable of performing digital signal processing of such information. The information processing devices also employ various display units to display such information on screens thereof, where examples of such display units may include, but not necessarily limited to, cathode ray tubes (CRT's), active and/or passive matrix display devices, liquid crystal display devices (LCD's), plasma display panels (PDP's), projection display devices, and other display devices using technologies of electroluminescence, photoluminescence, and the like.

As shown in the figure, the display screen 10 is bordered by an upper edge 12U, a right edge 12R, a lower edge 12D, and a left edge 12L, where such edges intersect and form four corners such as, e.g., an upper-right corner 14UR, a lower-right corner 14DR, a lower-left corner 14DL, an upper-left corner 14UL, and so on. Such corners 14 can be formed at right angles or may also be rounded when desirable. Such an information processing device generally displays various graphical objects (or hot spots or commands) 16 on various locations on the screen 10. In order to facilitate handling and manipulation of such information, the information processing device generally employs a cursor emulating device capable of generating and displaying a pointer or a cursor 18 on the display screen 10. The information processing device further includes a cursor control device to allow the user to move the cursor 18 from a current cursor position D₁₀ (or D₃₀) to a target position 22 (e.g., D₂₀ such as on a boundary or edge of or inside a particular graphical object 16). After positioning the cursor 18 on the boundary or in the graphical object 16, the user selects the intended object (or command). By clicking or double clicking such an object, the user may perform an intended manipulation of such information.

Various conventional cursor control devices have been in use to move the cursors 18 to the target position 22, to select the intended graphical object (command or hot spot) 16, and to perform preset functions to manipulate the information, where examples of such conventional cursor control devices may include, but not necessarily limited to, mouse-type controllers, track ball-type controllers, touch pad-type controllers, joystick-type controllers (or similarly shaped track stick- or track rod-type controllers), disk-type controllers, arrow key-type controllers, and the like. Regardless of operating mechanisms of such cursor control devices, however, the user generally has to manipulate at least a part of such devices to move the cursor 18 at a non-optimal manual speed or at another non-optimal constant speed from the current cursor position to the new target position 22 along a target direction 24 and/or along a target path 26. Accordingly, the conventional cursor control devices suffer from a major drawback in that such devices do not allow the user to coarsely but reliably move the cursor 18 toward a vicinity of the desired target position 22 and then to precisely position the cursor 18 at desired target position 22.

For example, moving the cursor 18 by manipulating a set of conventional arrow keys such as an up-arrow key, a down-arrow key, a left-arrow key, and a right-arrow key is time-consuming and at best cumbersome. In addition, use of such arrow keys is generally limited to alphanumeric texts and not compatible with most graphic applications. Even when the user may use various arrow keys to move the cursor 18 vertically and/or horizontally (or at preset angles) in the text or between various graphical objects 16 displayed on the display screen 10, the user generally has to use multiple keys and/or to hit the same key several times. Accordingly, the arrow keys are no solution for effectively moving the cursor 18 on the display screen 10.

Conventional touch pad-type controllers can be applied to all graphic and text environments, where the user moves the cursor 18 across a sensing zone thereof in accordance with a movement of his or her finger along a target direction 24 and/or target path 26 at a desirable speed. The touch pads, however, suffer from their own limitations. For example, the touch pad is typically disposed in one part of a key board and its active sensing zone is restricted to an area which is generally smaller than the display screen 10. To maintain at least a minimal resolution, the active sensing zone of the touch pad is designed so that its entire zone functionally correspond to only a fraction of the display screen 10 such as, e.g., a subdomain 28 shown in FIG. 1. Accordingly, the movement of the user's finger across a diagonal of the sensing zone of the touch pad effects the movement of the cursor 18 across a diagonal of only the subdomain 28 such as, e.g., from a current position, D₁₀, to an interim position, D₁₁. When the target position 22 is positioned far away from the interim position, D₁₁, the user generally has to apply another finger stroke by, e.g., taking off his or her finger from the upper left corner of the sensing zone, repositioning his or her finger in a center or in a lower right corner of the sensing zone, and then moving the finger again across the sensing zone in order to fine control the movement of the cursor 18 along the target direction 24 and/or target path 26 toward the target position 22. Moving the cursor 18 by applying multiple finger strokes is not only cumbersome but also time-consuming. In addition, by having to apply multiple strokes, the user tends to be distracted from accurately positioning the cursor 18 in the target position 22 and, therefore, may end up moving his or her finger more than twice. Furthermore, the touch pad is provided with a fixed resolution so that the movement of the user's finger along a given distance on the sensing zone of the touch pad effects the movement of the cursor along a preset distance on the display screen 10. In many cases, such a fixed resolution may be too coarse for a precise or fine control of the cursor 18 and may be too high for a coarse control of the cursor 18. Conventional track ball-type controllers which include rollable balls and translate rotational movement of the balls into the cursor movements also suffer from the limitations similar to those of the touch pad-type controllers, i.e., the user has to rotate such a rotatable ball at least a few times when the user has to move the cursor 18 along greater distances on the display screen 10.

Conventional mouse-type controllers can also be used in the graphic and text environments, where the user manually moves the cursor 18 on the display screen 10 by moving such mouses in the target direction 24 and/or along the target path 26 at a desirable manual speed selected by the user. Accordingly, when the cursor has to be moved along a greater distance on the display screen 10, the user has to displace the mouse along another greater distance at a manually selected speed. Because such mouses require work spaces next to the information processing devices, they may not be readily applied when the information processing devices are used in a tight space. Such mouses also find limited applications with portable information processing devices and/or wireless keyboards which frequently have to be used when there are no work spaces available therearound. In addition, the mouses are provided at a preset resolution such that the movement of the mouse along a given distance on a surface effects the movement of the cursor 18 along a preset distance on the display screen 10. Therefore, when the cursor 18 has to be moved along a greater distance on the display screen 10, the user frequently has to generate multiple movement of the mouses, e.g., moving the mouse from one end to an opposite end of the available work space, lifting up and repositioning the mouse the mouse in the work space, and then moving the mouse again so as to effect the desired movement of the cursor 18 on the display screen 10. As discussed herein, the user may be easily distracted while generating multiple movements of the mouse and have to move the mouse at least a few times to precisely position the cursor 18 in the target position 22 on the display screen 10. In addition, regardless of the operating mechanisms of the mouses (e.g., conventional ball mouses or optical wireless mouses), they generally have to be oriented at certain angles during each of such movements to move the cursor 18 along the intended target direction 24 and/or target path 26. The current mouses, therefore, cannot solve the foregoing problems either.

Conventional joystick-type controllers and similarly shaped track stick- and/or track rod-type controllers may also be used to move the cursor 18 in the text and graphical environments. Contrary to the above key-type, touch pad-type, track ball-type, and mouse-type controllers, the joystick-type controllers allow the user to move the cursor 18 at a constant or variable preset speed in the target direction 24 and/or along the target path 26. The user simply has to rotate, swivel or tilt handles of the joysticks toward intended directions, and the cursor 18 moves at the constant or variable speed in a corresponding direction on the display screen 10. As the cursor 18 approaches the vicinity of the target position 22, the user may swivel the handle of the joystick to correct or to fine control the direction of the cursor movement and to precisely position the cursor 18 at the target position 22 on the display screen 10. Examples of such joysticks and/or similarly operating pointing devices may include, but not necessarily be limited to, conventional joysticks specifically designed for numerous videogames, TrackPoint® pointing devices generally incorporated into middle portions of keyboards and available from IBM (White Plains, N.Y.), track disks and/or pressure-sensitive pads designed to be pushed down or to be swiveled around 360°, and so on. However, the joysticks also suffer from their own limitations. For example, many joysticks allow the user to move the cursor 18 only at the preset constant speed regardless of the distance of the cursor 18 to travel on the display screen 10. Therefore, the user may have to hold the handle of the joystick for an extended period of time when the cursor 18 has to be positioned to the target position 22 which is located at an opposite corner of the current position, D₁₀. In other circumstances, the preset speed of the cursor 18 may be too fast for the user to precisely position (i.e., fine control) of the cursor 18 on the display screen 10 or when the user has to navigate the cursor 18 through a host of tiny graphical objects thereon.

The prior art does provide various joysticks and swivel disks or spheres each of which allows the user to select desirable speeds of the cursor movement on the display screen 10. An exemplary variable-speed disk-type cursor control device has been disclosed in U.S. Pat. No. 5,432,530 issued to Arita et al. in July 1995 and assigned to Fujitsu Limited (Kawasaki, Japan). The disk-type cursor controller typically includes a position control means to move the cursor 18 on the display screen, a speed control means to control a speed of a movement of the cursor 18, and a switching means to switch an operation mode between a position control mode and a speed control mode. The position control means is arranged to be movable within a stationary case, whereas the switching means is circularly disposed around the movable position control means so that the switching means activates the speed control means when the movable position control means moves beyond a preset range and contacts the switching means. Therefore, the user can move the curser 18 at a fast speed on the display screen 10. However, the disk-type controller suffers from its design limitation in that the user can move the cursor at the fast speed only after he or she displaces the movable positioning means along a preset distance. Accordingly, it is impossible for the user to initially move the cursor at a fast speed without having to move the cursor at a slow speed for some distance. Furthermore, because the disk-type controller does not allow independent access to each of the position control mode and the speed control mode, the user can engage in only one of the modes at a time and may not reap the benefits of controlling the position and speed in any order. Similarly, the variable-speed joystick-type controllers have been disclosed in U.S. Pat. No. 6,404,323 B1 issued to Schrum et al. in June 2002, U.S. Pat. No. 6,313,826 B1 issued to Schrum et al. in November 2001, and U.S. Pat. No. 6,256,012 B1 issued to Devolpi in July 2001, all of which are assigned to Varatouch Technology Inc. (Sacramento, Calif.). Such variable-speed joystick-type controllers typically include a stick and a conductive elastic member disposed thereunder. As the user applies an external force to the stick, the conductive elastic member begins to deform and to change its contact area with the stick and its electrical resistance, thereby generating a set of signals each denoting a directions of the movement of the cursor 18 and a speed of such movement on the display screen 10, respectively. Although the variable-speed joystick-type controllers allow the user to control the positioning and speed of the cursor 18, its limitation stems from the very fact that a single medium such as the conductive elastic member, determines both the movement direction and speed at the same time. Accordingly, it is not feasible for the user to control the movements of the cursor 18 and the speeds of such movements in any arbitrary order and to control both the movements and the speeds simultaneously. It is noted that the foregoing U.S. patents are incorporated herein by reference in their entirety.

The prior art also provides cursor emulating softwares controlling various operational aspects of the cursor 18 such as, e.g., a cursor shape, a cursor speed on the display screen 18, a sensitivity of the cursor movement, and the like. However, such a software is generally provided as a program in a host of other programs stored in a control panel of an operating system of the computers. Thus, when the user desires to change the cursor speed, e.g., from a normal, slow speed to a coarse, fast speed, he or she has to access the cursor emulating software by navigating through a host of files or folders by moving the cursor and by selecting desirable files or commands displayed on the display screen 10. When the user subsequently desires to switch the cursor speed back to its normal, slow speed, the user has to go through the files or commands by moving the cursor 18 again. Therefore, the cursor emulating software cannot provide a solution to the user who wants to readily change the cursor speed from the normal, slow speed to the coarse, fast speed and vice versa.

Therefore, there is a need for cursor control systems and methods therefor enabling the user to quickly move the cursor to a vicinity of the target position through an initial coarse maneuver and to precisely position the cursor in such a target position through a subsequent fine maneuver. More particularly, there is a need to provide cursor control systems and related methods to allow the user to control the movements of the cursor and the speeds thereof in any arbitrary sequence as well as to enable the user to control both of the cursor movements and the cursor speeds independently, separately, and/or simultaneously.

### SUMMARY OF THE INVENTION

The present invention generally relates to various exemplary aspects and/or embodiments of cursor control systems and methods therefor to provide coarse and fine control in positioning cursors or pointers used on display screens of display units of various information processing devices. More particularly, such cursor control systems and related methods allow the user to quickly move such a cursor to the vicinity of the target point through an initial coarse control, and to precisely position the cursor in the target position through a subsequent fine control. As will be described in greater detail below, the cursor control systems and methods therefor of this invention may advantageously allow the user to selectively move the cursor at various (e.g., normal, fast, faster, slow, slower or adaptive) speeds on the display screen so that he or she can move and position the cursor to and in the target position without having to apply multiple movements or strokes of his or her finger. Accordingly, the cursor control systems and related methods of this invention allow the user to effectively control the movement, speed, and/or positioning of the cursor on the display screens of the display units of any information processing devices. Furthermore, such cursor control systems and methods therefor of this invention may advantageously allow the user to control the movement, speed, and positioning of the cursor independently, i.e., separately, in any desirable order, and/or simultaneously. The cursor control systems and methods therefor of the present invention may be realized by numerous aspects and embodiments thereof, where some exemplary aspects and embodiments of such cursor control systems and related methods are to be provided hereinafter in reference to accompanied figures.

In one aspect of the present invention, an exemplary cursor control system may be provided to move at least one cursor at multiple speeds along a target path to a target position, where the cursor, target path, and target position are defined on a display screen defined on a display unit of an information processing device, and where the target position and target path are selected on the display screen by an user of the information processing device. Such a cursor control system may include at least one cursor controller and at least one adjustor. The cursor controller is arranged to receive at least one first input signal from the user and to generate at least one original output signal in response to the first input signal. The adjustor is arranged to have at least two settings, to receive the original output signal from the cursor controller, to receive at least one second input signal which is provided by the user independently from the first input signal so as to select one of the settings, to process the original output signal at least partly based on the one of the foregoing settings selected by the user, and then to generate at least one final output signal at least partly based on the original output signal and the one of such settings selected by the user. The information processing device is arranged to receive the final output signal from the adjustor and to move the cursor on the display screen at one of the of speeds based on the final output signal.

The cursor control system according to such an aspect of the present invention offers various benefits over the prior art. First of all, unlike the conventional cursor emulating software, the cursor control system of the present invention employs the adjustor which is provided as a hardware which is directly and physically accessible by the user. Therefore, the user can manipulate the hardware instead of the software to control the speed of the cursor, e.g., by selecting one of the settings of the adjustor and moving the cursor at the speed accordingly. Secondly, the cursor control system of the present invention also provides the adjustor separately from the cursor controller. Accordingly, such an user can manipulate the cursor controller to move the cursor and can select one of the settings of the adjustor to control the speed of the cursor in any desirable order. Such an user may first select the coarse setting of the adjustor and coarsely move the cursor to the vicinity of the target position, and then select the fine setting of the adjustor and precisely position the cursor in the target position. The user may also change the adjustor settings and move the cursor by the cursor controller at least substantially simultaneously. In addition, contrary to the disk-shaped cursor controllers such as the one disclosed in the above U.S. Pat. No. 5,432,530, the user can directly and physically manipulate the adjustor independently of the cursor controller. Therefore, the user can switch the settings of the adjustor without having to maneuver (e.g., move, press, rotate or swivel) the cursor controller at all. Furthermore, by operatively and functionally separating the cursor controller for moving the cursor from the adjustor for selecting the cursor speed, the cursor control system of the present invention provides the user with greater a flexibility and precision in controlling the cursor movement and the cursor speed.

Exemplary embodiments of such an aspect of the present invention may include one or more of the following features.

The information processing device may include, e.g., a microprocessor, an integrated circuit, an optical processor, a biological processor, and the like, each of which may be arranged to process various digital and/or analog information. Examples of such an information processing device may include, but not necessarily be limited to, a computer, an electronic game device, a personal digital or data assistant, a communication device, an audio-visual device, a global positioning device, an automation device, a security device, an industrial control device, an automotive control device, a scientific analytical device, a camera, a camcorder, and a consumer electric device, each of which operatively couples with the display unit including the display screen defining the cursor thereon. In addition, such a computer may include, e.g., a desk-top computer, a portable computer, and a handheld computer which may have at least one telecommunication unit which may in turn include, e.g., an audio communication unit and a video communication unit. Examples of such a display unit may include, but not limited to, a liquid crystal display device, an active matrix display device, a passive matrix display device, an inorganic light emitting device, an organic light emitting device, a projection device, a plasma display device, a multi-dimensional virtual display device, an electroluminescence display device, a photoluminescence display device, a photoelectroluminescence display device, and the like, each of which includes at least one display screen thereon.

The target path may be a curvilinear route which connects a current position of the cursor on the display screen to the target position of the cursor on the display screen. Such a route may be a vector which starts from the current position and pointing toward the target position or may include at least one horizontal unit path and/or at least one vertical unit path each defined on the above display screen. Such a route may have a shape of a staircase or may include at least one curved section therealong.

The cursor controller may be any conventional cursor controllers such as, e.g., a mouse-type controller, a touch pad-type controller, a track ball-type controller, a joystick-type controller, a disk-type controller, a key-type controller, other less-frequently used cursor controllers, and so on. When the cursor controller is the mouse-type controller, the first input signal is a movement of the mouse effected by the user. When the cursor controller is the touch pad-type controller with a sensing zone, the first input signal is a movement of a body part of the user on the sensing zone such as, e.g., a tip of a finger of the user. When the cursor controller is the track ball-type controller with a rotatable ball, the first input signal is a rotation of such a ball effected by the user. When the cursor controller is the joystick-type controller having a handle, the first input signal is a movement of the handle effected by the user. When the cursor controller is the disk-type controller having a disk, the first input signal is a movement of the disk effected by the user. When the cursor controller is the key-type controller, the first input signal is a depression of the key effected by the user.

Such an adjustor may be spatially disposed in various ways in relation to the cursor controller. For example, the adjustor may be spaced apart from, adjacent to or around at least a portion of the cursor controller. The adjustor may also be disposed within, underneath, below, on or over at least a portion of the cursor controller. Alternatively, the adjustor and cursor controller may be contiguously disposed to form an unitary article.

The adjustor may also include at least one sensor arranged to detect the second input signal applied by the user. When the sensor does not detect the second input signal, the adjustor may be arranged to be in an inactive setting and to generate the final output signal which is unaugmented and which is, therefore, at least substantially identical to the original output signal. When the sensor does detect the second input signal, the adjustor may then be arranged to be in an active setting and to generate the final output signal which is augmented compared with the original output signal. The information processing device may be arranged to move the cursor at a slow speed in response to the unaugmented final output signal and arranged to move the cursor at a fast speed in response to the augmented final output signal. Examples of such a second input signal may include a movement of at least a portion of the adjustor, a mechanical, electrical, and/or magnetic contact with the portion of the adjustor, an external force applied to the portion of the adjustor, a deformation of the portion of the adjustor, a change in a mechanical, chemical, electrical, magnetic, and/or optical property of the portion of the adjustor, a presence or an absence of an article adjacent to the portion of the adjustor, a displacement, speed, and/or acceleration of the movement, light rays impinging upon the portion of the adjustor, and so on. Such a movement may be a horizontal, lateral, and/or a vertical movement thereof, while such a force may be a horizontal, lateral, and vertical force. The user may apply to the adjustor the second input signal by, e.g., moving, translating, displacing, rotating, turning, swiveling, touching, tilting, tapping, pressing, pushing, dragging, clicking, and/or holding at least a portion of the adjustor. Examples of the sensors capable of detecting such a second input signal may include, but not limited to, force sensors, displacement sensors, speed meters, accelerometers, motion sensors, voltage sensors, current sensors, magnetic sensors, variable resistors and sensors for measuring such resistances, variable capacitors and sensors for measuring such capacitances, photodetectors, torque sensors, and the like.

The slow speed may be a preset constant speed or a manual variable speed effected by the user. When the slow speed is the preset constant speed, the fast speed may be arranged to be at least twice, three times, five times, or ten times as fast as the slow speed. When the slow speed is the manual variable speed, a nominal value thereof may be defined as a nominal speed to move the cursor from a current position of the cursor near a lower right corner of the display screen precisely to the target position near an upper left corner of the display screen using the cursor controller in the inactive setting, and the fast speed may be arranged to be at least twice, three times, five times, and ten times as fast as the nominal speed of the slow speed.

The adjustor may also be arranged to adjust a movement pattern of the cursor on the display screen. The adjustor may augment the original output signal to the augmented final output signal to a preset extent so that the information processing device may move the cursor at a preset constant fast speed, regardless of a period of time during which the input signal may be applied to the sensor. In the alternative, the adjustor may augment the original output signal to the augmented final output signal to an extent enough to move the cursor to one of edges, corners, and/or inner positions of the display screen within a preset duration which may be less than one second, 500 milliseconds, 200 milliseconds, 100 milliseconds, and the like. The adjustor may augment the original output signal to the augmented final output signal in proportion to a period of time during which the input signal may be applied to the sensor. Such an adjustor may augment the original output signal continuously or incrementally in proportion to the period of time.

At least one sensor of the adjustor may be arranged to be stationary with respect to the body. Such a sensor may engage the adjustor into the active setting upon detecting a body part of the user therearound and engage the adjustor into the inactive setting (i.e., disengage from the active setting) upon detecting an absence of the body part. When a variable capacitor may be used as the sensor, the second input signal may a change in an electrical capacity of the sensor. When the sensor is a force sensor, the second input signal is an external force applied to the sensor. When the adjustor includes a light source emitting light rays, the sensor is a photodetector and the second input signal is the light rays which are reflected to the sensor.

The adjustor may be arranged to be in an inactive setting when the second input signal is not applied thereto, while the adjustor may be arranged to be in an active setting when the second input signal is applied thereto. The information processing device may be arranged to move the cursor at a slow speed in the inactive setting and at a fast speed in the active setting. In one embodiment, the adjustor may include at least one elastic unit arranged to recoil at least a portion of the adjustor from the active setting to the inactive setting and to bias the portion of the adjustor to the inactive setting. Such an adjustor may include a single knob arranged to be elevated in one of the inactive and active settings and to be depressed in the other of such settings. The adjustor may alternatively include a single knob arranged to be pushed in one direction to switch to the active setting and to recoil back to the inactive setting upon being released. The adjustor may also include at least one viscous unit arranged to provide a viscous friction to a movement of the adjustor between the active and inactive settings. As disclosed above, the adjustor may also be arranged to adjust the movement pattern of the cursor on the display screen. In another embodiment, the adjustor may be arranged to move from one to the other of the inactive and active settings upon being moved, pushed, pressed, rotated or otherwise displaced by the user. For example, the adjustor may include a toggle knob arranged to be biased to one position in the inactive setting and to be biased to another position in the active setting or may include two knobs arranged to be biased in an alternating mode in each of the above inactive and active settings. The adjustor may alternatively include a knob arranged to be rotated in an alternating mode to each of the inactive and active settings. Such an adjustor may also adjust the movement pattern of the cursor on the display screen.

The adjustor may be arranged to move between the foregoing inactive setting, active setting, and at least one subactive setting. Such an adjustor may generate the final output signal which is unaugmented and at least substantially identical to the original output signal in the inactive setting, which is augmented than the original output signal in the active setting, and which is attenuated than the original output signal in the subactive setting. The information processing device may move the cursor at a fast speed, a slow speed, and a slower speed when the adjustor is in the active setting, the inactive setting, and the subactive setting, respectively. The adjustor may include at least one elastic unit arranged to recoil the adjustor from each of the attenuating and augmenting settings to the inactive setting and then to bias the adjustor to the inactive setting. The adjustor may include a single knob arranged to be elevated in one of the active and subactive settings, to be depressed in the other of the active and subactive setting, and to be in an intermediate elevation in the inactive setting. The adjustor may include a single knob arranged to be pushed in a first direction to move to the active setting, to be pushed in a second direction to move to the subactive setting, and to recoil back to the inactive setting upon being released. The adjustor may also be arranged to move from one to the other of the active, inactive, and subactive settings only upon being moved by the user. The adjustor may include a toggle knob arranged to be biased to each of a first position, a second position, and a third position in each of the active, inactive, and subactive settings, respectively. In the alternative, the adjustor may include three toggle knobs arranged to be biased in an alternating mode in each of the active, inactive, and subactive settings. The adjustor may also include a switch arranged to be rotated in an alternating mode to each of the active, inactive, and subactive settings. In addition, such an adjustor is arranged to adjust a movement pattern of the cursor on the display screen.

When the adjustor is arranged to be moved between at least one inactive setting and at least one active setting, the original output signal may be arranged to have an original number of pulses of, e.g., electrical currents and voltages. The adjustor in its inactive setting may be arranged to not alter the original output signal, to generate the final output signal which is at least substantially identical to the original output signal, and then to allow the information processing device to move the cursor at a slow speed on the display screen. In contrary, the adjustor in its active setting may be arranged to modulate a number of the pulses, amplitudes of the pulses, and/or frequencies of such pulses of the original output signal, to generate the final output signal which is preferably different from the original output signal, and then to allow the information processing device to move the cursor at a fast speed on the display screen. Such an adjustor may modulate the original output signal, e.g., by adding an augmenting number of the pulses thereto, and to generate the final output signal which includes the augmenting number of the pulses in addition to the original number therein and/or by multiplying an augmenting factor thereto and to generate the final output signal having a total number of the pulses which equals to a product of the original number and augmenting factor. The augmenting number and/or the augmenting factor may be a preset constant. In the alternative, the augmenting number and/or the augmenting factor may be arranged to be variable and to be determined at least partly by at least one feature of the second input signal which may include, but not necessarily be limited to, a magnitude of an external force applied to at least a portion of the adjustor, a direction of the force, a first duration of the force, a number of applications of the force, a gap between such applications of the force, a presence and/or absence of a contact between the user and the portion of the adjustor, an area of the contact, a second duration during of the contact, a displacement from a movement of the portion of the adjustor, a speed of the movement, an acceleration of the movement, a direction of the movement, a duration of the movement, a deformation of the portion of the adjustor, an electrical, mechanical, chemical, magnetic, and optical property of the portion of the adjustor, a change in such a property of the portion of the adjustor, a presence and/or an absence of an article adjacent to the portion of the adjustor, light rays or electromagnetic waves impinging upon the portion of the adjustor, and the like.

The augmenting number and/or the augmenting factor may be arranged to be determined at least partly based on the first and/or second durations and, more particularly, at least substantially proportional the first and/or second durations. The augmenting number and/or augmenting factor may be at least substantially proportional to a difference between a preset offset and the first and/or second durations. The augmenting number may be a preset constant or a variable number which may vary, e.g., in a range of thousands, in a range of hundreds, and the like. The augmenting factor may be a preset constant or a variable factor which may vary, e.g., between 2.0 and 20.0, between 5.0 and 20.0, between 7.0 and 15.0, and the like. The augmenting number and/or augmenting factor may be large enough for the information processing device to at least substantially directly move the cursor to one of corners, edges, and inner positions within a preset period which may be less than, e.g., one second, 500 milliseconds, 200 milliseconds, 100 milliseconds or less. The adjustor may be arranged to modulate the original output signal, e.g., by increasing the amplitudes of the pulses and generating the final output signal having greater amplitudes than the original output signal and/or by increasing the pulse frequencies and generating the final output signal with higher frequencies than the original output signal.

The adjustor may also be arranged to be moved to at least one subactive setting in which the adjustor may decrease a number of the pulses, amplitudes of the pulses, and/or frequencies of the pulses of the original output signal. The adjustor may generate the final output signal at least partly different from the original output signal and then allow the information processing device to move the cursor at a slower speed on the display screen which is slower than the slow speed in the inactive setting. For example, the adjustor may modulate the original output signal, e.g., by subtracting an attenuating number of the pulses therefrom and generating the final output signal having the original number minus the attenuating number of the pulses therein or by dividing the original number by an attenuating factor and generating the final output signal having a total number of the pulses which is a ratio of the original number to the attenuating factor. The attenuating number and/or attenuating factor may be a preset constant. In the alternative, the attenuating number and/or attenuating factor may be arranged to be variable and determined at least partly based on at least one of the foregoing features of the second input signal.

The cursor control system may further include multiple cursor controllers each of which may be arranged to receive the first input signal, to generate the original output signal in response to the first input signal, and to deliver the original output signal to the adjustor. In the alternative, the cursor control system may include multiple the adjustors each arranged to offer one of the settings and to receive the original output signal from the cursor controller(s), where each adjustor may be arranged to generate the final output signal in any of such settings or in only one of such settings. Each of the adjustor may also be arranged to generate the final output signal in any of the settings. One of such adjustors may be arranged to move the cursor at a fast, constant speed, whereas the other of such adjustors may be arranged to move the cursor directly to one of corners, edges, and inner positions of the display screen.

In another aspect of the present invention, a cursor control system may be provided to move at least one cursor at multiple speeds along a target path to a target position. The cursor, the target path, and the target position are defined on a display screen of a display unit used for an information processing device, and the target position and the target path are selected on the display screen by an user of the information processing device. Such a cursor control system may include at least one cursor controller and at least one adjustor. The cursor controller may be arranged to receive at least one first input signal from the user and to generate at least one original output signal in response to the first input signal. The adjustor may be arranged to have at least two settings, to receive such an original output signal from the cursor controller, to receive at least one second input signal provided by the user independently from the first input signal to select one of the settings, to process such an original output signal based on the one of the settings selected by the user, and to generate at least one final output signal based on the original output signal and the one of the settings selected by the user. The cursor control system may also include at least one emulator which is arranged to receive the final output signal from the adjustor and to move the cursor on the display screen for the display unit of information processing device at one of the of speeds at least partly based on the final output signal. Such a cursor control system provides various benefits over the conventional cursor control devices.

Exemplary embodiments of such an aspect of the present invention may include one or more of the following features.

Such an emulator may be disposed inside the cursor control system, e.g., incorporated as a part of an integrated circuit thereof. The emulator may be provided as a machine code stored in an integrated circuit, a floppy disk, a compact disk, a downloadable information in an internet, and so on. The machine code may be incorporated in the information processing device and/or cursor control system. Other aspects and embodiments described hereinabove may also be applied to this aspect of the invention.

The cursor control system of such an aspect of this invention offers various benefits over the conventional cursor control devices. Provided separately from the cursor controller and/or adjustor and as a hardware or a software, the emulator of the present invention may be incorporated into any part of the cursor control system, the display unit, and/or the information processing device. Such a configuration provides flexibility in designing the cursor control system. In addition, by providing the above emulator as a software, such a cursor control system may be not only incorporated into a new information processing device but also retrofit to existing information processing devices.

In another aspect of the present invention, a cursor control system may be provided to move at least one cursor at multiple speeds along a target path to a target position. The cursor, the target path, and the target position are defined on a display screen of a display unit used for an information processing device, and the target position and the target path are selected on the display screen by an user of the information processing device. The cursor control system includes at least one cursor controller and at least one adjustor. In one embodiment, the cursor controller receives at least one first input signal from the user and generates at least one original output signal in response to such a first input signal. The adjustor moves between at least one inactive setting and at least one active setting, receives the original output signal from the cursor controller, receives at least one second input signal provided by the user independently from the first input signal so as to select one of the settings, processes the original output signal at least partly based on one of the settings selected by the user, and generates at least one final output signal at least partly based upon the original output signal and the one of the settings selected by the user. Such an adjustor also includes at least one sensor arranged to detect the second input signal, generates an unaugmented final output signal at least substantially identical to the original output signal in the inactive setting, and augments and/or converts the original output signal into an augmented final output signal in the active setting. The information processing device receives the unaugmented and augmented final output signals from the adjustor and to move the cursor at a slow and fast speed on the display screen, respectively. In another embodiment, the cursor controller similarly receives at least one first input signal from the user and generates at least one original output signal in response thereto. The adjustor has at least one inactive setting and at least one active setting, receives the original output signal from the cursor controller, receives at least one second input signal provided by the user independently from the first input signal to select one of the settings, processes the original output signal at least partly based on the one of the settings selected by the user, and generates at least one final output signal based on the original output signal and the one of the settings selected by the user. The cursor control system also includes at least one elastic unit which is arranged to recoil the adjustor from the active setting to the inactive setting and to bias the adjustor in the inactive setting. The information processing device receives the final output signal from the adjustor and moves the cursor on the display screen at one of the speeds at least partly based on the final input signal. In yet another embodiment, the cursor controller also receives at least one input signal provided thereto by the user and generates at least one original output signal in response to the input signal. The adjustor also has at least one inactive setting and at least one active setting, receives the original output signal from the cursor controller, processes the original output signal at least partly based on one of the settings selected by the user, and generates at least one final output signal at least partly based on the original output signal and the one of the settings selected by the user. The information processing device receives the final output signal from the adjustor and moves the cursor on the display screen at a slow speed in one of the settings and at a fast speed in the other of the settings. In yet another embodiment, the cursor controller may be arranged to allow a direct access by the user and to generate at least one original output signal in response to the access by the user, while the adjustor may be arranged to have at least two settings, to allow another direct access by the user to select one of the settings, to convert the original output signal into at least one final output signal at least partly based on the one of the settings selected by the user, and to move the cursor on the display screen at one of the of speeds based on the final output signal. In a further embodiment, the cursor controller receives at least one first input signal from the user and generates at least one original output signal in response to the first input signal, whereas the adjustor is disposed spaced apart from the cursor controller, has at least two settings, receives the original output signal from the controller, also receives at least one second input signal provided by the user to select one of the settings, converts the original output signal into at least one final output signal at least partly based on the original output signal and the one of the settings selected by the user, and moves the cursor on the display screen at one of the of speeds based on the final output signal.

The foregoing cursor control systems offer numerous benefits over the prior art cursor control devices. By activating and deactivating any of the sensors, the user can advantageously switch the cursor speed from the coarse setting for the fast speed to the fine setting for the slow speed and vice versa within a preset period of time. The time required to switch the settings of the adjustor typically depends upon a response time of the sensors which may be in a range of a few milliseconds or less. When the cursor control system includes the foregoing elastic unit, the adjustor can advantageously recoil back to its inactive position after the user releases the adjustor and prepare to receive the next second input signal from the user. Therefore, the user can readily switch the settings of the adjustor whenever he or she wants to move the cursor at the fast speed.

In other aspects of the present invention, a cursor control system may be provided to move at least one cursor defined on a display screen of a display unit for an information processing device along a target path defined on the display screen and selected by an user of the device. The cursor control system may similarly include at least one cursor controller and at least one adjustor. In one embodiment, the adjustor provides at least two settings for speeds and/or movement patterns of the cursor. The cursor controller operatively couples with the adjustor and moves the cursor in different speeds and/or movement patterns at least partly based on one of the settings of the adjustor which is selected by the user. In another embodiment, the cursor controller moves the cursor, while the adjustor operatively couples with the cursor controller and has multiple settings for multiple speeds of movements of the cursor. The cursor moves at one of the speeds determined at least partly by one of the settings of the adjustor selected by the user. In yet another embodiment, the adjustor has at least two settings for speeds and/or movement patterns of the cursor, while the cursor controller is operatively coupled to the adjustor to move the cursor in different speeds and/or movement patterns at least partly based on one of the settings of the adjustor selected by the user. Both of the adjustor and the cursor controller are preferably disposed to be accessed by the user independently. In yet another embodiment, the cursor controller moves the cursor, while the adjustor is spaced apart from the cursor controller, operatively couples with the cursor controller, and provides multiple settings for multiple different speeds of movements of the cursor. Such a cursor is arranged to move at one of the speeds determined at least partly by one of the settings of the adjustor selected by the user. In a further embodiment, the cursor controller moves the cursor, while the adjustor is operatively coupled to the cursor controller and provides multiple settings for multiple speeds of movements of the cursor, where the cursor is arranged to move at a fast speed when the adjustor is in one of the settings and at a slow speed when the adjustor is in the other of the settings. In another embodiment, the cursor controller moves the cursor, while the adjustor operatively couples with the cursor controller, has at least one inactive setting and at least one active setting, and moves the cursor at a slow speed and a fast speed in the inactive setting and the active setting, respectively. Such a cursor control system may also include at least one elastic unit arranged to recoil the adjustor from the active setting to the inactive setting and to bias the adjustor to the inactive setting,

In another aspect of this invention, an adjustor may be provided to modulate electrical signals. In one embodiment, the adjustor includes at least one selector module, at least one receiver module, and at least one processor module. The selector module offers multiple settings, provides an user with a direct physical access thereto, and allows the user to select one of the settings. The receiver module receives at least one original electrical signal which includes an original number of electrical pulses therein. The processor module is operatively coupled to the selector module and the receiver module, and adds an augmenting number of the pulses to the original electrical signal to generate at least one final electrical signal, where the augmenting number depends at least partly on one of the settings selected by the user and the original electrical signal. In another embodiment, the adjustor may include the similar selector module and the similar receiver module. The adjustor also includes at least one processor module operatively coupled to the selector module and receiver module, and arranged to generate at least one final electrical signal including a total number of the pulses which is a product of the original number and an augmenting factor that is determined at least partly based on one of the settings selected by the user. In a further embodiment, an adjustor may be provided for a cursor control system capable of moving at least one cursor at multiple speeds along a target path to a target position, where the cursor, target path, and target position are defined on a display screen of a display unit of an information processing device, and where the target position and target path are selected on the display screen by an user of the information processing device. The cursor control system has at least one cursor controller arranged to receive at least one first input signal from the user to generate at least one original output signal in response to the first input signal. The adjustor includes at least one selecting module having at least two settings and arranged to provide the user with a direct physical access thereto, and at least one sensor module arranged to receive the original output signal from the cursor controller and to receive at least one second input signal from the user independently from the first input signal to allow the user to select one of the settings. Such an adjustor includes at least one processor module which is arranged to process the original output signal at least partly based on the one of the settings selected by the user and to generate at least one final output signal based on the original output signal and the one of the settings selected by the user. The information processing device is arranged to receive the final output signal from the adjustor and to move the cursor on the display screen at one of the of speeds based on the final output signal.

Such an adjustor of the present invention offers benefits over the conventional cursor control devices. Most advantageously, the adjustor can be manufactured as a separate article including the foregoing emulator which may be incorporated thereinto as a hardware and/or a software. Such an adjustor, therefore, can be readily retrofit to any conventional cursor control devices.

In another aspect, a method may be provided to move at least one cursor at multiple speeds along a target path to a target position by a cursor control system, where the cursor, target path, and target position are defined on a display screen of a display unit for an information processing device, where the target path and target position are selected on the display screen by an user of the device, and where the cursor control system includes at least one cursor controller for moving the cursor on the display screen and at least one adjustor with multiple speed settings for such a cursor controller. The method may include the steps of selecting an active setting of the adjustor, coarsely moving the cursor to or toward a vicinity of the target position at an augmented, fast speed by a cursor controller in response to a coarse input signal applied thereto by the user, switching the adjustor to an inactive setting thereof, and precisely moving the cursor to the target position at a slow speed by the cursor controller in response to a fine input signal applied thereto by the user.

Exemplary embodiments of such an aspect of the present invention may include one or more of the following features.

Such a method may further include the step of disposing the cursor controller and adjustor to provide direct physical accesses to the user independently. The disposing step may include the step of arranging such an adjustor spaced apart from the cursor controller. The arranging step may also include the step of disposing the adjustor adjacent to, next to, around, within, above, on, underneath or below at least a portion of the cursor controller. The disposing step may also include the step of arranging the adjustor and the cursor controller as an unitary article.

The selecting step may include one of the steps of choosing the active setting and choosing one of the active settings provided in an intermittent fashion or a continuous fashion. The selecting step may also include the step of moving, displacing, pushing, pressing, touching, turning, rotating, swiveling or impinging light rays to as least a portion of the adjustor. The selecting step may also result from the step of moving, displacing, pushing, pressing, touching, turning, rotating, swiveling or impinging light rays to at least a portion of the adjustor. Such a method may further include one of the steps of releasing the portion of the adjustor and recoiling the portion of the adjustor.

One or both of the moving steps may include one of the steps of displacing the cursor along a first target path connecting a present position of the cursor on the display screen and the target position and displacing the cursor along a second target path leading the cursor to the vicinity of the target position. The second displacing step may include one of the steps of composing the second target path as a mixture of at least one horizontal unit path and at least one vertical unit path of the display screen and including at least one curved section in the second target path.

The coarsely moving step may include one of the steps of moving the cursor at a fast speed which may be a preset constant and moving the cursor at a fast speed which may be variable. The coarsely moving step may include the steps of detecting at least one feature of such a coarse input signal and increasing the fast speed according to the feature. Such a detecting step may include the steps of sensing a distance of a movement effected by the coarse input signal, sensing a direction of the movement, sensing a vector of the movement, sensing a speed of the movement, sensing an external force effecting the movement, sensing an acceleration effecting the movement, and sensing a duration of the movement. The detecting step may also include the step of detecting a duration, a magnitude, a direction, a frequency, a phase angle, and/or a number of applications of the coarse input signal. The detecting step may further include the step of detecting the coarse input signal on more than one occasion. The increasing step may include one of the steps of increasing such a fast speed in proportion to the duration of the coarse input signal, increasing the fast speed in proportion to a first time measured after the coarse controller receives the coarse-input signal, increasing such a fast speed after a preset period of time measured after the coarse controller receives the coarse input signal, and increasing the fast speed in proportion to the magnitude of the coarse input signal. The increasing step may include one or more of the steps of increasing the fast speed continuously and increasing the fast speed incrementally. The coarsely moving step may including the steps of defining multiple corners, edges, and inner positions of the display screen and directly moving the cursor to one of the corners, the edges, and the inner points of the display screen in response to the coarse input signal. The directly moving step may include the step of performing the directly moving step within one second, 500 millisecond, 200 millisecond, 100 millisecond or less.

Such a coarsely moving step may further include the steps of generating at least one original output signal by the cursor controller, constructing at least one final output signal by augmenting the original output signal, and fast moving the cursor based on the augmented final output signal. Such a constructing step may include the step of generating the final output signal by lengthening and/or amplifying the original output signal. The lengthening step may include one of the steps of adding a constant augmenting number of electrical pulses to the original output signal and adding a variable augmenting number of electrical pulses to the original output signal. Alternatively, the lengthening step may include the step of increasing a number of electrical pulses included in the original output signal by a factor of an augmenting factor. Such an increasing step may include one of the steps of maintaining the augmenting factor as a preset constant and manipulating the augmenting factor as variable. Such an amplifying step may include one the steps of manipulating amplitudes of-electrical signals of the original output signal and manipulating frequencies of electrical signals of the original output signal. Such a fast moving step is effected by the step including one of the steps of moving a mouse-type controller over a curvilinear surface, moving a body part of the user across a sensing zone of a touch pad-type controller, rotating a rotatable ball of a track ball-type controller, swiveling or rotating a handle of a joystick-type controller, moving or swiveling at least a portion of a disk-type controller, pressing at least a portion of a disk-type controller, pressing down a key-type controller, and the like.

The switching step may include the step of choosing the inactive setting, one of the inactive settings provided in an intermittent fashion, and one of the inactive settings provided in a continuous fashion. Such a switching step may include one of the steps of moving, pushing, pressing, touching, turning, rotating, swiveling, displacing, and impinging light rays to at least a portion of the adjustor. The switching step may further include one of the steps of releasing at least a portion of the adjustor after the coarsely moving step and recoiling the portion of the adjustor after the coarsely moving step.

The precisely-moving step may include the step of moving the cursor at a slow speed which may be a preset constant or at a slow speed which may be variable. The precisely moving step may include one of the steps of moving a mouse-type, controller over a curvilinear surface, moving a body part of the user across a sensing zone of a touch pad-type controller, rotating or rolling a rotatable or rollable ball of a track ball-type controller, swiveling or rotating a handle of a joystick-type controller, moving, swiveling or pressing at least a portion of a disk-type controller, pressing or pushing down a key-type controller, and the like.

The selecting step may also include the steps of selecting a subactive setting of the adjustor and precisely positioning the cursor in the target position at an attenuated, slower speed also by the cursor controller in response to an auxiliary input signal applied thereto by the user. The selecting step may include one of the steps of choosing the subactive setting, choosing one of the subactive settings provided in an intermittent fashion, and choosing one of the subactive settings provided in a continuous fashion.

The method may further include the steps of selecting the active and inactive settings in any order and moving the cursor coarsely and precisely in the any order. The method may also include the steps of selecting at least one of the active and inactive settings more than once so as to move the cursor to the target position.

In another aspect, a method may be provided to move at least one cursor at multiple speeds along a target path to a target position by a cursor control system, where the cursor, target path, and target position are defined on a display screen of a display unit for an information processing device, and where the target position and target path selected on the display screen by an user of the device. Such a method may include the steps of selecting one of multiple setting ech of which is arranged to effect a different speed scale of a movement of the cursor, receiving an input signal provided by the user, generating an original output signal in response to the input signal, converting the original output signal to a final output signal at least partly based on the one of the settings selected by the user, and moving the cursor on the display screen at least partly based on the final output signal.

Exemplary embodiments of such an aspect of the present invention may include one or more of the following features.

The selecting step may include the step of choosing an inactive setting for a slow speed for the cursor movement or, in the alternative, choosing an active setting for a fast speed for the cursor movement. The second choosing step may include one of the steps of selecting the active setting and selecting one of the active settings provided in an intermittent fashion or a continuous fashion. The method may further include the step of choosing a subactive setting for a slower speed for the cursor movement, where the choosing step may include one of the steps of selecting the subactive setting and selecting one of the subactive settings provided in an intermittent or continuous fashion. The selecting step may include one of the steps of moving, touching, pressing, and swiveling at least a portion of the cursor control system. The method may further include one of the steps of releasing the portion of the cursor control system and recoiling the portion of the cursor control system.

The receiving step may include the steps of providing a movement to at least a portion of a conventional cursor control device and detecting at least one feature related to the movement. The providing step may include the steps of moving at least a portion of a mouse over a surface, moving or touching a body part of the user on a sensing zone of a touch pad, rotating or rolling a rotatable ball of a track ball, swiveling a handle of a joystick, pressing at least a portion of a disk, and pushing or pressing down an arrow key. The detecting step may include the steps of sensing a distance of the movement, sensing a direction of the movement, sensing a vector of the movement, sensing a speed of the movement, sensing an external force effecting the movement, sensing an acceleration effecting the movement, and sensing a duration of the movement.

The generating step may include the step of providing the original output signal as a series of multiple pulse trains each including multiple electrical pulses. Such a providing step may include the steps of denoting an x-component of the original output signal as a first pulse train and denoting an y-component of the original output signal as a second pulse train. Such a providing step may further include the step of denoting an z-component of the original output signal as a third pulse train. The providing step may include the step of constructing each of the electrical pulses as the pulse of an electrical current or an electrical voltage.

The converting step may include the step of modulating a number of the pulses in the original output signal, amplitudes of the pulses in the original output signal, and/or frequencies of the pulses in the original output signal based on the one of the settings to generate the final output signal. The modulating step may include one of the steps of adding an augmenting number of pulses which are at least substantially similar to the pulses of the original output signal, where the augmenting number is determined at least partly by the one of the settings and multiplying the number of the pulses in the original output signal by an augmenting factor which is determined at least partly by the one of the settings.

The moving step may include the step of displacing the cursor from a current position thereof to the target position. The displacing step may include one of the steps of moving the cursor along the target path which is arranged to be a vector from the current position and to the target position, moving the cursor along the target path which includes at least one horizontal unit path and at least one vertical unit path of the display screen, and moving the cursor along the target path including at least one curved section. The moving step may include the step of moving the cursor at a constant slow speed or at a variable manual speed effected by the user. The-moving step may include one-of the steps of moving the cursor at a constant fast speed, moving the cursor at a fast speed which is arranged to accelerate over time, and moving the cursor directly to one of corners, edges, and inner positions of the display screen within a preset period of time. Such a moving step may include one of the steps of rendering the information processing device move the cursor at least partly based on the final output signal, and rendering the information processing device process such a final output signal and moving the cursor based on the processed final output signal.

In another aspect of the present invention, a cursor control system may be provided to move at least one cursor at multiple speeds along a target path to a target position. Such a cursor, target path, and target position are defined on a display screen of a display unit used in conjunction with an information processing device, while the target position and target path are selected on the display screen by an user of the information processing device. Such a cursor control system may be made by a process including the steps of: providing a cursor controller capable of generating at least one original output signal in response to a first input signal applied thereto by the user, where the original output signal is arranged to carry directional information based on which the cursor is to move on the display screen; providing at least one adjustor with multiple settings one of which is an active setting and another of which is an inactive setting and arranged to receive the original output signal from the cursor controller; arranging the adjustor to generate at least one final output signal in the foregoing inactive setting by unaltering the original output signal and at least one another final output signal in the foregoing active setting by augmenting the original output signal; and arranging the information processing device to move the cursor on the display screen at least partly based on one of the final output signals, thereby moving the cursor at a slow speed and at a fast speed in response to such an unaltered and augmented final out signals, respectively.

In another aspect of this invention, an adjustor of a cursor control system may be provided to modulate electrical signals thereby. Such an adjustor may be made by a process including the steps of: arranging the adjustor to receive at least one original electrical signal; providing multiple settings thereto one of which may be an active setting and another of which may be an inactive setting; and arranging the adjustor to generate at least one final electrical signal by unaltering the original signal in the inactive setting and to generate at least one another final electrical signal in the active setting by lengthening and/or amplifying the original output signal.

In another aspect of the present invention, a cursor control system may be provided to move at least one cursor defined on a display screen of a display unit for an information processing device along a target path which is defined on the display screen and selected by an user of the information processing device. The cursor control system may include a body, at least one fine controller, and at least one coarse controller. The fine controller is coupled to the body, receives at least one first input signal from the user, and moves the cursor at a first speed on the display screen in response to the first input signal. The coarse controller is also coupled to the body, receives at-least ore second input signal from the user independently of the first input signal, and moves the cursor on the display screen in response to the second input signal at a second speed which is or capable of being faster than the first speed.

The cursor control system according to such an aspect of the present invention offers various benefits over the prior art. First of all, unlike the conventional cursor emulating software, the cursor control system of the present invention provides at least two cursor controllers each of which has a different speed ranges. Accordingly, the user can select one of the cursor controllers and move the cursor at the desirable speed. When desirable, the cursor control system can also allow the user to use both of the controllers at least substantially simultaneously. Secondly, the cursor control system of this invention advantageously employs multiple cursor controllers disposed separately. Therefore, the user can manipulate one or both of the cursor controllers to move the cursor at the fast or slow speed in any desirable order. For example, the user may control the coarse controller and coarsely move the cursor to the vicinity of the target position, and then control the fine controller and precisely position the cursor in the target position. The user may also move both cursor controllers at least substantially simultaneously. In addition, contrary to the disk-shaped cursor controllers such as the one disclosed in the above U.S. Pat. No. 5,432,530, the user can directly and physically manipulate both controllers independently. Therefore, the user can change the cursor speeds without having to maneuver (e.g., move, press, rotate or swivel) the fine controller at all. Furthermore, by functionally and physically separating the coarse and fine controllers for moving the cursor at the fast and slow speed, respectively, the cursor control system of the present invention provides the user with greater a flexibility and precision in controlling the cursor movement and the cursor speed.

Exemplary embodiments of such an aspect of the present invention may include one or more of the following features.

The fine and coarse controllers may be arranged to provide the user with a first and second direct physical access thereto, respectively. The controllers may be disposed in such a way that the first and second physical accesses are different. Alternatively, the fine and coarse controllers may be disposed in such a way that the user may make the first and second physical accesses at least substantially independently. The first and second input signals may be of similar types or of different types. The controllers may be arranged to receive the input signals in any sequence such that, e.g., the coarse controller receives the second input signals and then the fine controller receives the first input signal. Alternatively, the controllers may also be arranged to receive the input signals at least substantially simultaneously.

The information processing device may include, e.g., a microprocessor, an integrated circuit, an optical processor, a biological processor, and the like, each of which may be arranged to process various digital and/or analog information. Examples of such an information processing device may include, but not necessarily be limited to, a computer, an electronic game device, a personal digital or data assistant, a communication device, an audiovisual device, a global positioning device, an automation device, a security device, an industrial control device, an automotive control device, a scientific analytical device, a camera, a camcorder, and a consumer electric device, each of which operatively couples with the display unit including the display screen defining the cursor thereon. In addition, such a computer may include, e.g., a desk-top computer, a portable computer, and a handheld computer which may have at least one telecommunication unit which may in turn include, e.g., an audio communication unit and a video communication unit. Examples of such a display unit may include, but not limited to, a liquid crystal display device, an active matrix display device, a passive matrix display device, an inorganic light emitting device, an organic light emitting device, a projection device, a plasma display device, a multi-dimensional virtual display device, an electroluminescence display device, a photoluminescence display device, a photoelectroluminescence display device, and the like, each of which includes at least one display screen thereon.

The target-path may be a curvilinear route which connects a current position of the cursor on the display screen to the target position of the cursor on the display screen. Such a route may be a vector which starts from the-current position and pointing toward the target position or may include at least one horizontal unit path and/or at least one vertical unit path each defined on the above display screen. Such a route may have a shape of a staircase or may include at least one curved section therealong.

At least one of the fine and coarse controllers may be arranged to be symmetrically disposed with respect to the body and/or the other of such controllers. Both of the fine and coarse controllers may also be arranged to be symmetrically disposed with respect to the other thereof. Alternatively, the fine and coarse controllers may also be arranged to be asymmetrically disposed with respect to the body and/or the other of such coarse controllers. Such fine and coarse controllers may also be disposed in various arrangements with respect to each other. For example, such a coarse controller may be spaced apart from the fine controller. The fine and coarse controllers may be arranged to be stationary or, alternatively, such controllers may be arranged to be movable with respect to the body. The fine (or coarse) controller may also be disposed adjacent to, next to or around at least a portion of the coarse (or fine) controller. The fine (or coarse) controller may be arranged to form an annular shape in at least a portion of which at least a portion of the coarse (or fine) controller is disposed. In such an embodiment, the coarse controller may form an annular shape in which at least a portion of the fine controller is disposed, where the annular shape may be an annular polygonal shape such as an annular triangle, square, rectangle, hexagon, octagon, and the like, or may be an annular curved shape such as a circle, an oval, and the like. The coarse (or fine) controller may be disposed in, on, over, underneath, below or along the fine (or coarse) controller. Alternatively, the fine and coarse controllers may be contiguously formed. In this embodiment, at least one divider may be disposed between the fine and coarse controllers to provide, e.g., a visual, tactical, and operational boundary therebetween.

Both of the fine and coarse controllers may be fixedly coupled to the body, where the coarse controller may include at least one movable part to be manipulated by the user to move the cursor at the second speed. Alternatively, one of the fine and coarse controllers may be fixedly coupled to the body, while the other of such controllers may be movably coupled to the body. The coarse controller may also be arranged to move with respect to the body, where multiple elastic units may be provided and coupled to the coarse controller, to bias the coarse controller in an inactive position in which the elastic units are in equilibrium, and to move the coarse controller toward the inactive position when the elastic units are not in the equilibrium. The cursor control system may also include at least one viscous unit arranged to be coupled to the coarse controller to reduce oscillation during a movement thereof. In another alternative, both of the fine and coarse controllers may also be movably coupled to the body. For example, the fine and coarse controllers may be fixedly coupled to the other thereof and to move in unison therewith.

The first input signal may include, e.g., a movement of at least a portion of the fine controller, a mechanical, electrical, and/or magnetic contact with at least a portion of the fine controller, a force applied to the portion of the fine controller, deformation of the portion of the fine controller, and so on, where such a movement may be a horizontal, lateral, and vertical movement, and such a force may be a vertical, lateral, and horizontal force. The user may apply such a first input signal to such a fine controller by, e.g., moving, displacing, touching, tapping, rotating, pressing, pushing, clicking, holding, tilting, and swiveling at least a portion of the fine controller.

The fine controller may be a conventional cursor control device such as, e.g., a mouse-type controller, a touch pad-type controller, a track ball-type controller, a joystick-type controller, a disk-type controller, and a key-type controller. A first of the mouse-type controller includes a first rollable ball and moves the cursor in response to a movement of the first ball effected by the first input signal. A second of the mouth-type controller includes a light source and an optical tracking unit, and moves the cursor in response to a movement of the fine controller which is effected by the first input signal and detected by the optical tracking unit. The touch pad-type controller forms a sensing zone and is arranged to move the cursor in response to a movement of a body part of the user over the sensing zone. The track ball-type controller includes a second rollable ball and moves the cursor according to a movement of the second ball effected by the first input signal. The joystick-type controller has a movable handle and moves the cursor in response to a movement of the handle effected by the first input signal. The disk-type controller includes a movable disk and moves the cursor according to a movement of the handle effected by the first input signal. The key-type controller moves the cursor in response to a tapping thereof effected by the first input signal as well. Such a first speed may be a preset constant, where the fine controller may be the joystick-type controller, disk-type controller, and the like. The first speed may be variable and at least partly determined by the movement which is manually effected by the user, where the fine controller may be the mouse-type controller, touch pad-type controller, track ball-type controller, joystick-type controller, disk-type controller, key-type controller, and so on. The user may effect the movement by moving, e.g., an anatomical part of the user, an article coupled to the user, a portion of the fine controller, and an entire portion of the fine controller. The first speed may depend on, e.g., the movement and a range ratio which represents a ratio of an on-screen distance to be moved by the cursor on the display screen to a real distance of the movement effected by the user. The second speed may be a preset constant and arranged to be faster than a nominal value and/or an average of the first speed.

The second input signal may be a movement of at least a portion of the coarse controller, a mechanical, electrical or magnetic contact with the portion of the coarse controller, an external force applied to the portion of the coarse controller, a deformation of the portion of the coarse controller, a change in a mechanical, chemical, electrical, magnetic, and/or optical property of the portion of the coarse controller, a presence and/or an absence of an article adjacent to the portion of the coarse controller, a displacement, a speed, an acceleration of the movement, light rays impinging upon the portion of the coarse controller, and so on. The movement may be a horizontal, lateral, and vertical movement, while the force may be a vertical, lateral, and horizontal force. The user may apply the second input signal to the coarse controller by, e.g., moving, translating, displacing, rotating, turning, swiveling, touching, tapping, pressing, pushing, dragging, clicking, tilting, and holding such a portion of the fine controller.

The second speed may be a preset constant or arranged to depend at least partly on such a second input signal. The second input signal may be applied directly to the coarse controller and/or transmitted indirectly to the coarse controller through the fine controller. Such a second speed may depend upon, e.g., a duration of the second input signal, a magnitude thereof, a direction thereof, a frequency thereof, a phase angle thereof, and a number of applications of the second input signal. The coarse controller may further be arranged to increase the second speed either continuously or incrementally. Such a second speed may be arranged to increase in proportion to the duration of the second input signal or to increase over a first time which is measured after the coarse controller receives the second input signal, to be proportional to the first time. The second speed may also be arranged to increases after a preset period of time measured after the coarse controller receives the second input signal, or to be proportional to the magnitude of the second input signal, the magnitude of the external force, the force, and the like. The second speed may also be arranged to increase when the user applies the second input signal one more time to one or both of the fine and coarse controllers. Such a coarse controller may also be arranged to perform selection of, e.g., a graphical object, a command, and a hot spot on the display screen. The coarse controller may perform such a selection, e.g., when the user applies more of the external force to the cursor control system, when the second input signal is applied thereto for more than a preset period of time, or when the coarse controller is touched, tapped, pressed, pushed, clicked, moved, rotated, swiveled, and tilted at least one more time after receiving the second input signal. Such a coarse controller may be deactivated and cease to further move the cursor, e.g., when the user ceases to apply the second input signal, when the user applies the second input signal once more to the cursor control system, after a period of time after the user applies the second input signal, and the like.

The coarse controller may include at least one sensor which is arranged to detect the second input signal which may include, e.g., the external force, the movement, speed, acceleration, contact, deformation, change, presence, and/or absence. The sensor may be a force sensor, a displacement sensor, a speed meter, an accelerometer, a motion sensor, a magnetic sensor, a voltage sensor, a current sensor, a variable resistor and a sensor to measure changes in such resistances, a variable capacitor and a sensor to measure changes in such capacitances, a photodetector, a torque sensor, and so on. The sensor may also generate at least one signal which represents a relative position of a point along the sensor to which the user applies the second input signal. When the sensor forms a variable resistor, an electrical resistance thereof is arranged to vary depending upon the position of the point along the coarse controller. The sensor may include a conductive elastic article arranged to change its electrical resistance in response to the second input signal, where such a conductive elastic substance may be a conductive foam. The sensor may also include at least two conductive elastic articles arranged to be separated from each other in an absence of the second input signal and to contact each other at the point while receiving the second input signal. The sensor may be arranged to be position coded such that the coarse controller and the information processing device may be arranged to detect a relative position of a point along the sensor to which the user applies the second input signal.

The coarse controller may also include multiple sensors arranged in a row, a column, and/or an array and detecting the second input signal such as the external force, the movement, the speed, the acceleration, the contact, the deformation, the change, the presence, and the absence. Such sensors may generate at least one signal which represents a relative position of at least one of the sensors to which the user applies the second input signal. The sensors may be arranged in one of a contiguous pattern, a continuous pattern, and/or an intermittent pattern. At least one of the sensors may also be a force transducer, a displacement sensor, a speed meter, an accelerometer, a motion sensor, a voltage sensor, a current sensor, a magnetic sensor, a variable resistor or a sensor for detecting changes in such resistances, a variable capacitor or a sensor for measuring changes in such capacitances, a photodetector, and a torque sensor. The sensors may further be arranged to be position coded in such a way that the coarse controller and/or the information processing device may detect a relative position of, e.g., the sensors to which the user applies the second input signal.

When the display screen defines multiple edges and corners therearound and also includes multiple inner positions therein, the coarse controller may be arranged to move the cursor to one of the edges, corners, and positions of the display screen at the second speed within a preset period of time. Such a preset period may be one second, 500 millisecond, 200 millisecond, 100 milliseconds, and/or at least an order of magnitude faster than the first speed of the cursor. In the alternative, the coarse controller may move the cursor to one of such edges, corners, and/or inner positions at least substantially instantaneously. Such a coarse controller may move the cursor to one of the edges, corners, and inner positions when the user applies the second input signal to the coarse controller, when the user applies the second input signal to the coarse controller on multiple occasions, and/or when the user applies the second input signal to the coarse controller for a preset period of time.

The cursor control system may further include multiple coarse controllers arranged to move the cursor at different second speeds each of which is faster than the first speed in response to the second input signal. When the display screen has therearound multiple edges, corners, and inner positions, at least one of the coarse controllers may move the cursor directly to one of such edges, corners, and inner position, while at least another of the coarse controllers may move the cursor at the second speed along the target path.

In other aspects of the present invention, cursor control systems may be provided to move at least one cursor defined on a display screen of an information processing device along a target path which is defined on the display screen and selected by an user of the information processing device. Such cursor control systems may include a body, at least one fine controller, and at least one coarse controller. The fine controller couples with the body, receives at least one first input signal from the user, and moves the cursor on the display screen in response to the first input signal at a first speed, while the coarse controller couples with the body, receives at least one second input signal from the user independently of the first input signal, and moves the cursor on the display screen in response to the second input signal at a second speed which is or capable of being faster than the first speed. In one aspect, the fine controller is a mouse-type controller including a rollable ball and arranged to move the cursor in response to a movement of the ball effected by the first input signal. In another aspect, the fine controller is a mouse-type controller including at least one optical tracking unit and arranged to move the cursor in response to the movement of the fine controller effected by the first input signal. In another aspect, the fine controller is a touch pad-type controller including a sensing zone and is arranged to move the cursor in response to a movement of a body part of the user over or across the sensing zone. In yet another aspect, the fine controller is a track ball-type controller having a rollable ball and arranged to move the cursor in response to a movement of the ball which is effected by the first input signal. In another aspect, the fine controller is a joystick-type controller having a movable handle and arranged to move the cursor in response to a movement of the handle effected by the first input signal. In another aspect, the fine controller is a disk-type controller having a movable handle and arranged to move the cursor in response to a movement of the handle which is effected by the first input signal. In a further aspect, such a fine controller is a key-type controller arranged to move the cursor in response to a tapping thereof effected by the first input signal.

The above cursor control systems provide numerous benefits over the prior art cursor control devices. Most advantageously, the coarse controller of this invention may be incorporated into any conventional cursor control devices, e.g., by incorporating the coarse controller adjacent to, around, within, on or below the conventional fine controllers. Accordingly, the manufacturing facilities for the conventional cursor control devices may easily be converted to produce the cursor control systems of the present invention. In addition, any conventional cursor control devices may be converted into the coarse controllers of this invention, e.g., by modifying the conventional devices to modulate the output signals or by incorporating the foregoing adjustor thereinto.

In yet other aspects of this invention, cursor control systems may also be provided to move at least one cursor defined on a display screen of an information processing device along a target path which is defined on the display screen and selected by an user of the information processing device. Such cursor control systems may include a body, at least one fine controller, and at least one coarse controller, where both the fine and coarse controllers are coupled to the same or different portions of the body. In one aspect, the fine controller receives at least one first input signal from the user and to move the cursor on the display screen in response to the first input signal at a first speed, while the coarse controller receives at least one second input signal from the user independently of the first input signal and moves the cursor on the display screen in response to the second input signal at a second speed arranged to be faster than a normal and/or average value of the first speed. In another aspect, the fine controller receives at least one first input signal from the user and moves the cursor on the display screen in response to the first input signal at a first variable speed which is at least partly determined by the first input signal. The coarse controller receives at least one second input signal from the user independently of the first input signal and moves the cursor on the display screen in response to the second input signal at a second speed which is or capable of being faster than the first speed. In yet another aspect, the fine controller receives at least one first input signal from the user and moves the cursor on the display screen in response to the first input signal at a constant first speed and/or a variable first speed determined at least partly by the first input signal. The coarse controller receives at least one second input signal from the user independently of the first input signal and moves the cursor on the display screen in response to the second input signal at a second speed which is or capable of being faster than the constant first speed and faster than a normal value and/or an average of the variable first speed. In yet another aspect, the fine controller provides the user with a first direct physical access thereto in order to receive at least one first input signal from the user and moves the cursor on the display screen in response to the first input signal at a first speed. The coarse controller provides the user with a second direct physical access thereto so as to receive at least one second input signal from the user independently of the first input signal and then moves the cursor on the display screen in response to the second input signal at a second speed which is or capable of being faster than the first speed. In another aspect, the fine controller provides the user with a first direct physical access thereto in order to receive at least one first input signal from the user and moves the cursor on the display screen in response to the first input signal at a first speed. The coarse controller provides the user with a second direct physical access thereto so as to receive at least one second input signal from the user and moves the cursor on the display screen in response to the second input signal at a second speed which is or capable of being faster than the first speed. In another aspect, the fine controller moves the cursor on the display screen in response to the first input signal at a first speed, while the coarse controller moves the cursor on the display screen in response to the second input signal but independently of the first input signal at a second speed which is or capable of being faster than the first speed. In yet another aspect, the fine controller receives at least one first input signal from the user and moves the cursor on the display screen in response to the first input signal at a first speed. The coarse controller receives at least one second input signal from the user and moves the cursor on the display screen in response to the second input signal at a second speed which is or capable of being faster than the first speed. In yet another aspect, the fine controller may move the cursor on the display screen in response to the first input signal at a first speed, while the coarse controller also moves the cursor on the display screen in response to the second input signal at a second speed which is or capable of being faster than the first speed. More particularly, both the fine and coarse controllers are arranged to be independently controlled by the user. In another aspect, the fine controller moves the cursor on the display screen in response to the first input signal at a first speed, while the coarse controller is spaced apart from the fine controller and moves the cursor on the display screen in response to the second input signal at a second speed which is or capable of being faster than the first speed. In yet another aspect, the fine controller moves the cursor at a first speed, whereas the coarse controller moves the cursor at a second speed which is or capable of being faster than the first speed. In yet another aspect, the fine controller moves the cursor at a first variable speed which is at least partly determined by a manual movement effected by the user, and the coarse controller moves the cursor at a second speed which is or capable of being faster than the first speed.

In other aspects of this invention, further cursor control systems may be provided to move at least one cursor defined on a display screen of an information processing device along a target path which is defined on the display screen and selected by an user of the information processing device. In one embodiment, a cursor control system includes at least one fine controller arranged to move the cursor at a first speed as well as at least one coarse controller arranged to move the cursor at a second speed capable of being faster than the first speed. In another embodiment, a cursor control system includes at least one fine controller arranged to move the cursor at a first-variable speed-at least partly determined by a manual movement effected by the user, as well as at least one coarse controller arranged to move the cursor at a second speed which is or capable of being faster than the first speed.

In further aspects of this invention, fast cursor controllers may be provided for cursor control systems for moving at least one cursor defined on a display screen of a display unit of an information processing device along a target path defined on the display screen and selected by an user of the device. The cursor control system includes at least one slow cursor controller arranged to receive a first input signal from the user and to move the cursor on the display screen in response to the first input signal at a slow speed. In one aspect, the fast cursor controller includes at least one sensor which is disposed in an operative relation to the slow cursor controller and which is arranged to be directly accessible by the user, to receive at least one second input signal directly from the user, and to move the cursor on the display screen in response to the second input signal at a fast speed that may be or capable of being faster than the slow speed. In another aspect, the fast cursor controller includes at least one sensor module arranged to receive a second input signal independently of the first input signal as well as at least one processor module to move the cursor on the display screen in response to the second input signal at a fast speed capable of being faster than the slow speed.

The coarse controller of the present invention provides benefits over the conventional cursor control devices. Most advantageously, such a coarse controller can be manufactured as a separate article which may be incorporated into any conventional cursor control devices. For example, such a coarse controller can be manufactured to be movably or fixedly attached to the conventional cursor control devices such that the user can use both the coarse and fine controllers independently and/or at least substantially simultaneously.

In another aspect, a method may be provided to move a cursor which is defined on a display screen of a display unit for an information processing device to a target position along a target path by a cursor control system with at least two controllers, where both of the target position and target path are defined on the display screen and selected by an user of the device. Such a method may include the steps of: receiving a coarse input signal from the user by a coarse controller; coarsely moving the cursor to a vicinity of the target position at a fast speed in response to the coarse input signal by the coarse controller; receiving a fine input signal from the user by a fine controller at least substantially independently of the coarse input signal; and precisely positioning such a cursor in the target position at a slow speed in response to the fine input signal using the fine controller at least substantially independently of the coarse controller.

Exemplary embodiments of such an aspect of the present invention may include one or more of the following features.

The method may include the step of disposing the fine and coarse controllers to provide the user with direct physical accesses thereto independently. The disposing step may include the step of arranging the fine controller spaced apart from the coarse controller at a preset distance. Such an arranging step may include the step of disposing at least a portion of the coarse controller adjacent to, next to, around, within, over, on, underneath or below at least a portion of the fine controller. The disposing step may include the step of arranging the fine and coarse controllers as an unitary article.

The step of receiving the coarse input signal may result from at least one of the steps which include moving, translating, displacing, rotating, turning, swiveling, tilting, touching, tapping, pressing, pushing, dragging, clicking, double-clicking, and/or holding at least a portion of the coarse controller. The step of receiving the coarse input signal including may include the step of detecting a movement of at least a portion of the coarse controller, an electrical, mechanical, and/or magnetic contact with the portion, light rays or electromagnetic waves impinged to the portion, an external force applied to the portion, a deformation of the portion, a change in an electrical, mechanical, chemical, magnetic, and/or optical property of the portion, a presence of an article adjacent to the portion, an absence of the portion, a displacement from the movement, a speed of the movement, and/or an acceleration of the movement. The step of detecting the movement may also include the step of sensing a vertical, horizontal, vertical, and radial movement-of such a portion of the coarse-controller. In addition, the step of detecting the deformation may also include the step of sensing a horizontal, lateral, vertical, and/or radial deformation of the portion of the coarse controller. The step of detecting the external force may include the step of sensing a horizontal, lateral, vertical, and/or radial force applied to the portion of the coarse controller. The step of detecting the displacement may further include the step of sensing a horizontal, lateral, vertical, and/or radial displacement of such a portion of the coarse controller. The foregoing detecting steps may also include the step of disposing at least one sensor to detect the coarse input signal. The disposing step may include the step of arranging more than one of the above sensor in a row, a column, and/or an array. Such a method may include the step of position coding the sensors. The disposing step may include the step of arranging a single sensor for detecting a relative position of a point to which the user applies the coarse input signal. The step of receiving the coarse input signal may include the steps of receiving the coarse input signal directly by the coarse controller and receiving the coarse input signal indirectly through at least a portion of the fine controller.

The coarsely moving step may include one of the steps of moving the cursor along the target path connecting a present position of the cursor on the display screen and the target position and moving the cursor along a path different from the target path but pointing to or toward the vicinity of the target-position. The coarsely moving step may include the step of moving the cursor at the fast speed which is a preset constant. The coarsely moving step may include the steps of detecting at least one feature of the coarse input signal and increasing the fast speed according to the feature. The increasing step may include the step of increasing the fast speed continuously or incrementally. The detecting step may include the step of detecting a duration, a magnitude, a frequency, a phase angle, a direction, and/or a number of applications of the coarse input signal. The increasing step may include one of the steps of increasing the fast speed in proportion to the duration of the coarse input signal, increasing the fast speed in proportion to a first time which is measured after the coarse controller receives the coarse input signal, increasing such a fast speed after a preset period of time which is measured after the coarse controller receives the coarse input signal, and increasing such a fast speed in proportion to the magnitude of the coarse input signal. The above detecting step may include the step of detecting the coarse input signal on at least two occasions. The coarsely moving step may include the steps of defining multiple corners, multiple edges, and multiple inner positions of the display screen and directly moving the cursor to one of the corners, the edges, and the inner points of the display screen in response to the coarse input signal. In addition, the directly moving step may include the step of performing the directly moving step within one second, 500 millisecond, 200 millisecond, 100 millisecond or less.

Such a method may further include the step of receiving an additional input signal from the user by a coarse controller and selecting one of a graphical object, a command, and/or a hot spot on the display screen using the coarse controller in response to the additional input signal. The step of receiving the additional input signal may result from the step of moving, translating, rotating, turning, swiveling, touching, tapping, pressing, pushing, dragging, clicking, double-clicking, tilting or holding at least a portion of the coarse controller. The step of receiving the additional input signal may also include the step of detecting a movement of at least a portion of the coarse controller, a mechanical, electrical, and/or magnetic contact with such a portion, an external force applied to such a portion, a deformation of the portion, a change in a mechanical, chemical, electrical, magnetic, and/or optical property of the portion, a presence or absence of an article adjacent to the portion, a displacement from the movement, a speed of the movement, and/or an acceleration of the movement.

Such a method may further include the step of terminating a movement of the cursor at the fast speed. The terminating step may include the step of stopping such a movement when the user stops to apply the coarse input signal, when the user applies the second input signal once more to the coarse controller, and/or when the movement stops in a period of time after the coarse controller receives the coarse input signal. The terminating step may also include the step of performing such a terminating step before the positioning step, simultaneously with the positioning step, and/or after the positioning step.

The step of receiving the fine input signal may result from at least one of the steps including translating, rotating, turning, swiveling, touching, pressing, pushing, tilting, and/or holding at least a portion of the fine controller. The step of receiving the fine input signal may include one of the steps of detecting a movement of at least a portion of the fine controller, a mechanical contact with such a portion, an external force applied to the portion, a deformation of the portion, a change in an optical and/or electrical property of such a portion, a presence and/or absence of an article adjacent to such a portion, a displacement from the movement, a speed of the movement, and/or an acceleration of the movement. The positioning step may include the step of moving the cursor across the display screen by a ball mouse-type controller, an optical mouse-type controller, a touch pad-type controller, a track ball-type controller, a joystick-type controller, a disk-type controller, a key-type controller, and the like.

Such a method may further include the step of performing the moving and positioning steps in any sequence and/or at least substantially simultaneously. The method may include one of the steps of performing the single positioning step and multiple the moving steps in any sequence or order, performing the single moving step and multiple the positioning steps in any sequence or order, and/or performing multiple moving steps and multiple positioning steps in any sequence or order.

Such a method may include the step of disposing the coarse controller and the fine controller to be independently accessible by the user. The method may further include the step of disposing at least a portion of the coarse controller spaced apart from, adjacent to, next to, around, within, over, on, underneath or below at least a portion of the fine controller.

In other aspects, methods may be provided to move a cursor defined on a display screen of a display unit for an information processing device to a target position along a target path by a cursor control system with at least two controllers. Both of the target positions and target paths are defined on the display screens and selected by users of the devices. In one aspect, a method may include the steps of coarsely moving the cursor to or toward a vicinity of the target position at a fast speed using a coarse controller and precisely positioning the cursor in the target position at a slow speed using a fine controller. In another aspect, a similar method may include the steps of independently receiving a fine input signal and a coarse input signal from the user by a fine controller and a coarse controller, respectively, coarsely moving the cursor to a vicinity of the target position at a fast speed in response to the coarse input signal by the coarse controller, and precisely positioning the cursor in the target position at a slow speed in response to the fine input signal by the fine controller thereafter. In another aspect, a method may include the steps of providing at least one coarse controller and at least one fine controller independently accessible to the user, receiving a coarse input signal from the user directly by the coarse controller, coarsely or fastly moving the cursor to or toward a vicinity of the target position at a fast speed in response to the coarse input signal by the coarse controller, receiving a fine input signal from the user directly by a fine controller, and precisely positioning the cursor in the target position at a slow speed in response to the fine input signal by the fine controller independently of the coarse controller. In another aspect, a method may also include the steps of receiving a coarse input signal from the user by a coarse controller, coarsely moving the cursor to or toward a vicinity of the target position at a fast speed in response to the coarse input signal by the coarse controller, receiving a fine input signal from the user by a fine controller thereafter, and then precisely positioning the cursor in the target position at a slow speed in response to the fine input signal by the fine controller. In a further aspect, a method may also include the steps of arranging a coarse controller to be directly and physically accessible by the user, receiving a coarse input signal from the user by the coarse controller, coarsely or fastly moving the cursor to or toward a vicinity of the target position at a fast speed in response to the coarse input signal by the coarse controller, arranging a fine controller to be directly and physically accessible by the user, receiving a fine input signal from the user by using the fine controller at least substantially independently of the coarse input signal, and precisely positioning the cursor in the target position at a slow speed in response to the fine input signal by the fine controller independently of the coarse controller.

In yet another aspect, a cursor control system may be provided to move at least one cursor defined on a display screen of a display unit for an information processing device along a target path defined on the display screen and selected by an user of the device. Such a cursor control system may be made by a process including the steps of providing at least one fine controller arranged to receive at least one first input signal from the user, arranging the fine controller to move the cursor on the display screen in response to the first input signal at a first speed, also providing at least one coarse controller arranged to receive at least one second input signal from the user independently of the first input signal, and arranging the coarse controller to move the cursor on the display screen in response to the second input signal at a second speed faster than the first speed.

In a further aspect, a fast cursor controller may be provided for a cursor control system which may move at least one cursor defined on a display screen of an information processing device along a target path which is defined on the display screen and selected by an user of the device. Such a cursor control system may include at least one slow conventional cursor controller which is arranged to receive a first input signal from the user and to move the cursor on the display screen in response to the first input signal at a slow speed. The fast cursor controller of the cursor control system may be made by a process including the steps of disposing at least one sensor in an operative relation to the slow cursor controller and arranging the sensor to be directly accessible by the user, to receive at least one second input signal directly from the user, and to move the cursor on the display screen in response to the second input signal at a fast speed faster than the slow speed.

As used herein, an “information processing device” refers to a device which may store, read, process, and/or otherwise perform an arithmetic and/or logical operation on information in an analog, digital, optical, and/or magnetic format. Such an information processing device typically includes at least one microprocessor, integrated circuit, optical processor, biological processor, and so on, each of which may store, read, process, and/or perform above operations on such information. Examples of such an information processing device may include, but not necessarily be limited to, a computer, an electronic game device, a personal digital (or data) assistant, a communication device, an audiovisual device, a global positioning device, an automation device for a factory, an office or a house, a security device for a factory, an office or an residence, an industrial control device such as a control panel for industrial equipment, an automotive control device, a scientific analytical device, a camera, a camcorder, a consumer electric device, and the like, each of which may operatively couple with a display unit with a display screen defining a cursor thereon. The computer may include a desk-top computer, a portable computer such a notebook computer, a hand-held computer such as a palm-pilot, and the like. In particular, such a computer may include at least one telecommunication unit which may in turn include an audio and/or video communication unit.

A “display unit” refers to any device having at least one “display screen” on which the above information may be statically and/or dynamically displayed. Examples of such a “display unit” may include, but not limited to, a passive matrix display device, an active matrix display device, a liquid crystal display device, an inorganic light emitting device, an organic light emitting device, a projection device, a plasma display device, a multi-dimensional virtual display device, an electroluminescence display device, a photoluminescence display device, a photoelectroluminescence display device, a cathode ray tube, and the like, each of which may include at least one display screen thereon. More particularly, at least one pointer is movably defined on the display screen of the display device such that an user (or operator) may move and position the pointer at a target position also defined on the display screen. Depending on functional or operational characteristics of the display device and/or the information processing device, the pointer may take a variety of forms such as, e.g., a movable cursor, a selectable highlighted region, and/or their equivalents.

A term “cursor” collectively refers to any types of pointers used to point a graphical object, a command, and/or a hot spot displayed on the display screen of the display unit used in conjunction with the information processing device. The cursor may have various shapes such as, e.g., a thin vertical, horizontal or slanted arrow head, a vertical, horizontal or slanted arrow head with a body, a double-sided arrow head, a quadruple-sided arrow head, a highlighted zone displayed in the display screen, and the like.

As used herein, a “manual” speed of a cursor means a speed of such a cursor caused by a movement of at least a portion of a cursor controller effected by an user. That is, the user may move the cursor at such a manual speed by moving a mouse-type cursor controller, by rotating a rollable ball of a track ball-type cursor controller, by swiveling a handle of a joystick-type cursor controller, by pushing down a disk of a disk-type cursor controller, by pressing down a key-type cursor controller, and the like. The user may also move the cursor at a manual speed by moving his or her body part such as a finger tip across a sensing zone of a touch pad-type cursor controller. As is evident from this definition, the manual speed entirely depends upon the movement effected by the user and may have a value ranging from a near-zero speed to a very fast speed. In order to compare the manual speed with other cursor speeds attainable by coarse controllers and/or adjustors as will be disclosed in greater detail herein, the “manual” speed is to be defined herein as a nominal speed to move the cursor from its current position near a lower right corner of the display screen precisely to a target position near an upper left corner of the display screen by any of the foregoing conventional cursor controllers. When this definition may be indefinite, the “manual speed” is to be preferably defined as a length of a diagonal of the display screen per second, because a speed of the cursor depends not only upon a speed of the movement of the user but also upon the dimension of the display screen of the display unit. In addition, a “speed” of the cursor, a “slow speed” of the cursor, a “cursor speed,” a “nominal speed” of the cursor or an average speed of the cursor herein represents to the “manual speed” unless otherwise specified. To the contrary, a “fast speed” or a “faster speed” herein refers to a cursor speed attained or attainable by various coarse controllers and/or adjustors of the present invention.

Unless otherwise defined in this specification, all technical and scientific terms used herein have the same meaning as commonly understood or used by one of ordinary skill in the art to which this invention belongs. Although various methods and/or materials that are equivalent or similar to those described herein can be used in practice or testing of the present invention, suitable methods and/or materials are described herein. All published patent applications, patents, publications, and other references mentioned herein are incorporated by reference in their entirety. In case of conflict, the present specification, including definitions, will control. Furthermore, unless other specified, the materials, methods, and/or examples herein are exemplary and illustrative only, and not intended to be limiting the scope of this invention.

Other features and advantages of the present invention will become apparent from following detailed description and/or from the claims.

### BRIEF DESCRIPTION OF THE DRAWINGS

FIG. 1 is a schematic view of a conventional display screen with graphical objects displayed thereon;

FIG. 2A is a schematic diagram of an exemplary embodiment of a cursor control system with a stationary fine cursor control member and a stationary coarse cursor control member according to the present invention;

FIG. 2B is a schematic diagram of an exemplary stationary coarse cursor control member for a cursor control system of FIG. 2A according to the present invention;

FIG. 3A is a schematic diagram of another exemplary embodiment of a cursor control system with a movable fine cursor control member and a movable coarse cursor control member according to the present invention;

FIG. 3B is a cross-sectional view of an exemplary cursor control system obtained along a line AA of FIG. 3A, where an exemplary coarse cursor control system has a movable light source and a stationary light detector according to the present invention;

FIG. 3C is a cross-sectional view of an exemplary cursor control system obtained along a line AA shown in FIG. 3A, where an exemplary coarse cursor control member includes a pointer and a touch pad according to the present invention;

FIG. 3D is a cross-sectional view of an exemplary cursor control system obtained along a line AA shown in FIG. 3A, where an exemplary coarse cursor control member includes a ball and a pair of transducers disposed therearound according to the present invention;

FIG. 3E is an exploded schematic diagram of an exemplary coarse cursor control member of FIG. 3D according to the present invention;

FIG. 3F is a cross-sectional view of an exemplary cursor control system obtained along a line AA shown in FIG. 3A, where an exemplary coarse cursor control member has a direction detecting mechanism according to the present invention;

FIG. 3G is an exploded schematic diagram of an exemplary coarse cursor control member of FIG. 3F according to the present invention;

FIG. 4A is a schematic diagram of another exemplary embodiment of a cursor control system with a movable fine cursor control member and a coarse cursor control member disposed below the fine cursor control member according to the present invention;

FIG. 4B is a schematic diagram of another exemplary embodiment of a cursor control system with a movable fine cursor control member and a movable coarse cursor control member according to the present invention;

FIG. 4C is a schematic diagram of another exemplary embodiment of a cursor control system with a movable fine cursor control member and a stationary coarse cursor control member according to the present invention;

FIG. 4D is a schematic diagram of another exemplary embodiment of a cursor control system having a movable fine cursor control member and another stationary coarse cursor control member according to the present invention;

FIG. 5A is a schematic diagram of another exemplary embodiment of a cursor control system with a rotatable fine cursor control member and a coarse cursor control member disposed about the fine cursor control member according to the present invention;

FIG. 5B is a schematic diagram of another exemplary embodiment of a cursor control system with a rotatable fine cursor control member and an assembly of coarse cursor control member about the fine cursor control member according to the present invention;

FIG. 5C is a schematic diagram of another exemplary embodiment of a cursor control system with a rotatable fine cursor control member and a movable coarse cursor control member according to the present invention;

FIG. 6A is a schematic diagram of an exemplary embodiment of a hybrid-type cursor control system including a mouse-type cursor control member and an exemplary stationary adjustor spaced apart therefrom according to the present invention;

FIG. 6B is a schematic diagram of an exemplary embodiment of a hybrid-type cursor control system with a mouse-type cursor control member and an exemplary movable adjustor according to the present invention;

FIG. 6C is a schematic diagram of an exemplary embodiment of a hybrid-type cursor control system having a touch pad-type cursor control member and a pair of exemplary adjustors according to the present invention; and

FIG. 6D is a schematic diagram of an exemplary embodiment of a hybrid-type cursor control system including a joystick-type cursor control member and an exemplary adjustor incorporated to an input unit according to the present invention.

### DETAILED DESCRIPTION OF EXEMPLARY EMBODIMENTS

The present invention generally relates to various exemplary aspects and/or embodiments of cursor control systems and methods therefor to provide coarse and fine control in positioning cursors or pointers used on display screens of display units of various information processing devices. More particularly, such cursor control systems and related methods allow the user to quickly move such a cursor to a vicinity of a target point through an initial coarse maneuvering, and to precisely position such a cursor in the target position through a subsequent fine maneuvering. As will be described in greater detail below, such cursor control systems and related methods of the present invention may advantageously allow the user to move the cursor at one of different (e.g., normal, fast, slow, and/or adaptive) speeds on the display screen such that the user can move and position the cursor in the target position without having to apply multiple movements or strokes. Accordingly, the movement and/or positioning of the cursor can be more efficiently and effectively executed.

Various exemplary aspects, embodiments, and methods therefor of the present invention will now be described and, more particularly, with reference to accompanying drawings and texts, where the aspects and embodiments of a variety of cursor control systems and methods therefor disclosed herein represent only different aspects, embodiments, and methods of this invention. Such systems and methods of the present invention, however, may also be embodied in many other different forms. Thus, the exemplary aspects and embodiments of the cursor control systems and methods therefor described herein shall not be interpreted to limit the scope of this invention. Rather, such exemplary aspects, embodiments, and methods described herein are provided so that the following disclosure will be thorough and complete, and fully convey the scope of the present invention to one of ordinary skill in the arts of electrical engineering, computer engineering, computer science, and other related disciplines.

Various cursor control systems and methods therefor of the present invention may generally be categorized into one of “composite” cursor control systems (and methods therefor) and “hybrid” cursor control systems (and methods therefor). The composite cursor control system may include at least one coarse cursor control member (abbreviated as a “coarse controller” hereinafter) as well as at least one fine cursor control member (abbreviated as a “fine controller” hereinafter). In particular, the fine controller of the composite cursor control system may advantageously be any conventional cursor control device. The coarse controller of the composite cursor control system allows an user to move the cursor to a vicinity of the target position at a fast speed or directly to an edge or a corner of the display screen, while the fine controller of the composite cursor control system allows the user to fine control the positioning of the cursor in the target position. The hybrid cursor control system may include at least one cursor control member (abbreviated as a “cursor controller” hereinafter) and at least one adjustor. The cursor controller of the hybrid cursor control system may advantageously be any conventional cursor control device, while the adjustor provides the user with multiple settings of ranges of cursor speeds. Accordingly, the user may select one of different settings of the ranges of the cursor speeds and move the cursor on the display screen at one of the normal, fast, and slow speeds.

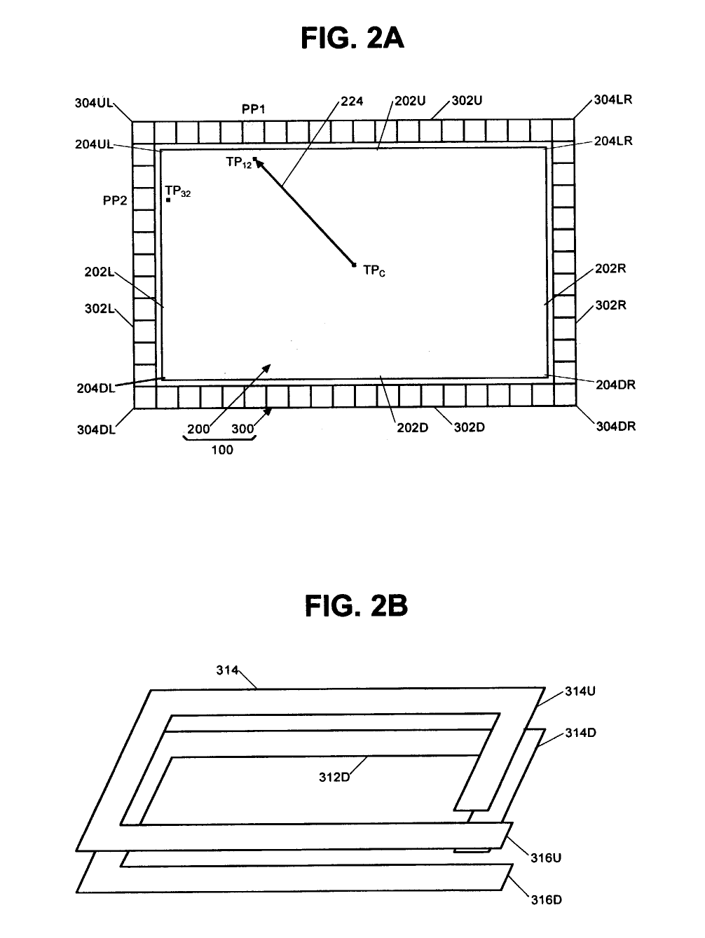

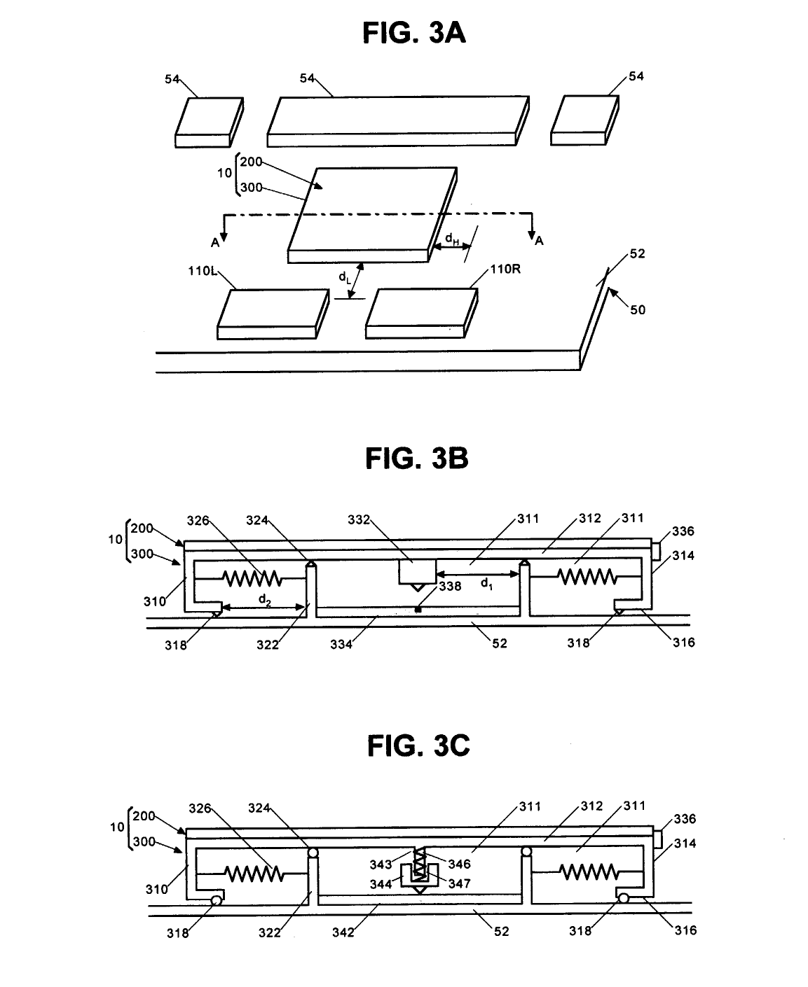

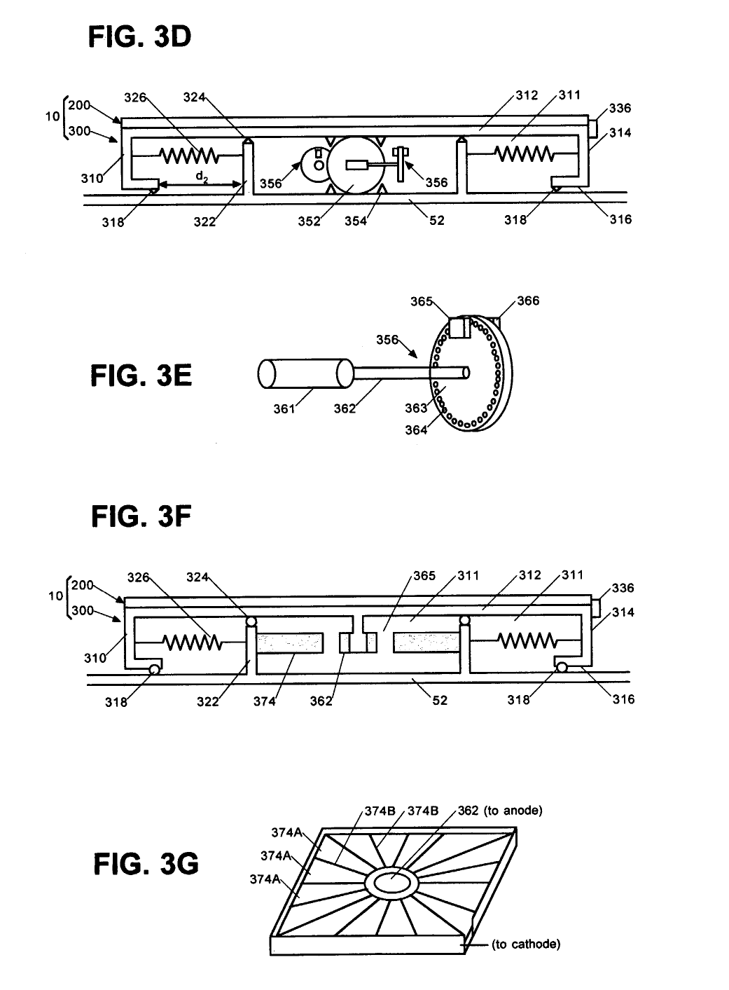

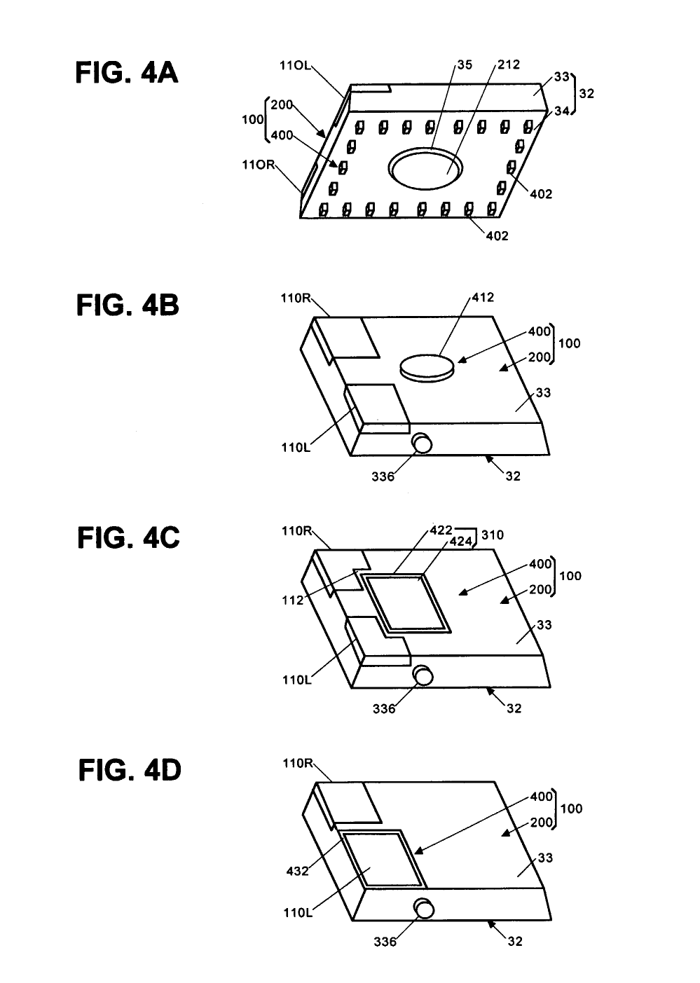

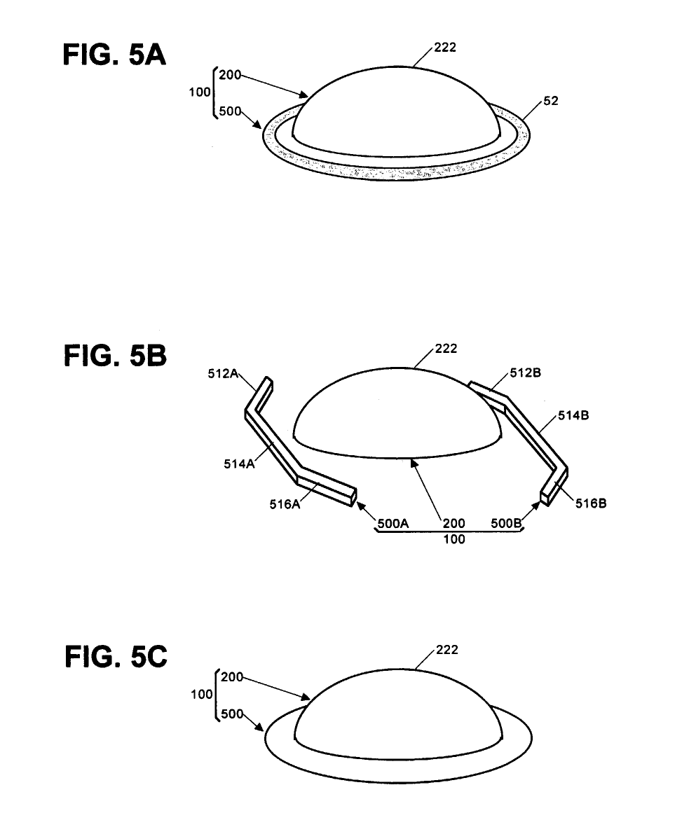

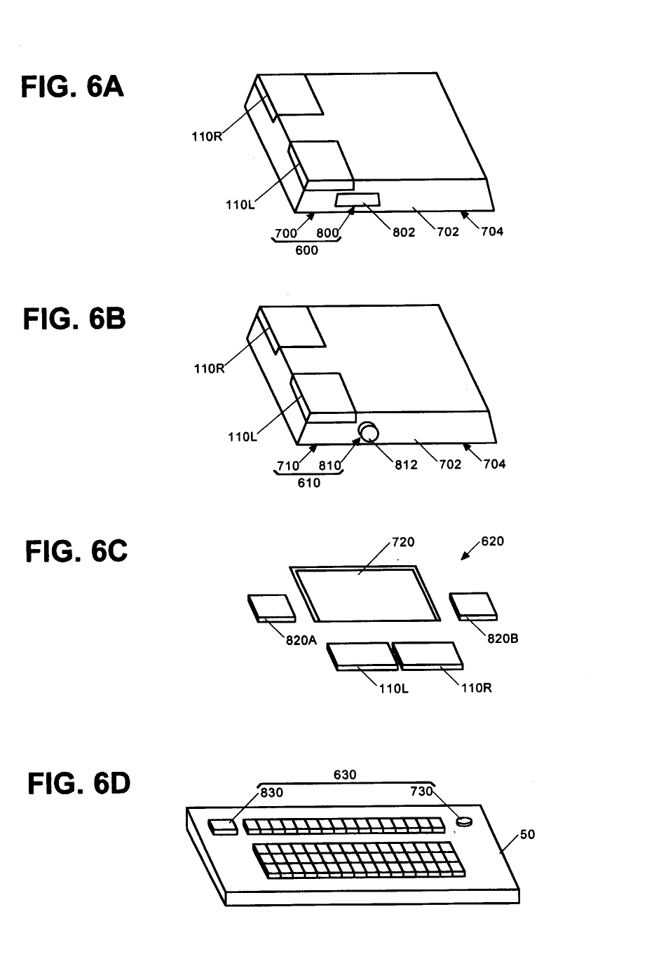

Following figures and relevant texts describe a variety of exemplary cursor control systems and related methods. For example, FIGS. 2A and 2B denote exemplary embodiments of composite cursor control systems and methods therefor, in which conventional touch pad-type controllers are used as fine controllers and in which various stationary coarse controllers are incorporated thereto; FIGS. 3A through 3G relate to exemplary embodiments of further composite cursor control systems and methods therefor, in which conventional touch pad-type controllers are used as fine controllers and in which various movable coarse controllers are incorporated thereto; FIGS. 4A to 4D describe further exemplary embodiments of composite cursor control systems and methods therefor, where conventional mouse-type controllers are used as fine controllers and where various stationary and movable coarse controllers are implemented thereto; FIGS. 5A to 5C represent further exemplary embodiments of composite cursor control systems and methods therefor, where conventional track ball-type controllers are used as fine controllers and where various stationary and movable coarse controllers are incorporated thereto; and, finally, FIGS. 6A to 6D represent exemplary embodiments of hybrid cursor control systems and methods therefor, where various conventional cursor control devices are employed as cursor controllers and where various adjustors are incorporated thereto.

Unless otherwise specified, cursor control systems of this invention, coarse or fine controllers thereof, cursor controllers thereof, and adjustors thereof are not generally drawn to scale for ease of illustration. In addition, such systems, controllers, adjustors, their members, units, elements, and/or parts designated by the same numerals and/or those with different alphanumeric suffixes generally denote the same, similar, structurally alternative, and/or functionally equivalent systems, controllers, adjustors, members, units, elements, and parts thereof.

In one aspect of the present invention, an exemplary cursor control system includes at least one fine controller and at least one coarse controller. The fine controller may be similar or identical to conventional touch pads, whereas the coarse controller may include a row, a column or an array of sensors which may be shaped as a rectangular annular strip and may function similar or identical to conventional touch pads, except that the coarse controller may move the cursor at a faster speed than the fine controller. FIG. 2A represents a schematic diagram of an exemplary embodiment of a cursor control system having a stationary fine cursor control member and a stationary coarse cursor control member according to the present invention. An exemplary composite cursor control system 100 may include a single fine cursor control member (abbreviated as a “fine controller” hereinafter) 200 which is conventionally embodied as touch pads, and a single coarse cursor control member (abbreviated as a “coarse controller” hereinafter) 300 disposed external to and around such a fine cursor controller 200.

The fine controller 200 defines a rectangular sensing zone which is bordered by four straight and mutually orthogonal edges such as, e.g., an upper edge 202U, a right edge 202R, a lower edge 202D, and a left edge 202L, and such edges 202 intersect and define four corners 14 such as, e.g., an upper-right corner 204UR, a lower-right corner 14DR, a lower-left corner 14DL, and an upper-left corner 14UL. Underneath the sensing zone are generally provided an array of various sensors (not shown in the figure) capable of detecting presence and/or movement of an object such as a finger tip of the user when disposed on top of the sensing zone and moving thereacross. Upon detection, the sensors generate electrical signals in response thereto. The information processing device receives and analyzes the signals to recognize locations of the signal-generating sensors of the sensor array and to move or position the cursor accordingly along an intended target direction 24 and target path 26. A variety of conventional touch pad sensors and their mechanisms may be employed for the fine controller 200. As an example, U.S. Pat. No. 4,680,430 issued on Jul. 14, 1987 to Yoshikawa et al. discloses a resistive film to determine coordinate position data of a point on a display screen which is indicated by a touch of a finger tip or other load. U.S. Pat. No. 4,103,252 issued on Jul. 25, 1978 to Bobick discloses an array of capacitors which define a sensing region detecting a human touch by changes in capacitive charge caused by a touch which then varies a time constant of an RC network which is a part of an oscillator. U.S. Pat. No. 4,736,191 issued on Apr. 5, 1988 to Matzke discloses a touch activated control device including individual conductive plates in which the user's touch on a dielectric layer overlaying a plate is detected by individually changing and discharging each sector in the plate in a sequential manner to determine increased capacitance of such a sector. U.S. Pat. No. 4,550,221 issued on Oct. 29, 1985 to Mabusth describes a touch sensitive control device which translates a touch location to output signals and includes a substrate supporting multiple interleaved, closely spaced, non-overlapping conducting plates. U.S. Pat. No. 4,639,720 issued on Jan. 27, 1987 to Rympalski et al. discloses an electronic pad containing a graphics input pad having an array of transparent capacitive pixels, the capacitance characteristics of which are changed in response to passing of a conductive tipped stylus over the surface of the graphics input pad. European Pat. Pub. No. 574,213 filed on Jul. 6, 1993 by Miller described a proximity sensor array which senses changes in capacitance between horizontal and vertical conductors connected to a position sensing pad so as to determine x-, y-, and z-positions. U.S. Pat. No. 5,305,017 issued on Apr. 19, 1984 to Gerpheide also describes a touch sensitive input pad on which the user inputs position information using his or her finger. In addition, International Pub. WO 9,718,546 filed on Nov. 12, 1996 by Gerpheide discloses a tactile feedback touch pad system including a combination of textures and raised ridges on a pad surface to indicate programmable button portions which, when tapped, execute preselected functions programmably assigned to those buttons. Other position-sensitive sensors or mechanisms may also be applied to the fine controller 200 of the present invention. It is appreciated that all of the foregoing patents and publications are to be incorporated herein by reference in their entireties.

Regardless of the sensor types, the number of sensors provided under the fine controller 200 is generally determined by various factors such as, e.g., a length and a width of the sensing zone, an intended resolution or density of the sensors per an unit area of the sensing zone, static or dynamic sensor characteristics, and so on. However, because the sensing zone of such a fine controller 200 is significantly smaller than the display screens of the display units of information processing devices, such a sensing zone cannot cover an entire portion of the display screen. Therefore, when the user moves his or her finger tip along a longest diagonal of the sensing zone, the cursor is displaced only about a half of a longest diagonal of the display screen, which necessitates the user to apply several strokes to move the cursor from one end to the other end of the display screen. As will be discussed in greater detail below, the cursor control systems and methods therefor of the present invention can advantageously solve such a problem.

The coarse controller 300 is generally similar or identical to conventional touch pads, except that the coarse controller 300 is differently shaped and sized to enclose the edges and corners of the fine controller 200. More particularly, the coarse controller 300 has four straight edges 302 such as an upper edge 302U, a right edge 302R, a lower edge 302D, and a left edge 302L which intersect to define corners 304 such as, e.g., an upper-right corner 304UR, a lower-right corner 304DR, a lower-left corner 304DL, and an upper-left corner 304UL. Such a coarse controller 300 generally includes a single resistive or capacitive sensor or a row or an array of the above sensors therealong in such a way that there roughly exists one-to-one correspondence between the sensors along the edges 302 and corners 304 of the coarse controller 300 and the sensors along the edges 202 and corners 204 of the fine controller 200, and so on. The sensors are activated when tapped, touched or pressed upon and then generate electrical output signals in response thereto. The information processing device receives the output signals therefrom, assesses the locations of the sensors which produces the output signals, and moves the cursor to the target position 22 along the target direction 24 and target path 26.

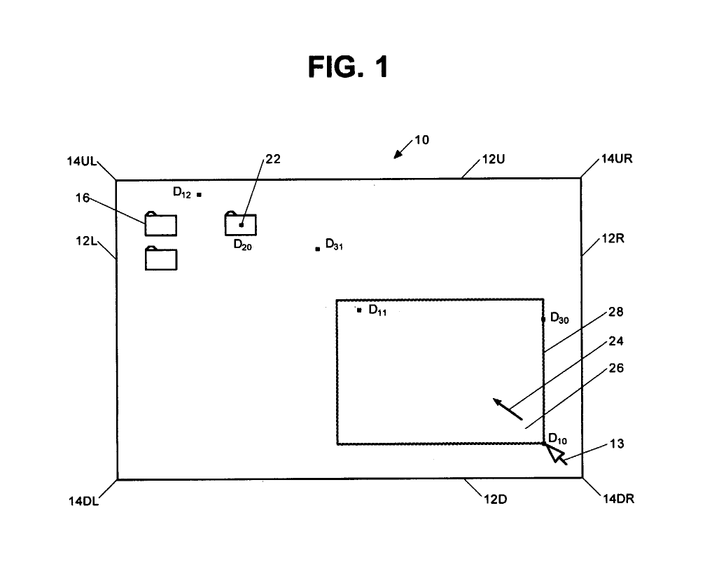

In operation, the user finds a new target position, D₂₀, on the display screen 10 and confirms the current target position, D₁₀. The user then constructs the target direction 24 and the target path 26 along which the cursor 18 has to be displaced. When a length of the estimated target path 26 is less than or about one half of the diagonal of the target screen 10, the user may move the cursor 18 to the target position 22 from the current cursor position solely by manipulating the touch pad-type fine controller 200. When the length of the estimated target path 26 is longer than a half of such a diagonal, however, the user first uses the coarse controller 300 to move the cursor 18 to a vicinity of the target position 22 and then uses the fine controller 200 in order to accurately locate the cursor 18 at the target position 22. For example and in reference to FIG. 1, the user first constructs the target direction 24 on the display screen 10. The user constructs an “estimated” target direction 224 on the sensing zone of the fine controller 200, e.g., by drawing a straight line passing through a center, TP_{C}, of the fine controller 200 at the same slope of the target direction 26 or, alternatively, by connecting the center, TP_{C}, of the fine controller 300 to an estimated target point, TP₁₂, on the fine controller 200 which is estimated by the user with respect to its center, TP_{C}. The user extrapolates the estimated target direction 224 to the coarse controller 300 and obtains a location, PP₁, of the coarse controller 300 disposed at an intersection between the estimated target direction 224 and the coarse controller 300. Thereafter, the user activates the coarse controller 300 by tapping, touching, and/or pressing the location, PP₁ (or a sensor disposed therein) and optionally holding the location, PP₁. The coarse controller 300 generates an electrical output signal, and the information processing device receives the output signal and moves the cursor 18 along the target direction 24 at a preset speed which is generally faster than a manual speed of the cursor 18 by the fine controller 200. When the cursor 18 approaches the target position 22 (i.e., an undershoot ending at a point, D₁₁) or passes beyond the target position 22 (i.e., an overshoot such ending at a point, D₁₂), the user releases his or her finger from the location, PP₁, and deactivates the coarse controller 300 to stop the fast movement of the cursor 18 along the estimated target direction 224. The user then activates the fine controller 200 by positioning his or her finger tip on the sensing zone thereof, and positions the cursor 18 precisely in the target position 22. In another example where the user wants to move the cursor 18 currently in the cursor position, D₃₀, to the target position, D₂₀, the user constructs the target direction between the positions D₃₀ and D₂₀ on the display screen 10. The user subsequently constructs an estimated target direction on the sensing zone of the fine controller 300, e.g., by drawing a straight line passing through the center, TP_{C}, of the sensing zone having the same slope as the target direction 26 on the display screen 10 or by connecting such a center, TP_{C}, and the estimated target position, TP₃₂, on the sensing zone. The user extrapolates the estimated target direction and obtains a location, PP₂, activates the coarse controller 300 by pressing the location, PP₂, and optionally holding the location, PP₂. The information processing device then moves the cursor 18 along the target direction 26 at the preset fast speed. It is appreciated, in both exemplary manipulations, that the user's movement is thereby confined to an upper-left portion of the fine and coarse controllers 200, 300. By obviating multiple strokes as required in the conventional touch pad-type controllers, the cursor control system 100 of this invention allows the user to perform more accurate and effective positioning of the cursor 18 in the target position 22.

The coarse controller 300 may be arranged to move the cursor 18 along the target direction 24 and/or the target path 26 in various ways. The coarse controller 300 is generally activated when the user applies thereto various input signals by, e.g., touching, tapping, pressing, and/or pushing the selected location and/or sensor of the coarse controller 300. The sensor of the coarse controller 300 generates electrical output signals in response to the input signals. The information processing device receives the output signals, assesses the target direction 24 and/or target position 26, and positions the cursor 18 in the target position 22. The cursor 18 is generally moved along the target direction 24 at a constant speed which is generally selected to be about the same or faster than a slow, manual speed of the cursor 18 effected by the conventional touch pad-type controllers. More particularly, such a constant speed is to be faster than the cursor speeds attainable by conventional track ball-type controllers, e.g., by a factor which may range from about 125% to about 1,000% or by 125%, 150%, 200%, 250%, 300%, 350%, 400%, 500%, 600%, 700%, 800%, 900% or 1,000% of the slow speeds attainable by any types of the conventional cursor controllers.

Modifications and variations of the foregoing exemplary cursor control systems and methods shown in FIG. 2A also fall within the scope of the present invention. First of all, such cursor control systems may be arranged to have different configurations. For example, the fine controller can have the sensing zones with rectangular, square, other polygonal, circular, oval, and other curved shapes. Similarly, the coarse controller may also have various shapes as long as the sensors thereof may be distributed around the edges and/or corners of the fine controller as far as such an arrangement can provide the user with a physical access to the sensors. Therefore, a hexagonal, octagonal, circular, oval or other curved strip-shaped coarse controller may be disposed around a rectangular or circular fine controller. The coarse controller may be disposed right next to the edges of the fine controller to define a substantially contiguous cursor control system. In the alternative, the coarse controller may be spaced apart from the fine controller to define a gap space therebetween. The coarse controller may be comprised of multiple strips of sensors disposed symmetrically or asymmetrically around the fine controller. For example, such a coarse controller may include four separate sensor strips which are disposed around each edge of the fine controller. When desirable, the coarse controller includes only two sensor strips disposed above and below the fine controller or on a left side and a right side thereof. Such a cursor control system and its coarse and fine controllers may be disposed in almost any location on the input unit such as the keyboard of the computer. The fine and coarse controllers may be arranged to be level with each other or, alternatively, such controllers may also be disposed at different levels so that one is raised over the other. More particularly, when the coarse controller is raised over the body of the keyboard, the sensors may be disposed on top of and/or around sides of the coarse controller. Alternatively, at least one divider may be disposed between the touch-pad fine controller and the touch-pad coarse controller to provide the user with a sensual distinction of different sensing zones of the controllers. Examples of the dividers may include, but not necessarily limited to, a single contiguous article or multiple articles raised along the boundary between the fine and coarse controllers, at least one protrusions and/or grooves defined along such a boundary, and any other tactile or visible (both mono-chromic and multi-chromic) configurations provided along the boundary. In addition, the fine controller may have a smaller size than its conventional counterparts and such a fine controller may be shaped almost arbitrarily, because the coarse controller may move and position the cursor to any locations on the display screen of the display unit at a faster speed. It is appreciated that both the shapes and sizes of the coarse controllers (and/or fine controllers) may be determined to provide the user with independent physical accesses to such controllers so that the user can independently manipulate each controller in any sequence or simultaneously.

In essence, the coarse controller includes either a single sensor providing multiple locations to be selected by the user or a cluster of sensors arranged in a row, column or array and at least one of which may be selected by the user. The exemplary touch pad-type coarse controller is shaped as an annular rectangular, square, polygonal, circular, oval or other curved strip. In general, both of the coarse and fine controllers may have the same density of such locations or sensors, i.e., the same numbers of locations or sensors per unit length or area. When desirable, the coarse controller may have more or less locations or sensors per unit length or area (i.e., a higher or lower density) than the fine controller. It is appreciated that a main function of the coarse controller is to find a direction along which the cursor is to be moved at a faster speed and/or to locate an edge or a corner of the display screen to which the cursor is to be moved. Therefore, the locations or sensors of the coarse controller may be arranged in a row or column in which such locations or sensors may be disposed continuously, contiguously, intermittently, and/or at intervals. The locations or sensors of the coarse controller may also be provided in multiple rows and/or columns. Furthermore, when the number of locations or sensors along the edge of the coarse controller does not exactly match that of the fine controller, the information processing device may preferably interpolate or extrapolate such a spatial information to estimate the target direction and/or target path and to move the cursor accordingly. It is appreciated that the foregoing coarse and/or fine controllers of this invention may employ various sensors. In addition to the foregoing sensors disclosed in the prior art which have been incorporated herein in their entirety by reference, other sensors may also be used to detect directions along which the user intends to move the cursor and locations in which the cursor is to be positioned. Examples of such sensors may include, but not limited to, an accelerometer to detect a vector of acceleration of the movement effected by the user, a displacement sensor to detect a distance of the movement, and other conventional sensors which may provide at least two dimensional coordinate information along which the cursor is to be moved. It is also appreciated that such sensors may not necessarily produce the coordination-specific information. Instead, the information processing device may be arranged to receive the output signals from the non-location specific sensors, to assess the location of such sensors generating the output signals in response to the user's input signals, and to move the cursor toward or to the target position on in the display screen.

The cursor control system may include at least one selection mechanism as commonly found as left and right selection buttons of the conventional input units such as the keyboard. For example, the selection buttons may be separately provided above, below, and/or next to the coarse controller. When desirable, the selection buttons may also be disposed between the coarse and fine controllers. Various functions associated with at least one of such selection buttons may be incorporated into the coarse and/or fine controllers. For example, the coarse controller may include a clicking mechanism thereunder so that the coarse controller selects graphical objects or preset commands when clicked or pushed down. The coarse controller may perform a preset operation associated with the selected graphical objects or commands when pushed down and then held for a period of time longer than a preset threshold and/or when clicked twice or consecutively within a preset period of time. Instead of such pushing or clicking, the coarse controller may also be arranged to be activated when tapped, pressed, or touched. Similarly, the fine controller may be arranged to include the foregoing clicking mechanism thereunder and to select the graphical object or command and/or to perform the preset operations associated therewith.

The cursor control system and/or information processing device may adopt various bases in calculating the estimated target direction which is used to select the location or sensor of the coarse controller touched by the user to move the cursor along the target direction or the target path on the display screen. As illustrated in conjunction with FIG. 2A, one of the estimated target directions may be constructed by drawing a straight line which passes through the center of the fine controller (or its sensing zone) along the target direction. Other estimated target directions may also be constructed by drawing lines which have the same slope as the target direction on the display screen and which also pass through various points of the fine controller such as, e.g., its corners, various points on its edges, and/or an estimated current cursor position of the cursor on the fine controller (or its sensing zone). The estimated target direction may also be constructed by, e.g., drawing another straight line from the estimated current cursor position on the fine controller (or its sensing zone) to or toward the estimated target position thereon.

Not only the cursor control system but also information processing device may be arranged to control the speeds and/or movements of the cursor. As described in conjunction with FIG. 2A, the cursor may move at a fast speed during an active period of the coarse controller (i.e., when the user taps or touches, and optionally holds the selected location or sensor of the coarse controller), and then stop during an inactive period of the coarse controller (i.e., when the user releases the selected location or sensor thereafter). The preset fast cursor speed may be selected, e.g., as a percentage of a length of the diagonal of the display screen along which the cursor can be displaced per second, where such a percentage typically ranges from about 20% to about 500% of such a length or, more particularly, 20%, 35%, 50%, 75%, 100%, 125%, 150%, 175%, 200%, 250%, 300%, 350%, 400%, 450%, and 500% thereof. Such cursor speeds may also be arranged to be adjustable by the user by a hardware such as a control knob of the coarse controller with which the user may adjust the cursor speed and/or by a software such as a cursor emulating program in the information processing device.

Either the coarse controller or the information processing device may also move the cursor at a first preset speed when the user initially applies the input signal and activates the coarse controller, and then accelerate such a cursor when the user provides another input signal such as, e.g., holding down the location or sensor of the coarse controller for a period of time longer than a preset period, tapping or touching the same location or sensor again or double clicking such within a preset period of time, and the like. Upon detecting the additional input signal, the information processing device may increase the speed of the cursor to a preset faster speed or, alternatively, gradually accelerate the cursor speed either continuously or incrementally.(i.e., at intervals). When the coarse controller is arranged to have clicking mechanisms, the information processing device can move the cursor at a first fast speed upon receiving a single clicking signal from the coarse controller, and increase the cursor speed upon receiving a double clicking signal therefrom. When the location or sensor of the coarse controller may detect an external force exerted thereto by the user and/or a contact between the user's finger tip and the sensing zone thereof, the information processing device may control the cursor speed based thereupon. For example, upon touching the coarse controller, the cursor speed may be increased from a normal slow speed to the preset fast speed. Upon touching such a coarse controller once more before releasing it or within a preset period of time, the cursor speed may then be increased by an amount determined by, e.g., a magnitude of the force, a duration of the force, an area of such a contact, a duration of the contact, and the like. Accordingly, the user may adaptively control the cursor speed by adjusting the exerted force or such a contact area. The coarse controller may also be arranged to move the cursor directly to one of the edges and/or corners defined on the display screen. The coarse controller and/or the information processing device may be arranged to effect such a movement of the cursor upon receiving the user's initial input signal or upon receiving the user's additional input signal. Alternatively, the coarse controller and/or information processing device may further be arranged to move the cursor to one of preset inner positions on the display screen other than the edges and corners thereof upon receiving the user's initial or additional input signal. The coarse controller may also include a memory arranged to store coordinate information of the inner positions selected by the user, and then to move the cursor to such positions.

As described above, the information processing device may provide a menu from which the user can select desirable features for controlling the above speeds and/or movements of the cursor. When desirable, the cursor control system may include multiple coarse controllers each of which is at least substantially identical in its function but is disposed in different locations on the display unit, e.g., horizontally, laterally, vertically, and/or radially disposed with respect to the fine controller and spaced apart from each other. Alternatively, multiple coarse controllers may be arranged to perform different functions. For example, a first coarse controller may be disposed around and adjacent to the fine controller to move the cursor along the estimated target direction at a first fast speed, while a second coarse controller is concentrically disposed with respect to the first coarse controller to move the cursor directly to one of the edges or corners of the display screen. In such an embodiment, the user can adaptively manipulate one or both of the coarse controllers depending upon the current and target positions of the cursor.

The cursor control system and/or information processing device may also construct the target paths on various bases. The target direction is universally defined as a direction of a vector from the current cursor position of the cursor to the target position defined on the display screen of the display unit. Accordingly, only one target direction is to be defined for a given set of the current and target positions of the cursor. In contrary, numerous target paths may be constructed to move the cursor along such a target direction. A first target path may be constructed as a straight line connecting the current cursor position and the target position. Alternatively, a second target path may be defined as a staircase-shaped path which connects the current cursor position and the target position but which is a combination of multiple horizontal and vertical unit paths defined on the display screen. A third target path may also be constructed in a zigzag mode or as a combination of multiple curved and/or straight segments leading from the current cursor position to the target position. In general, the first straight target path is most preferred. However, the staircase target path may be found useful in a text environment, while the curvilinear target path may be useful in a graphical environment.

The operation mechanisms of the cursor control system of the present invention may also be tailored in a variety of ways. As described in conjunction with FIG. 2A, the coarse controller may be activated upon receiving the input signal (i.e., when tapped, touched, clicked or pressed upon), and deactivated upon ceasing to receive the input signal (i.e., when released). Accordingly, the cursor begins to move as the coarse controller is activated, keeps moving as far as the user supplied such an input signal, and stops moving when the user subsequently releases and deactivates the coarse controller. Alternatively, the coarse controller may be activated upon receiving the first input signal, and then deactivated upon receiving the second input signal which may be similar to the first input signal. In such an embodiment, the cursor begins to move as the coarse controller is activated, and keeps moving until the user applies the second input signal regardless of whether the user releases the coarse controller. In another alternative, the coarse controller may be activated upon receiving the first input signal and perform a first function (such as, e.g., moving the cursor at the fast speed or toward one of the edges, corners, and inner positions on the display screen), may be activated to a different mode upon receiving the second input signal and perform a second function (such as, e.g., moving the cursor at the faster speed or toward another edge, corner or inner position on the display screen), and then may be deactivated upon receiving a third input signal. As described above, the coarse controller may be arranged to move the cursor according to the magnitudes of the external force applied thereto by the user and/or the contact area therebetween. In such an embodiment, the coarse controller may similarly move the cursor upon receiving the input signal, and stop the cursor upon detecting the cessation of application of the input signal. It is appreciated that conventional on-off means known and used in the art may be employed by the fine and/or coarse controllers. Typical examples of such on-off means may include, but not be necessarily limited to, simple on-off switches, toggle switches, clicking switches, and the like. It is appreciated that the embodiment of FIG. 2A can be implemented into other conventional cursor control devices such as, e.g., mouse-type controllers, track ball-type controllers, joystick-type controllers, disk-type controllers as described hereinabove or hereinafter.

In another aspect of the present invention, a simple sensing mechanism may be incorporated into the coarse controller of the composite cursor control system to construct the target directions in which the cursors can be displaced. FIG. 2B shows a schematic diagram of an exemplary stationary coarse cursor control member for a cursor control system shown in FIG. 2A according to the present invention, where an exemplary coarse controller 300 typically includes at least one elongated upper conductive strip 312U and at least one elongated lower conductive strip 312D. The conductive strips 312U, 312D are generally disposed one above the other, are bent at right angles, and define internal cavities in order to enclose the fine controller 200 (not shown in this figure) therein. The conductive strips 312U, 312D define distal ends 314U, 314D and proximal ends 316U, 316D, where such distal ends 314U, 314D are generally freely floating and not physically contacting corresponding proximal ends 316U, 316D. In particular, the upper and lower conductive strips 312U, 312D are spaced apart from each other by a preset distance and define a gap filled with insulative or dielectric materials. In addition, at least one of the upper and lower conductive strips 312U, 312D may preferably include or be made of elastic or flexible materials so that one or both strips 312U, 312D may move between an unstressed (or undeformed) position and a stressed (or deformed) position.

In operation, the upper strip 312U is electrically coupled to one polarity (e.g., a cathode of a power cell), while the lower strips 312L is electrically coupled to another polarity (e.g., an anode of the power cell or the ground). Because the upper and lower conductive strips 312U, 312D define an open loop and are electrically separated from each other, the coarse controller 300 and conductive strips 312U, 312D are normally “open” and stay inactive in an unstressed, non-contacting position. Similar to the steps described in conjunction with FIG. 2A, the user selects the target position on the display screen, obtains the target direction thereon, constructs the estimated target direction on the sensing zone of the fine controller, extrapolates the estimated target direction on the sensing zone, and then obtains a point of intersection on the sensing zone of the fine controller. After confirming a selected location 314 along the upper conductive strip 312U, the user applies a force and bends the upper strip 312U to its stressed position, thereby bringing the selected location 314 of the upper strip 318U in an electrical contact with the lower strip 312L and forming a closed conduction loop which starts from the proximal end 316U of the upper strip 312U, through the bent portion 314, through a corresponding location of the lower strip 312U, and to the proximal end 316D of the lower strip 316D. The information processing device measures an electric current or voltage, and calculates an exact location 314 along the strips 312U, 312D using a known resistivity (i.e., electrical resistance per unit length or unit area) thereof. As the user releases his or her finger tip from the selected portion 314, the upper strip 312U recoils back to its unstressed position, thereby breaking the closed conduction loop and returning the coarse controller 300 to its normally open unstressed state.

Modifications and variations of the foregoing exemplary cursor control systems and methods of FIG. 2B also fall within the scope of the present invention. For example, the coarse controller may have any configuration capable of generating electric signals upon being tapped, touched or pressed upon by the user. Accordingly, the coarse controller may have a wade range of configurations (such as, e.g., lengths, widths, thicknesses, number of bends, bending angles, and the like) and properties (such as, e.g., conductivities, flexibilities, and other electrical or mechanical characteristics) as far as it may response to the user's input signals. When relatively narrow conductive articles are employed to form the conductive strips, at least a portion of the upper and/or lower strips may be coiled, netted, knitted, webbed, and/or spiraled while forming the similarly elongated strips. In the alternative, such strips may include multiple strands of conductive articles therein and make more than one electrical contact when tapped, touched or pressed upon by the user, thereby exhibiting improved sensitivity in detecting the input signals. The upper strip may preferably have multiple narrow conductive articles arranged horizontally and side by side, where each article is electrically isolated from the adjacent ones. The lower strip may similarly have multiple sheets of such articles each of which is disposed underneath the corresponding conductive article of the upper strip. Accordingly, in response to the input signal, at least one pair of the conductive articles may form the conductive loop therethrough. The information processing device then receives such signals and identifies the selected location along each pair of the conductive sheets. When the estimated values of the selected locations may differ from one set to the other set of such conductive sheets, the information processing device may calculate an arithmetic or geometric average of such signals, thereby finding the best-fitted location selected by the user along the conductive strips. In addition, the upper strip may be made of elastic materials such that the upper strip may recoil back to its original unstressed state when released. In the alternative, at least one elastic unit may be incorporated into the coarse controller and coupled to the upper (or lower) strip such that the elastic unit is deformed when pressed or pushed by the user and then recoils when released. When desirable, conventional toggling unit may be employed such that the user can her an audible sound after he or she properly selects an intended position along the upper (or lower) strip. Moreover, conductive sponges may also be disposed between the upper and lower conductive strips so that the electrical conductivity or resistivity can change without having to press one of the strips enough to touch the other strip. In the alternative, the conductive sponge may be formed as a loop and used as a variable resistance sensor without having to include any of the upper and lower strips. By monitoring changes in conductance or resistance of the sponge strip, the information processing device can calculate the location along the strip selected by the user and move the cursor accordingly. Further configurational details and/or operational characteristics of the cursor control system and the coarse controllers of FIG. 2B may be identical or at least substantially similar to those of FIG. 2A.

In another aspect of the present invention, another exemplary cursor control system includes at least one fine controller and at least one coarse controller, where the fine controller is similar to or identical to conventional touch pad-type controllers and where the coarse controller includes a row, a column or an array of sensors which may be mobile and function similar or identical to conventional or modified touch pad-type controllers. FIG. 3A shows a schematic diagram of another exemplary embodiment of a cursor control system having a movable fine cursor control member and a movable coarse cursor control member according to the present invention. An exemplary composite cursor control system 100 is provided below various keys 54 of an input unit 50 such as a keyboard of the information processing device such as a computer, and includes a single fine controller 200, a single coarse controller 300, and a pair of selectors 110L, 110R. The fine controller 200 shown in FIG. 3A is identical or at least substantially similar to that of FIG. 2A, and moves the cursor 18 according to the input signal from the user such as, e.g., tapping, touching or pressing by the finger tip of the user. The coarse controller 300 is typically disposed inside and/or vertically underneath the fine controller 200 and, therefore, is not clearly identifiable in this figure. Contrary to that of FIG. 2A, however, the coarse controller 300 may include one of various mobile mechanisms which may render the coarse controller 300 move with respect to a body 52 of the input unit 50. Therefore, the fine controller 200 which fixedly couples with the coarse controller 300 also becomes movable with respect to the body 52 thereof. As will be described below, various mechanisms implemented to the coarse controller 300 generate electrical output signals according to a movement of the coarse controller 300, and the information processing device deciphers such output signals and moves the cursor 18 in the target direction 24 on the display screen 10 at a preset fast speed or at accelerating speeds, and/or moves the cursor 18 directly to one of the edges, corners, and inner positions of the display screen 10. The selectors 110L, 110R allow the user to select the graphical object, hot spot, and command in order to perform the intended operation on the information assigned thereto. In general, the movable fine and coarse controllers 200, 300 may include various position and/or motion detection mechanisms, where FIGS. 3B through 3G illustrate various exemplary embodiments thereof. It is appreciated that the embodiments of FIGS. 3B through 3G may be incorporated as the movable coarse controller into other conventional cursor control devices example of which may include, but not necessarily limited to, mouses-type controllers, track ball-type controllers, joystick-type controllers, disk-type controllers, and the like, as described hereinabove or hereinafter.

First, the coarse controller 300 may include a source-detector mechanism as generally seen in conventional light-guided mouse-type controllers. FIG. 3B represents a cross-sectional view of an exemplary cursor control system obtained along a line AA of FIG. 3A. An exemplary coarse cursor control system includes at least one movable light source and at least one stationary light detector according to the present invention. As described above, an exemplary touch pad-type fine controller 200 is identical to or at least substantially similar to that of FIG. 2A. To the contrary, an exemplary coarse controller 300 includes a movable cover 310 including a rectangular top part 312, a side 314, and a bottom part 316. The top part 312 is typically planar, and fixedly or detachably coupled to a bottom surface of the fine controller 200, while the bottom part 316 is typically annular and floating above the body 52 of the input unit 50. The annular side 314 extends between the top part 312 and the bottom part 316, and forms an internal cavity 311 in which a source-detector mechanism of this embodiment is to be disposed as will be described below. On top of the body 52 is provided at least one support 332 which is arranged to movably or slidingly support both the fine controller 200 and the cover 310 of the coarse controller 300. Multiple sliders (such as, e.g., pointed edges, wheels or canisters) 318, 324 may optionally be provided between the bottom part 316 and the body 52 and/or between the top part 312 and the support 322 to reduce static or dynamic friction forces generated therebetween, thereby facilitating sliding movement of the cover 310 of the coarse controller 300 with respect to the body 52 of the input unit 50.

The source-detector mechanism of FIG. 3B generally includes at least one wave source 332 and at least one array of wave detectors 334. The wave source 332 emits electromagnetic waves of preset frequencies and preferably guides the waves along a preferred direction such as, e.g., toward the array of wave detectors 334, where typical examples of the wave sources 332 may include, but not limited to, LED's, lasers, directionalized lights which may be monochromic, multichromic, visible, UV or IR light beams, and so on. The wave source 332 is generally fixed to a bottom of the top part 312 and disposed in a center of the top part 312 such that the wave source 332 is disposed inside or within the supports 322 when the cover 310 is assembled onto top of such supports 332. The wave source 332 is preferably aligned and/or oriented to emit such waves at a preset angle such as, e.g., downwardly and vertically with respect to the body 52 of the input unit 50. The wave detectors 334 desirably receive the waves emitted by various wave sources 332, and generate electrical or optical output signals in response to an amount of energy associated with such waves. Typical examples of such wave detectors 334 may include, but not necessarily be limited to, photo-luminescence devices, photo-detectors, and so on. Such detectors 334 are preferably arranged in a two-dimensional planar array which is fixedly disposed on top of and in parallel with the body 52 of the input unit 50 so that the waves emitted by the wave source 332 automatically impinge upon at least a portion of the wave detectors 334 at right angles. In particular, the array of detectors 334 is spaced apart from the wave source 322 within a preset threshold distance to maximize a sensitivity in detecting the waves. The array of detectors 334 is preferably disposed between the supports 322 so that the wave source 332 is disposed on top of and in a center of the detector array 334. Moreover, each wave detector 324 is functionally coupled or, more particularly, position coded to the information processing device so that the device recognizes the specific wave detectors 334 which are irradiated by the wave source 332, generate the electric output signals, and deliver such output signals to the device.

The coarse controller 300 also includes at least one elastic unit 326 disposed therearound to provide recoil or elastic characteristics thereto. In general, multiple elastic units 326 such as springs are coupled between the support 322 and the side 314 of the cover 310 in an angular and symmetric arrangement about a center of the cover 310 of the coarse controller 300. Each of the elastic units 326 is typically arranged to have a preset Young's modulus, elasticity, and/or unstressed length such that the center of the cover 310 or the top part 312 is aligned on top of a center of the array of wave detectors 334. This position is to be referred to as a “neutral position” hereinafter, where no external force (or no net external force) is applied to the cover 310. When the external force, Fₑₓₜ, is applied to the cover 310 along one direction, at least one elastic unit disposed forwardly along the direction is to be squeezed, whereas at least one other elastic unit disposed backwardly along the direction is to be extended. When such external force is removed, the squeezed elastic unit extends back to its original length, whereas the extended elastic unit is also recoiled to its original length. Therefore, the entire cover 310 recoils back to its neutral position.

It is appreciated that distances of travel of the cover 310 of the coarse controller 300 depend upon shapes and sizes of various parts thereof. For example, the distance of travel of the cover 310 may be limited by the lesser of two dimensions, “d₁” and “d₂,” where d₁ denotes a distance between an inner wall of the support 322 and the wave source 332 and where d₂ denotes a distance between an internal end of the bottom part 316 and an outer wall of the support 322. When d₁ is shorter than d₂, the cover 310 moves the distance of d₁ from the neutral position and the total distance of travel is also d₁. Conversely, when d₁ is longer than d₂, the cover 310 can move the distance of d₂, while the total travel distance is also d₂. Therefore, by arranging shapes and/or sizes of various parts thereof, the coarse controller 300 may also be arranged to effect a preset travel of distance in the horizontal, lateral, and/or radial direction.

The coarse controller 300 further includes at least one detection unit 336 to deactivate one or both of the wave source 332 and wave detectors 334. When the user ceases to apply the force and releases the cover 310 after the cursor 18 moves near the target position 22, the cover 310 recoils to its neutral position. Without any preventive measures, such a wave source 332 would activate other sensors leading to the center of the sensor array 334. The cover 310 would then recoil to its neutral position, and the cursor 18 would also be dragged back to its original position. In order to avoid the unintended movement of the cursor 18, the information processing device may be arranged to sense the recoiling or other unintended backward movement of the cover 310 and to activate the detection unit 336 which deactivates one or both of the wave source 332 and detectors 334 thereupon. When the cover 310 recoils to and/or in the vicinity of its neutral position, the information processing device may then deactivate the detection unit 336 for a next movement of the cover 310 and the cursor 18.

In operation, the cover 310 of the coarse controller 300 is placed on top of the body 52 of the input unit 50 by positioning the support 322 of the body 52 inside an aperture defined by the annular bottom part 316 of the cover 310. Multiple elastic units 326 are then provided symmetrically around the center of the cover 310 between the side 314 and the support 334. Accordingly, the cover 310 is disposed in its neutral position so that the wave source 332 can irradiate light beams on a “neutral” sensor 338 such as the one located in the center of the array of wave detectors 334. Similar to the steps described in conjunction with FIGS. 2A and 2B, the user determines the target position on the display screen 10, finds the target direction from the current cursor position to the target position 22 on the display screen 10, and constructs the estimated target direction on the sensing zone of the fine controller 200. The user applies the force to move the cover 310 of the coarse controller 300 (along with the fine controller 200 coupled thereto) along the estimated target direction with respect to the body 52 of the input unit 50. As the cover 310 translates along the estimated target direction, the wave source 332 also moves therealong with respect to the body 52 while emitting light beams onto different sensors of the array of wave detectors 334, thereby allowing such wave detectors 334 to generate the output signals in accordance with the translating movement of the cover 310 and the wave source 332. The information processing device keeps track of the output signals generated by different sensors of the wave detectors 334 and determines the locations of such signal-generating sensors of the wave detectors 334 as well as a temporal sequence of such a signal generation. The information processing device detects the estimated target direction with respect the body 52 of the input unit 50 thereform, and moves the cursor 18 at the fast speed along a corresponding target path 26 and/or to one of the edges, corners, and inner positions on the display screen 10. When the user moves the cursor 18 to the vicinity of the target position 22, the user finishes the coarse maneuver of the cursor 18 by releasing the cover 310 of the coarse controller 300, effecting two separate events. First, the detection unit 336 monitors the cessation of the application of the external force, raises a flag, and sends an electrical signal to the information processing device which then deactivates one or both of the wave source 332 and/or detectors 334 until the cover 310 recoils to its neutral position and the detection unit 338 detects the next input signal form the user. Second, multiple elastic units 326 begin to return to the unstressed position by pushing and/or pulling the cover 310 with respect to the body 52 such that the cover 310 recoils to its neutral position. Because the wave source 332 is to be deactivated during the recoiling movement of the cover 310, the information processing system leaves the cursor 18 in the vicinity of the target position 22, and does not move the cursor 18 back to its original position. As the user is done with the coarse maneuver of the cursor 18 at the fast speed using the coarse controller 300, he or she manipulates the fine controller 200 to move the cursor 18 precisely to the target position at the slow speed or at the manual speed.

Modifications and variations of the foregoing exemplary cursor control systems and methods of FIG. 3B also fall within the scope of the present invention. First, as is the case with those shown in FIG. 2A, the cursor control system and its fine and coarse controllers may have similarly modified polygonal and/or curved configurations. In addition, the shapes and sizes of the internal parts of the coarse controller may also be varied, and the internal cavity inside the cover of the coarse controller may have different configuration. Therefore, various parts of the coarse controller may be adjusted to effect one or both of the distances, d₁ and d₂. Therefore, the distances d₁ and d₂ may be arranged to be identical measured from the center of the cover as is the case with a round or oval bottom part and a round or oval concentric side, to be constant along each orthogonal direction of the coordinate system as is the case with a rectangular or square bottom part and a rectangular or square side, and so on. Alternatively, the distances d₁ and d₂ may be arranged to be different such that a rectangular bottom part and a rectangular side may be disposed to define the distances d₁ and d₂ which may be proportional to a length-to-width ratio of the display screen of the display unit. Secondly, the coarse controller may be provided with various mechanisms to minimize the frictional resistance during the sliding movement of the cover. As shown in the figure, any number of such sliders may be disposed in any desirable locations between the contacting articles such as, e.g., the top part and the side, the bottom part and the body, and the like. The sliders may be any conventional wheels, canisters, balls, rollers, articles with pointed edges, friction-minimized surfaces, and any other suitable articles which are capable of reducing or minimizing the static and/or dynamic friction forces therebetween.

The cover of the coarse controller may be arranged to recoil to its neutral position by various mechanisms. As described above, the cover may be arranged to have the neutral position in which multiple elastic units are in an equilibrium, i.e., a vector sum of the forces exerted by the elastic units becomes zero and the cover is in a full stop. In such a neutral position, some elastic units may be in their unstressed states, whereas other units may be in their stressed states by being either stretched or squeezed. Such elastic units may be distributed to define the neutral position in various locations of the cover, although the most preferable location for such a neutral position is a center of the cover to guarantee the cover with the longest distance of travel. Any conventional elastic articles may be used as the elastic units examples of which may include, but not necessarily limited to, cylindrical or conical coil springs, flat spiral springs, leaf springs, torsion bars, torque springs, and the like. Such a spring may be a compression spring to be compressed in its stressed position or an extension spring to be extended or elongated in its stressed position. The spring may also be a constant force spring with a constant spring constant or a variable spring with a spring constant which varies according to its length. The elastic unit may include other elastic elements example of which may include, but not limited to, cross-curve materials, snap tapes, stampings, extension round wires, compression round wires or tension round wires which are available from Vulcan Springs Work (Telford, Pa.). When the elastic units are distributed radially around the center of the cover, they are preferably symmetrically disposed therearound, e.g., at every 150 (i.e., twenty-four elastic units), 30° (i.e., twelve elastic units), 45° (i.e., eight elastic units), 60° (i.e., six elastic units), 90° (i.e., four elastic units), and the like. The coarse controller may include one or more spiral spring which is disposed in or near the center of the cover, couples the cover to the underlying base of the input unit, and arranged to produce the recoil force whenever the cover deviates from its neutral position which is its center. The coarse controller may also include at least one viscous unit disposed between the cover and the body of the input unit and arranged to dissipate at least a portion of the energy associated with the external force during the movement of the cover. Inclusion of such a viscous unit may minimize or eliminate oscillation of the cover, where examples of such viscous units may include, but not necessarily limited to, viscous dashpot, shock absorbers, fluid dampers, and liquid die springs available from Taylor Devices, Inc. (North Tonawanda, N.Y.). Selection of the number and types of such elastic and viscous units and the locations of such units is generally a matter of choice of one of ordinary skill in the art.

The source-detector mechanism of such a coarse controller may also be modified according to various different embodiments. First, the wave source and wave detector may be disposed in any locations of the input unit other than inside the inner cavity of the cover. For example, the cover may include an attached part which moves in unison with the cover. The wave source may be coupled to the attached part, and the wave detectors disposed under the wave source to detect the movement of the cover. The attached part may be preferably disposed external to and beside the cover, and apart from the top part and side of the cover and/or the support of the body of the input unit. When desirable, the wave source and detectors may be reversely disposed such that the wave detectors are coupled to the top part of the cover, and the wave source is coupled to the body of the input unit. The wave source and/or detectors may also be disposed at preset angles such that the light beams or waves beams irradiated by the wave source may be reflected, refracted, and/or transmitted by various conventional optical elements examples of which may include, but not necessarily limited to, convex and/or concave lenses, zoom lenses, convex and/or concave mirrors, prisms, and the like. In general, the coarse controller may include any number of wave sources and/or wave detectors as far as the coarse controller generates the output signals representing the estimated target direction. Accordingly, the wave detectors may be arranged in a single file and angled or curved to define an annular rectangular, square, circular or oval array while defining the neutral position in its center so that the array of wave detectors may detect the movement of the cover with respect to the body as soon as the wave source of the cover deviates from the neutral position and emits the light rays on one of the surrounding single-filed detectors. Such an embodiment offers the benefit of employing a minimum number of wave detectors in the coarse controller, usually at the cost of a limited capability of sensing only an initial estimated target direction but not ensuing correctional changes in its course made by the user. Resolution of such a coarse controller depends upon many factors such as, e.g., the number of wave detectors used therein, dynamic sensitivities of the detectors in response to the movable wave source, and so on, where the resolution of the coarse controller is proportional to the number of wave detectors. When the coarse controller incorporates multiple wave detectors which are arranged in a two-dimensional array, each row and/or column thereof may include a minimum of at least three detectors for differentiating three different directions of cursor movements. In contrary, when the wave detectors are arranged in a single file whether angled or curved so as to encircle the neutral position, the coarse controller may include a minimum of four detectors (e.g., a combination of up, down, left, and right, or a combination of upper-left, upper-right, lower-left, and lower-right) or six detectors (e.g., a combination of upper-left, up, upper-right, right, lower-right, down, lower-left, and left). Other combinations may also be possible to detect different directions of movements of the coarse controller.

The cursor control system and/or information processing device may also control movements and/or speeds of the cursor according to various embodiments as described in conjunction with FIG. 2A. For example, the cursor may be moved at a preset constant speed or may also be accelerated during the activation period of the coarse controller, and the cursor may stop during the deactivation period. Such cursor speeds may be defined as certain percentages of the length of the diagonal of the display screen and the user may be given an option to change the percentages. The sensors of the coarse controller may also measure the magnitude of the force exerted thereto by the user, the contact area of the user's finger tip with the sensing zone thereof, and so on. Based on such values, the sensors may generate the output signals having different amplitudes, frequencies, and/or phase angles so that the information processing device may manipulate the cursor speed based thereupon. The coarse controller may also be arranged to move the cursor directly to one of the edges, corners, and preset inner positions of the display screen, based on touching, tapping, pressing, or holding of the sensors, at a constant speed, at increasing speeds, continuously, incrementally, and the like. In the foregoing, the cursor control system or the information processing device may construct various target paths and/or may include multiple coarse controllers as described in conjunction with FIG. 2A.

The operation mechanisms of the cursor control system of the present invention may also be arranged in various embodiments. For example, the user activates the coarse controller by applying various input signals to the cover of the coarse controller. Examples of the input signals may include, but not be limited to, a horizontal and/or vertical force applied to the cover with or without necessarily moving the cover, a horizontal and/or vertical displacement of the cover by a minimum distance or a minimum depth, and the like. The cursor may continue to move thereafter at a constant speed or at increasing speeds toward the target point or to one of the edges, corners, and preset inner positions on the display screen as long as the user keeps the cover away from its neutral position or the user applies such an external force to the cover. In these embodiments, the cursor may move at a faster speed or at increasing speeds toward the target point or directly to one of the edges, corners, and positions of the display screen as the user displaces the cover farther away from its neutral position, as time elapses after the cover is positioned away from its neutral position, as the user applies more force, and so on. The cursor may also continue to move even after the user stops to move the cover or after the user stops to apply the force and lets the cover to recoil and return to its neutral position. The user may stop the cursor by moving the cover again or by applying another force one more time. In all of the above embodiments, the coarse controller may also be deactivated when the user stops to apply the force to the cover, when the magnitude of the applied force falls below a minimum value, when the user stops to move or push the cover, and so on.

The cursor control system may include at least one selection mechanism similar to the one of FIGS. 2A and 2B. For example, one or both of the left and right selection buttons of the conventional display units may be provided at various locations of, on or around the cursor control system. When desirable, all or at least some functions of the selection buttons may be incorporated into the coarse and/or fine controllers, e.g., by incorporating a clicking mechanism underneath the coarse controller so that the coarse controller selects a graphical object, a hot spot or a command when pushed down. In addition, when the coarse controller is pushed and held for a period longer than a threshold and/or pushed down consecutively or twice within a preset period of time, the coarse controller may perform a preset operation associated with the graphical object, hot spot or command. Instead of the clicking, pushing or pressing, the user may activate the coarse controller by gentle tapping or touching so as to select the graphical object, hot spot or command or to perform the preset operations. Similarly, the fine controller may include the foregoing clicking mechanism therewith to select such a graphical object, hot spot or command and/or to perform the preset operations.

The detection unit of the coarse controller of the present invention may further be constructed in various embodiments. First of all, the detection unit may be incorporated into the coarse controller or the information processing device as a hardware and/or software. When desirable, the function of the detection unit may be distributed to both of the coarse controller and the information processing device. Secondly, the backward movement of the cover may be determined by various mechanisms. For example, the detection unit may be arranged to calculate a vector which denotes the movement of the cover from two successive positions thereof and determine whether such a vector points more toward or away from the center of the cover or its neutral position. Upon detecting such a backward movement, the detection unit may stop further cursor movement during the backward movement of the cover by various mechanisms to be described below. In the alternative, the detection unit may calculate a distance from the center of the cover (or its neutral position) to the most current position of the cover. When the distance is less than the one calculated before, the detection unit detects the backward movement, and the coarse and/or the information processing device stops the movement of the cursor. In another alternative, the detection unit may monitor the input signals applied by the user such as, e.g., the force applied to the cover, the tapping, touching, and/or pressing of at least a portion of the cover, and the like. When the detection unit senses the cessation of the application of the force, tapping, touching, and/or pressing, the coarse controller and/or the information processing device may stop the cursor. In addition, the movement of the cursor with the recoiling movement of the cover may be stopped by various mechanisms. For example, the detection unit may electrically isolate the wave source and/or detectors from a power unit upon detecting the backward movement of the cover and then couple the wave source and/or detectors when the backward movement of the cover stops, e.g., when the cover recoils back to or near its neutral position. In the alternative, the information processing device may detect the backward movement of the cover and ignore further signals delivered from the wave detectors in order to prevent backward movement of the cursor with the cover recoiling to its neutral position. In order to effect such, such a detection unit may include at least one relay to open and close electrical circuits to or from the wave source and/or detectors upon and after detecting the backward movement of the cover. In addition, optional sensors may also be implemented to calculate the vectors and/or distances of the cover movement, to measure the force applied to the cover, and so on. When desirable, a manual switch may be provided so that the user may deactivate the wave source, wave detectors, and/or the information processing device. Other provisions to modify one or both of the hardware and/or software of the coarse controller and/or the information processing device may further be employed as long as they may prevent the backward movement of the cursor on the display screen while the cover recoils back to its neutral position.

The coarse controller may further be shaped and sized to facilitate application of the external force thereon and to enhance movement of the cover thereby. For example, the cover may include at least one separate handle such that the user may readily move the cover therewith. Alternatively, the coarse controller may include at least one protrusion and/or groove to increase friction thereof and to allow the user to readily apply the input signal thereto. By engraving several grooves on the sensing zone of the fine controller, on the edges of the fine controller, and/or along the side of the cover, the user may readily move the cover along an intended direction. In addition, various portions of the coarse and/or fine controllers may also be formed convex and/or concave to easily receive the user's finger tip. In addition to the above modifications and variations of the cursor control systems and methods of FIG. 3B, other configurational details and/or operational characteristics of the cursor control system and fine and coarse controllers of FIG. 3B are identical or at least substantially similar to those of FIGS. 2A and 2B.

The coarse controller 300 may include a modified touch-pad mechanism enclosed therein or externally coupled thereto. FIG. 3C is a cross-sectional view of an exemplary cursor control system obtained along a line AA of FIG. 3A, where an exemplary coarse cursor control member includes a pointing rod and at least one sensor and/or sensor array according to the present invention. Similar to the foregoing cursor control systems, an exemplary touch-pad style fine controller 200 is identical or at least substantially similar to that of FIG. 2A. An exemplary coarse controller 300 is constructed to have various parts similar to those of FIG. 2A such as, e.g., the cover 310, top part 312, side 314, bottom part 316, sliders 318, 324, and support 322. The coarse controller 300 also defines a similar internal cavity 311 in which the modified touch pad mechanism of this embodiment is to be disposed. The coarse controller 300 also includes at least one elastic unit 326 capable of generating the recoil force which returns the cover 310 to its neutral position when the user releases the cover 310.

Instead of the wave source 332 and detectors 334 shown in FIG. 3B, the modified touch pad mechanism of FIG. 3C includes at least one sensor (or a sensor array) 342 and a pointing rod 344. The sensor 342 is positioned on top of the body 52 of the input unit 50 and, more particularly, inside the internal cavity 311 and between the supports 322. Any touch pad-type cursor controllers which have been described hereinabove may be used as the sensor 342 of FIG. 3C. The pointing rod 344 may be coupled to and disposed under the top part 312 of the coarse controller 400, e.g., at or near the center of the top part 312 or the cover 310. In addition, the shapes and sizes of the pointing rod 344 are arranged so that a tip of the pointing rod 344 touches and applies a preset force or pressure on the sensor 342 while the pointing rod 344 move along with the cover 310 in response to the input signal from the user. To ensure that the pointing rod 344 does contact the sensor 342 but does not exert the excessive force or pressure thereon, the pointing rod 344 is preferably movably coupled to the top part 312 of the cover 310. In particular, the top part 312 may include a shaft 346 protruding downwardly, whereas a center portion of the pointing rod 344 defines a cavity arranged to receive and retain the shaft 346 therein. An elastic article such as a spring 348 is inserted around the shaft 346 and inside the cavity of the pointing rod 344 so that the spring 348 constantly pushes down the pointing rod 344 and allows the pointing rod 344 to constantly contact the sensor 342 while exerting the preset force or pressure thereto. Therefore, the sensor 342 may monitor the movement of the pointing rod 344 moving in unison with the cover 310 along the estimated target path, generate the output signals in response to the movement of the pointing rod 344, and deliver such signals to the information processing device which is arranged to move the cursor 18 along the target path 26 on the display screen 10 based at least partly upon the output signals. The cursor control system 300 may also include the detection unit 336 which is identical to or at least substantially similar to that of FIG. 3B such that the cursor 18 may not be dragged back to its original position while the cover 310 is recoiling to its neutral position.

In operation, the cover 310 of the coarse controller 300 is placed on top of the body 52 of the input unit 50 by placing the support 322 inside the cavity of the annular bottom part 316 of the cover 310. Multiple elastic units 326 are also symmetrically provided around the center of the cover 310 or the top part 312 thereof and between the outer wall of the side 314 and the support 334. Therefore, the cover 310 is disposed in its neutral position such that the pointing rod 344 touches or presses a “neutral” location (or a “neutral sensor”) located in the center of the sensor 342. Similar to the steps described in conjunction with FIGS. 2A, 2B, and 3B, the user chooses the target position 22 on the display screen 10 and obtains the target direction from the current cursor position toward the target position 22 on the display screen 10. The user then constructs the estimated target direction on the sensing zone of the fine controller 200 and applies the external force to move the cover 310 of the coarse controller 300 (along with the fine controller 200 coupled thereto) along the estimated target direction with respect to the body 52. As the cover 310 moves along the estimated target direction, the pointing rod 344 also moves therealong with respect to the body 52 while touching or pressing different locations of the sensor 342. The information processing device receives the output signals generated by the sensor 342, detects the locations of the locations in contact with the pointing rod 344, and then calculates the temporal sequence of such output signals. The information processing device obtains the estimated target direction and moves the cursor 18 along a corresponding target path 26 at the fast speed and/or moves the cursor 18 to one of the edges, corners, and preset inner positions defined on the display screen 10. When the user moves the cursor 18 to the vicinity of the target position 22, the user finishes coarsely maneuvering the cursor 18 by releasing the cover 310 of the coarse controller 300. The detection unit 336 monitors the cessation of the application of the input signal, raises a flag, and sends an electrical signal to the information processing device which then deactivates the sensor 342. Multiple elastic units 326 also return to their unstressed position by pushing and/or pulling the cover 310 to its neutral position. Because the sensor 342 is deactivated during the recoiling movement of the cover 310 and/or pointing rod 344, the information processing system leaves the cursor 18 in the vicinity of the target position, without moving the cursor 18 back to its original position. When the user is finished with coarsely or roughly positioning of the cursor 18 near the target position 22, he or she subsequently manipulates the fine controller 200 to move the cursor 18 to the target position 22 at the slow speed or at the manual speed.

Modifications and variations of the foregoing exemplary cursor control systems and methods of FIG. 3C also fall within the scope of this invention. First of all, the pointing rod may preferably be arranged to move or slide over the sensor without physically or operatively damaging or degrading the sensor. Various embodiments may also be used to reduce the friction between various parts of the coarse controller and the body of the input unit, e.g., by minimizing the area of contact between such parts, by optimizing the spring constant of the spring to apply sufficient but not excessive force downwardly to put the pointing rod in contact with the sensor, by providing various sliding or rolling mechanisms on a tip of the pointing rod, and so on. As far as the sensor may generate appropriate output signals, the spring constant of the spring is not material to the scope of the present invention. Therefore, any types of springs may be used to as far as the pointer can movably contact the sensor. Secondly, the detection unit of the coarse controller may be constructed in various embodiments. In addition to those described in FIG. 3B such as opening and closing the electric circuits including the sensor of the coarse controller therein, the detection unit may be arranged to retract the pointing rod upwardly or to move the sensor downwardly, thereby physically separating the pointing rod from the sensor and preventing the sensor from generating the output signals. When desirable, the modified touch pad mechanism may also be provided not inside the internal cavity of the coarse controller but external to the cover or other parts thereof. In addition to the above modifications and/or variations, other configurational details and/or operational characteristics of the cursor control system and fine and coarse controllers thereof of FIG. 3C are identical to or at least substantially similar to those of FIGS. 2A, 2B, and 3B.

The coarse controller 300 may also include a modified mouse mechanism externally coupled thereto or enclosed therein. FIG. 3D is a cross-sectional view of an exemplary cursor control system obtained along a line AA of FIG. 3A, where an exemplary coarse cursor control member includes at least one rollable ball and a pair of transducers disposed thereon according to the present invention, and FIG. 3E shows an exploded schematic diagram of the exemplary coarse cursor control member of FIG. 3D according to this invention. Similar to the foregoing cursor control systems, an exemplary touch pad-type fine controller 200 is identical or at least substantially similar to that shown in FIG. 2A. An exemplary coarse controller 300 is also constructed using the parts similar to or identical to those of FIG. 2A such as the cover 310, top part 312, side 314, bottom part 316, sliders 318, 324, support 322, and so on. The coarse controller 300 also defines the internal cavity 311 in which the modified mouse mechanism of this embodiment is to be disposed, and includes the elastic units 326 capable of generating the recoil force to recoil and return the cover 310 back to its neutral position when the user releases the cover 310.

Instead of the wave source 332 and detectors 334 shown in FIG. 3B, the modified touch pad mechanism of FIGS. 3D and 3E includes a rollable ball 352 and at least two transducers 356. Such a ball 352 is fittingly positioned inside the internal cavity 311 and between the supports 322 in order to simultaneously contact a lower surface of the top part 312 and an upper surface of the body 52 of the input unit 50. Any solid or elastic balls may be used as the rollable ball 352 of FIG. 3C as far as the horizontal or lateral movement of the cover 310 with respect to the body 52 may rotate such solid or elastic balls. It is preferred that multiple retainers 354 be provided around the rollable ball 352 to allow the rotation of the ball 352 but to prevent horizontal or lateral displacement of the ball 352 with respect to the body 52. The retainers 354 may be conveniently provided on the lower surface of the top part 312 and/or on the upper surface of the body 52 as shown in FIG. 3D. When desirable, the sliding mechanisms such as wheels, rollers, canisters, and/or pointed tips may also be implemented to the retainers 354 in order to minimize the friction therebetween. At least a pair of transducers 356 may be disposed to contact a surface of the ball 352 and, more preferably, in directions orthogonal to each other such as, e.g., along the x- and y-axes of the Cartesian coordinate system. In general, the transducers 356 are identical or at least similar to those used in conventional ball mouses such that each transducer 354 includes a roller 361 and a wheel 363 which are connected by a shaft 362. The roller 361 is arranged to contact the surface of the ball 352 and to rotate along its longitudinal axis according to the movement of the ball 352, while the wheel 363 forms multiple slits 364 around its edge at a preset interval. At least one wave or light source 365 (e.g., an LED) is fixedly coupled to a portion (e.g., the support 322) of the body 52 and disposed on one side of the wheel 363 so that the waves or light beams emitted by the source 365 pass through the slits 364. On the other side of the wheel 363 is provided a wave or light detector 366 (e.g., a photodetector or a column or an array of such photodetectors) which is fixedly coupled to the body 52 and arranged to detect such waves or light beams emitted by the source 365 and transmitted through the slits 364 of the wheel 363. In this embodiment, the movement of the cover 310 rotates the rollable ball 352 which then translates such a movement into rotational movements of the rollers 361 of the transducers 356. As the rollers 361 rotates, the shafts 362 rotate the wheels 363 in the same direction such that the waves or light beams continuously emitted by the source 365 may be transmitted through the slits 364 and active the detector 366 intermittently. The detector 366 detects the intermittent waves or light beams and generates the intermittent output signals (e.g., pulses of electrical currents or voltages) in response thereto. The information processing device receives the output signals, counts the number of slits 364 encompassed by the movement of the cover 310 in the x- and y-directions, and then moves the cursor 18 accordingly on the display screen 10. The cursor control system 300 may also include the detection unit 336 which is identical to or at least substantially similar to that of FIG. 3B such that the cursor 18 may not be dragged back to its original position on the display screen 10 as the cover 310 is released by the user and recoiled to its neutral position.

In operation, the cover 310 of the coarse controller 300 is placed on top of the body 52 of the input unit 50 by positioning the support 322 of the body 52 inside the cavity defined by the annular bottom part 316 of the cover 310. Multiple elastic units 326 are then provided symmetrically around the center of the cover 310 between the side 314 and the support 322 to position the cover 310 in its neutral position. Similar to those steps described in conjunction with FIGS. 2A, 2B, 3B, and 3C, the user selects the target position 22 and determines the target direction 24 on the display screen 10, constructs the estimated target direction on the sensing zone of the fine controller 200, and applies the external force to move the cover 310 (along with the fine controller 200 coupled thereto) along the estimated target direction. As the cover 310 translates along the estimated target direction, its movement rotates the rollable ball 352 which translates such a movement into rotational movements of the rollers 361 of the transducers 356. As the rollers 361 rotates, the shafts 362 rotate the wheels 363 in the same directions so that the waves or light beams continuously emitted by the source 364 are transmitted through the slits 364 intermittently. Upon detecting such intermittent waves or light beams, the detector 366 generates the intermittent output signals in response thereto, and delivers such signals to the information processing device counting the number of slits 364 encompassed by the movement of the cover 310 in the x- and y-directions and moving the cursor 18 at the fast speed and/or moving the cursor 18 to one of the edges, corners, and inner positions on the display screen 10. When the user moves the cursor 18 to the vicinity of the target position 22, the user finishes with the coarsely maneuver of the cursor 18 by releasing the cover 310. The detection unit 336 monitors the cessation of the application of the external force, raises a flag, and sends an electrical signal to the information processing device, thereby deactivating the source 365 and/or the detectors 366 and preventing the cursor 18 from being dragged back to its original position. At the same time, multiple elastic units 326 return to their unstressed positions by pushing and/or pulling the cover 310 so that the cover 310 recoils to its neutral position. When the user is finished with the coarse maneuver by bringing of the cursor 18 within the vicinity of the target position 22 at the fast speed, he or she starts the fine maneuver by controlling the fine controller 200 to precisely move the cursor 18 to the target position 22 at the slow speed or at the manual speed.

Modifications and variations of the foregoing exemplary cursor control systems and methods of FIGS. 3D and 3E also fall within the scope of the present invention. For example, the rollable ball may be disposed between the top part and the body of the input unit and, therefore, the size of such a ball generally depends on the distance between the top part and the body of the input unit. When a smaller ball is preferred, additional plates may be inserted below the top part or on top of the body to decrease the gap therebetween. The coarse controller may include more than two transducers which may not have to be orthogonal to one another as far as the transducers provide at least two-dimensional displacement signals to the information processing device or as long as the information processing device may decipher the output signals from the transducers and assess the coordinate information. When the three-dimensional positioning is preferred for cursors for three-dimensional display units, at least three transducers are preferably disposed along three orthogonal directions, e.g., the x-, y-, and z-directions of the Cartesian coordinate system, the r-, θ-, and z-directions of the cylindrical coordinate system or the r-, θ-, and directions of the spherical coordinate system. The rollable ball and the transducers may be disposed not only inside the internal cavity as shown in the figure, but also external to the cover when the rollable ball is coupled to and moves with the cover. This embodiment generally offers the benefit of decreasing a necessary thickness of such a coarse controller. The detection unit of the coarse controller may also be provided in various embodiments. In addition to those described in FIGS. 3B and 3C such as opening and/or closing the electric circuits including one or both of the transducers therealong, the detection unit may displace the transducers away from the ball, thereby physically separating the transducers from the surface of the rollable ball and preventing the wave or light detectors of the transducers from generating the output signals. In addition to the foregoing modifications and/or variations of the exemplary cursor control systems and methods therefor of FIGS. 3D and 3E, other configurational details and/or operational characteristics of the cursor control system and fine and coarse controllers of FIGS. 3D and 3E are identical to or at least substantially similar to those of FIGS. 2A, 2B, 3B, and 3C.

The coarse controller 300 may also include various direction detecting mechanisms by using variable-resistance and/or variable-capacitance transducers. FIG. 3F is a cross-sectional view of an exemplary cursor control system viewed along a line AA of FIG. 3A, in which an exemplary coarse cursor control member includes a direction detecting mechanism according to the present invention, and FIG. 3G shows an exploded schematic diagram of an exemplary coarse cursor control member of FIG. 3F according to this invention. Similar to the foregoing cursor control systems, an exemplary touch pad-type fine controller 200 is identical or at least substantially similar to that shown in FIG. 2A. An exemplary coarse controller 300 is constructed from the parts similar or identical to those of FIG. 2A such as, e.g., the cover 310, top part 312, side 314, bottom part 316, sliders 318, 324, support 322, and the like. The coarse controller 300 also defines the internal cavity 311 where the modified direction detecting mechanism of this embodiment is to be disposed and is provided with the similar elastic units 326 to generate the recoil force to return the cover 310 back to its neutral position when the user releases the cover 310.

The direction detecting mechanism of FIGS. 3F and 3G includes a movable member 362 and a deformable conductor 364. The movable member 362 is preferably disposed within the cavity 311 and coupled to the cover 310, e.g., to the center of the top part 312 so as to move in unison with the cover 310. The movable member 362 may be made of a conductive material or may include at least one electrical wire or a conductive article on an exterior portion of the movable member 362 so that an electrical circuit may be formed therethrough. Alternatively, a sensor (not shown in the figure) may be wrapped around the non-conductive movable member 362 so that an electric circuit may be constructed therethrough. The deformable conductor 364 is disposed inside the internal cavity 311 and desirably inside or between the supports 322. The deformable conductor 364 forms an aperture 365 in its center portion and fittingly receives the pointer 362 therein. As will be described below, the aperture 365 may be shaped and sized to snugly receive the movable member 362 therein, or to be slightly larger than the movable member 362 so that a gap may be formed between the deformable conductor 364 and the movable member 362. The deformable conductor 364 is preferably radially segmented so that multiple sections 364A may be constructed angularly around the aperture 365. In addition, at least one insulative separator 364B may be provided between adjacent sections 364A in order to prevent current leakage therethrough. Any deformable conductive materials may be used as the conductor 364, although such materials preferably exhibit a range of an electrical resistance and/or capacitance depending upon an extent of deformation thereof. Examples of such deformable conductive materials may include, but not necessarily be limited to, conductive foams or conductive sponges made of or impregnated with conductive metals, loosely wrapped or aggregated articles of conductive materials, conventional variable resistors which are arranged radially to move toward and away from the aperture 365 of the conductor 364 such as, e.g., variable displacement transducers, and so on. The movable member 362 (or its conductive parts) and each conductive section 364A of the deformable conductor 364 are electrically wired to a power supply unit. Therefore, the movable member 362 and the conductor 364 are normally “open” when there is no contact, and are “closed” when the movable member 362 is moved by the user and contacts at least one section 364A of the conductor 364. The information processing device monitors the electrical current flowing through the circuit (or that flowing through each section 364A of the conductor 364), detects an intensity of such a current and the temporal sequence of the current, and moves the cursor 18 in response to such a current along the target path 26 on the display screen 10. More particularly, such sections 364A of the conductor 364 are position-coded so that the information processing device may recognize from which section 364A the electrical signals may be generated. The coarse controller 300 may further include the detection unit 336 which may be identical to or at least substantially similar to that of FIG. 3B so that the cursor 18 is not dragged back to its original position when the cover 310 is recoiled to its neutral position.

In operation, the cover 310 of the coarse controller 300 is placed on top of the body 52 of the input unit 50 by positioning the support 322 of the body 52 inside an aperture defined by the annular bottom part 316 of the cover 310. Multiple elastic units 326 are then provided symmetrically around the center of the cover 310 between the side 314 and the support 334 to position the cover 310 in its neutral position. Similar to the steps described in conjunction with FIGS. 2A, 2B, 3B through 3E, the user chooses the target position 22 and the target direction 24 on the display screen 10, constructs the estimated target direction on the sensing zone of the fine controller 200, and applies the external force to move the cover 310 (along with the fine controller 200 coupled thereto) along the estimated target direction. As the user moves the cover 310 and the movable member 362 coupled thereto in the estimated target direction, the movable member 362 pushes, squeezes or deforms at least one section 364A of the deformable conductor 364 in the same direction, thereby increasing the contact between the conductive materials and decreasing the electrical resistance thereof. By applying the electric voltage through the circuit including the movable member 362, the deformed section 364A, the electric current flows through the circuit, the intensity of which may depend upon the voltage of the power and the resistance of the deformed section 364A of the conductor 364. The information processing device receives the electric signal, measures its characteristics (such as, e.g., its current, voltage, frequency, phase angle, and the like), and calculates the position of the deformed section 364A of the conductor 364 at least partly based on, e.g., the current through the circuit, the voltage across the circuit, the resistance and/or capacitance of the deformed section 364A, and so on. The information processing device then moves the cursor 18 at the fast speed in the target direction 24 and/or the target path 26 and/or moves the cursor 18 to one of the edges, corners, and preset inner positions on the display screen 10. When the cursor 18 is arranged to move at multiple fast speeds, the information processing device may analyze the movement and/or displacement of the movable member 362 from its neutral position, and determines the cursor speed based on various features of the input signal from the user as described hereinabove. When the user finishes to coarsely control the cursor 18 at the fast speed, the user releases the cover 310. The detection unit 338 senses the cessation of the application of the external force and deactivates the information processing device to prevent the cursor 18 from being dragged back to its original position. The elastic units 326 recoil and return to their unstressed positions by pushing and/or pulling the cover 310 to its neutral position. Thereafter, the user manipulates the fine controller 200 to move the cursor 18 precisely to the target position 22 at the slow speed or at the manual speed.

Modifications and variations of the foregoing exemplary cursor control systems and methods of FIGS. 3F and 3G also fall within the scope of this invention. First, the movable member and/or the aperture defined in the deformable conductor may be formed in various embodiments. However, as far as the movable member may contact and deform at least a portion of the deformable conductor, the exact shapes and/or sizes of the movable member or the deformable conductor are not material to the scope of the present invention. Accordingly, the aperture of the deformable conductor may be arranged to snugly receive the movable member, to be slightly larger than the movable member, or to be slightly smaller than the movable member in which embodiment, a minimum electrical current flows therethrough even when the cover is in its neutral position. Second, the deformable conductor may be arranged to have a zero conductivity, a very low conductivity, or a finite minimal conductivity in its undeformed state (i.e., when the cover is in its neutral position. Thereafter, such a conductivity may gradually increase according to a linear and/or non-linear relationship with linear, areal, and/or volumetric deformations of the conductor. As far as the information processing device may convert the changes in its conductivity or resistivity of the conductor into an extent of its deformation, precise physical or electrical characteristics of the deformable conductor are not material to the scope of this invention.

Multiple conductive sections of the deformable conductor may also be shaped and/or sized in various embodiments, and desirably distributed radially about a center of the deformable conductor. It is appreciated that the resolution of the direction detecting mechanism of FIGS. 2F and 2G may be determined by various factors such as, e.g., a total number of such sections of the conductor, a rate of change in the conductivity or resistivity of the materials used in such sections, and the like. Once the information processing device identifies the deformed conductive section exhibiting the changes in the conductivity, the device moves the cursor in a direction connecting the center of the conductor to the deformed section. Depending on the size of each of the sections or the direction in which the user moves the cover, multiple adjacent sections of such a deformable conductor may be pushed by the cover and change their conductivity or resistivity accordingly. The information processing device detects the relative locations of the deformed sections, senses the changes in their conductivities or resistivities, and calculates an averaged direction along which the cursor is to be displaced. When desirable, the information processing device may also analyze the changes in the properties of each section and calculate an interpolated direction which does not correspond to any specific location of the sections, but to an arithmetic, geometric or weighted average of the locations of the deformed, current-flowing sections of the conductor. Such a deformable conductor of the direction detecting mechanism may be made of a single contiguous conductive article when the information processing device may include necessary hardware and/or algorithms. In addition to the above modifications and/or variations of such exemplary cursor control systems and the methods of FIGS. 3F and 3G, other configurational details and/or operational characteristics of FIGS. 3F and 3G are identical to or at least substantially similar to those of FIGS. 2A, 2B, and 3B to 3E.

In another aspect of this invention, an exemplary cursor control system includes at least one fine controller and at least one coarse controller, where the fine controller is similar to or identical to conventional mouses and where the coarse controller includes a row, a column, and/or an array of sensors which may function similar or identical to conventional touch pads. FIG. 4A is a schematic diagram of another exemplary embodiment of a cursor control system having a movable fine cursor control member and a coarse cursor control member which is disposed adjacent to the fine cursor control member according to the present invention. An exemplary composite cursor control system 100 is provided as a modified mouse-type cursor controller which has a body 32 with a top part 33 and a bottom part 34 and which includes a single fine controller 200, a single coarse controller 400, a pair of selectors 110L, 110R, and the like. The fine controller 200 is generally identical or at least substantially similar to a conventional mouse having a rollable ball 212 at least a portion of which is exposed through an aperture 35 of the bottom part 34, and a pair of the foregoing transducers (not shown in the figure) arranged to contact the ball 212 and to generate electrical signals in response to rotational movements of the ball 212 as described in conjunction with FIGS. 3D and 3E. As the user moves the fine controller 200 along the estimated target path, the fine controller 200 generates such signals representing its movement in two directions, and the information processing device analyzes the electrical signals and moves the cursor 18 along the target path 26. The selectors 110L, 110R allow the user to perform the selection of the intended graphical object, hot spot or command and/or the intended operation of the information as assigned to the graphical object, hot spot or command. Other configurational details and/or operational characteristics of the fine controller 200 are identical or at least substantially similar to those of conventional mouse-type controllers.

The coarse controller 400 includes multiple retractable sensors 402 also exposed through the bottom part 34 around its perimeter. More particularly, such retractable sensors 402 are arranged to be retracted inside the body 32 of the cursor control system 100 as the user applies a vertical force to the body 32 and pushes down a corresponding part thereof, and to be recoiled out of the body 32 as the user releases such a body 32 and ceases to apply the vertical force to the sensors 402. The retractable sensors 402 are arranged to generate the output signals upon being pressed by the user and to deliver the signals to the information processing device, and then to terminate the generation of the signals upon being released by the user. Any conventional force or pressure transducers or displacement transducers may be employed at tips or inside the retractable sensors 402 to generate the output signals in response to the external force exerted thereto, displacement of the sensors 402, or retraction of the sensors 402, and the like. Any conventional retracting and recoiling mechanisms may also be used to retract and recoil the retractable sensors 402 into and out of the body 32. Such sensors 402 are preferably position-coded so that the information processing device can recognize those sensors 402 generating the output signals.

In operation, the user selects the target position 22 on the display screen 10 and obtains the target direction 24 from the current cursor position and the target position 22 on the display screen 10, similar to those steps described hereinabove. The user applies to the coarse controller 400 the input signal such as the vertical force, and tilts the body 32 of the fine controller 200 toward an end portion of the estimated target direction so that only those sensors 402 of the coarse controller 300 disposed at the end portion of such a direction are retracted into the body 32. The retracted sensors 402 generate the output signals, and send such signals the information processing device which is arranged to identify the signal-generating sensors 402 as well as the temporal sequence the signal generation. The information processing device calculates the target path 26 therefrom and moves the cursor 18 along the target path 26 at the preset fast speed and/or to one of the edges, corners, and inner positions on the display screen 10. As the user moves the cursor 18 to the vicinity of the target position 22, the user finishes the coarse maneuvering of the cursor 18 by releasing the body 32. The retracted sensors 402 are then recoiled back to their original positions and stop to generate the signals. Thereafter, the user manipulates the fine controller 200 to move the cursor 18 precisely to the target position 22 at the slow speed or at the manual speed.

Modifications and variations of the foregoing exemplary cursor control systems and methods of FIG. 4A also fall within the scope of the present invention. First, the cursor control system and its fine and/or coarse controllers may have different configurations. More particularly, the bottom part of the body may have rectangular, square, polygonal, circular, oval, and/or other curved shapes around edges of which the retractable sensors may be disposed. Any number of such sensors may be used to register the estimated target direction, although the resolution of the coarse controller may depend upon the number. In general, at least four sensors are preferably disposed on the bottom part so as to determine a set of an upward, downward, left, and right directions or another set of an upper-left, upper-right, lower-left, and lower-right directions. Accordingly, the coarse controller would have to incorporate more sensors should the resolution of the coarse controller be improved. Secondly, the retractable sensors may be arranged to detect many features of the input signal from the user, e.g., the presence or absence of the force applied thereto by the user, displacement of the sensors, the magnitude or extent of such displacement, and so on. For example, conventional force transducers or displacement transducers may be employed to measure the magnitude of the force or the extent of retraction of the sensors pushed into the body of the cursor control system. The measured values may also be used to control the speed of the movement of the cursor and/or to adjust the movement types of the cursor such as, e.g., moving the cursor at a constant fast speed or accelerating speeds or moving the cursor directly to one of the edges, corners, and inner positions of the display screen, where the speeds of the cursor may be defined as certain percentages of a length of the diagonal of the display screen as described above and where the user can optionally change such percentages. The information processing device may also move the cursor 18 to one of the edges, corners, and/or inner positions of the display screen upon receiving the input signals having certain preset features such as, e.g., the movement of the sensors beyond a threshold value, the external force exceeding a threshold force, retraction of the sensors for a period longer than a preset value, and the like. When desirable, the cursor may be moved along various target paths as defined hereinabove, and/or the cursor control system may also include multiple coarse controllers where one coarse controller may move the cursor at a preset fast speed, while another coarse controller moves the cursor directly to one of the edges, corners, and inner positions of the display screen. When multiple sensors may be retracted into the body and generate the output signals, the information processing device may be arranged to calculate an arithmetic, geometric or weighted average of the multiple signals, to find an averaged target direction therefrom, and to move the cursor along the averaged target direction at the fast speed.

The cursor control system of FIG. 4A may further employ various mechanisms of moving and positioning the cursor using the fine and coarse controllers. For example, the coarse controller may be activated by various input signals such as, e.g., the external force exceeding the preset threshold value with or without necessarily retracting the sensors into the body, retraction of the sensors into the body beyond a preset distance, retraction of the sensors for a period longer than a preset period, and the like. Thereafter, the cursor may continue to move at the constant fast speed or at increasing speeds toward the target point or directly to one of the edges, corners, and preset inner positions on the display screen. The cursor may further be arranged to move at such speeds as long as the user pushes down the body of the cursor control system by applying the force thereto, as long as at least one of the sensors is retracted into the body, and the like. The cursor may also be arranged to move at the fast speed toward the target point or directly to one of the edges, corners, and inner positions on the display screen as the user applies more force to the body, as the user retracts such sensors deeper into the body, as time elapses during the retraction of the sensors, and the like. The cursor may continue to move even after the user stops to supply the input signal, in which embodiment the user may stop the cursor movement by supplying another input signal. In all of such embodiments, the coarse controller may be deactivated when the user stops to apply the force to the body, when the magnitude of the force falls below a minimum value, when the user stops to move or push the body, and so on.

The cursor control system may also include selection mechanisms similar to those described herein. For example, the selection buttons may be provided at preset locations of the cursor control system as shown in the figure. In the alternative, all or some functions of such selection buttons can be incorporated into the coarse and/or fine controllers. Therefore, as the body is pushed for a period longer than a preset value and/or pushed down consecutively or at least twice within a preset period, the coarse controller may also perform the preset operations associated with such selection buttons. In addition, pushing and/or pressing the sensors may also activate the coarse controller to select the graphical object, hot spot or command and/or to perform the preset operations. The fine controller may also include the foregoing selecting mechanism of the coarse controller to select the graphical object, hot spot or command and/or to perform the preset operations on the information associated therewith. In addition to such modifications and variations of the exemplary cursor control systems and methods of FIG. 4A, other configurational details and/or operational characteristics of the cursor control system and its fine and coarse controllers may be identical or at least substantially similar to those of FIGS. 2A, 2B, and 3A through 3G. It is appreciated that the exemplary embodiment of the coarse controller in FIG. 4A can be incorporated into other conventional cursor control devices such as, e.g., touch pad-type controllers, track ball-type controllers, joystick-type controllers, and disk-type controllers.

In another aspect of this invention, an exemplary cursor control system includes at least one fine controller and at least one coarse controller, where the fine controller is similar to or identical to conventional mouses and where the coarse controller is a movable switch incorporated into the fine controller. FIG. 4B shows a schematic diagram of another exemplary embodiment of such a cursor control system including a movable fine cursor control member and a movable coarse cursor control member according to the present invention. An exemplary composite cursor control system 100 is constructed similar to that of FIG. 4A so that it includes the body 32 with the top and bottom parts 33, 34, and the fine controller 200 and selectors 110L, 110R which are identical or at least substantially similar to those of FIG. 4A.

Contrary to that of the previous embodiment, the coarse controller 400 of FIG. 4B includes at least one switch 412 and a direction detecting mechanism (not shown in the figure). The switch 412 of the coarse controller 400 is disposed on the top part 33 of the body 32 and arranged to move in at least two orthogonal directions or to rotate about a preset angle such as, e.g., 360° so that the user may turn the switch 412 in an intended direction. The direction detecting mechanism of the coarse controller 400 is generally identical or at least substantially similar to those of FIGS. 3A through 3G so that various sensors of the direction detecting mechanism generate the output signals according to the movement of the switch 412. For example, the direction detecting mechanism may include the source-detector mechanism of FIG. 3B, the pointing rod-sensor mechanism shown in FIG. 3C, the roller-transducer mechanism of FIGS. 3D and 3E, the movable member-deformable conductor mechanism of FIGS. 3F and 3G, and any other conventional sensors as long as they may detect the movements of the switch 412. Examples of the sensors may include, but not necessarily be limited to, force transducers, accelerometers, displacement transducers, motion sensors, optical tracking assembly, and the like. The information processing device receives the output signals generated by the sensors, finds the locations of the signal generating sensors, analyzes the temporal sequence of the output signals, and determines the target path 26 therefrom. The information processing device moves the cursor 18 along the target path 26 at the fast speed, at increasing fast speeds, or directly to one of the edges, corners, and inner positions of the display screen 10. The coarse controller 400 may also include at least one elastic unit (now shown in the figure) which may be identical or at least substantially similar to those of FIGS. 3A through 3G to recoil the switch 412 to its neutral position as the user releases the switch 412. The coarse controller 400 may also include at least one detection unit 336 which is identical or at least substantially similar to those of FIGS. 3A through 3G and which prevents the backward movement of the cursor 18 during the recoiling movement of the switch 412.

In operation, the user selects the target position 22 on the display screen 10 and obtains the target direction 24 from the current cursor position to the target position 22 on the display screen 10, similar to those steps described above. The user applies the horizontal and/or vertical force to press, tilt or swivel the switch 412 toward an end portion of the estimated target direction so that only those sensors of the coarse controller 300 disposed at an end portion are activated to generate the output signals. The information processing device receives such output signals, detects the locations of the signal-generating sensors of the direction detecting mechanism, tracks the temporal sequence of the output signals, and finds the target path 26 therefrom. The information processing device moves the cursor 18 along the target path 26 on the display screen 10 at the fast speed. When the user moves the cursor 18 to the vicinity of the target position 22, the user finishes the coarse control of the cursor 18 and releases the switch 412 which subsequently recoils back to its neutral position by the elastic units of the coarse controller 400. The sensors of the direction detecting mechanism are deactivated and stop generating the output signals. The user may manipulate the fine controller 200 to precisely move the cursor 18 to the target position 22 at the slow or manual speed.

Modifications and variations of the foregoing exemplary cursor control systems and methods of FIG. 4B also fall within the scope of the present invention. First, the cursor control system and its fine and coarse controllers may have similarly modified polygonal and/or curved configurations, and the switch of the coarse controller may be disposed on any desirable location of the control system. The shape and/or size of the switch may be adjusted as long as the user may readily operate such a switch. Therefore, at least one protrusion and/or groove may be provided on or around the switch to provide the user with an enhanced grip. Secondly, various sliding mechanisms described in FIGS. 3A to 3G may also be provided to the coarse controller for minimizing the frictional resistance during the rotating or swiveling movement of the switch. In addition, the switch may be arranged to recoil to its neutral position by various mechanisms. The switch may be arranged to have the neutral position where multiple elastic units are in an equilibrium, or where all elastic units are in equilibrium in which some elastic units may be in their unstressed states while others may be in their stressed states by being either stretched or squeezed. The coarse controller may also include at least one viscous unit to minimize or eliminate underdamped oscillation of the cover. In addition, the switch of the coarse controller may also be arranged to move vertically, laterally, horizontally, radially, and a combination thereof. For example, such a switch may be arranged to move horizontally or laterally in a direction substantially parallel to a surface of the top part of the body by employing the mobile mechanisms described in conjunction with FIGS. 3A to 3G. In the alternative, the switch may be arranged to be pushed down by employing various mechanisms examples of which may include, but not necessarily limited to, vertically extending floating article which is supported by an elastic unit as exemplified by the pointer of FIG. 3C, toggle switches, various force, acceleration or displacement sensors moving vertically, and the like. In another alternative, the switch may be arranged to swivel around without necessarily making any horizontal or lateral movements. It is noted, however, that detailed modes of the movement patterns of the switches are not crucial to the scope of the present invention as far as such switches generate the output signals in response to the force applied thereto by the user and/or to the duration of the force.

The cursor control system and/or information processing device may also control movements and/or speeds of the cursor according to various embodiments described hereinabove. For example, the cursor may move at the constant fast speed or accelerated and stopped, where the speeds may be defined as certain percentages of the length of the diagonal of the display screen and where the user may optionally customize such percentages. The sensors of the direction detecting mechanism may detect magnitudes of the force applied to the switch, displacement of the switch, and/or contact area between the switch and the user's finger tip, and then generate the output signals with different amplitudes, frequencies, and/or phase angles and the information processing device may control the cursor speed based thereupon. The coarse controller may also move the cursor to one of the edges, corners, and inner positions of the display screen based upon touching, tapping, pressing or holding of the sensors at the constant fast speed, at increasing speeds, intermittently or continuously. Such a cursor control system or information processing device may construct various target paths and/or may include multiple coarse controllers as described hereinabove.

The operation mechanisms of the cursor control system of the present invention may also be arranged in various embodiments. The coarse controller may be activated when a horizontal and/or vertical force is applied thereto with or without having to move the switch, when the switch is moved horizontally or laterally beyond a minimum preset distance, and so on. The cursor may continue to move at the constant fast speed or at increasing speeds toward the target point, and/or directly t one of the edges, corners, and preset inner positions on the display screen. The cursor may move as far as the user keeps the switch away from its neutral position or may apply a horizontal and/or vertical force to the switch. The cursor may also move at a faster speed toward the target point or directly to one of the edges, corners, and preset inner positions on the display screen, e.g., when the user may displace the switch farther away from its neutral position, when the switch is pushed down or away from its neutral position for a period longer than a preset threshold, when the user applies the force stronger than a preset threshold, and the like. The cursor may continue to move even after the user stops to move the switch or to apply the force, and allows the switch to recoil and return to its neutral position. In such an embodiment, the user may then stop the cursor by moving the switch again or by applying the force thereto one more time. In all of such embodiments, the coarse controller may be deactivated when the user stops to apply the force to the switch, when the magnitude of the force applied to the switch falls less than a minimum value, when the user stops to move the switch, and the like.

The detection unit may further be provided in various embodiments. As described above, the backward movement of the switch may be detected by various mechanisms such as, e.g., obtaining the vector for the movement of the switch and analyzing the direction of such a vector, obtaining the displacement corresponding to the distance between the switch and its neutral position, sensing the cessation of the application of the force to the switch, and the like. Once the backward movement is detected, the detection unit and/or the information processing device may stop further movement of the cursor during the backward movement of the switch by various mechanisms. For example, such a detection unit may electrically isolate the source-detector mechanism from the power supply upon detecting such a movement of the switch, and then couple the mechanism back when the backward movement is terminated, e.g., when the switch approaches or is recoiled back to its neutral position. In the alternative, the information processing device may be arranged to ignore the signals delivered by the sensors during the backward movement of the switch. To effect such, the detection unit may include at least one relay to open and close the electrical circuits to the source-detector mechanism, may include optional sensors to calculate the foregoing vector and/or distance, to measure the force applied to the switch, to measure the displacement of the cover from its neutral position, and so on. When preferred, a manual switch may be provided so that the user may deactivate appropriate parts of the cursor control system. Further provisions modifying one or both of the hardware and software of the coarse controller and the information processing device may be employed as far as they may prevent the backward movement of the cursor on the display screen while the cover recoils back to its neutral position.

The cursor control system may also include selection mechanisms similar to those described herein. For example, the selection buttons may be provided at preset locations of the cursor control system as shown in the figure. In the alternative, all or some functions of such selection buttons can be incorporated into the coarse and/or fine controllers. Accordingly, as the switch is moved laterally or horizontally or pushed vertically for a period longer than a preset value, consecutively, or at least twice within a preset period, the coarse controller may also perform the preset operations associated with the selection buttons. In addition, moving or pushing the switch may further activate the coarse controller to select the graphical objects, hot spots or commands or to perform the preset operations on the information. The fine controller may include the selecting mechanisms to select the graphical objects, hot spots or commands or to perform the preset operations. In addition to the modifications and/or variations of the exemplary cursor control systems and methods of FIG. 4B described above, further configurational details and/or operational characteristics of the cursor control system and its fine and coarse controllers may also be identical or at least substantially similar to those of FIGS. 2A, 2B, 3A through 3G, and 4A. It is appreciated that the coarse controller in the embodiment of FIG. 4B may also be incorporated into any conventional cursor control devices such as, e.g., touch pad-type controllers, track ball-type controllers, joystick-type controllers, disk-type controllers, and other cursor control devices.

In another aspect of this invention, an exemplary cursor control system includes at least one fine controller and at least one coarse controller, where the fine controller is similar to or identical to conventional mouses, whereas the coarse controller is a modified touch pad implemented adjacent to the fine controller. FIG. 4C is a schematic diagram of another exemplary embodiment of such a cursor control system having a movable fine cursor control member and a stationary coarse cursor control member according to the present invention. An exemplary composite cursor control system 100 is constructed similar to that of FIGS. 4A and 4B such that it forms the body 32 with the top and bottom parts 33, 34. The cursor control system 100 also includes the fine controller 200 and a pair of selectors 110L, 110R which are identical to or at least substantially similar to those shown in FIGS. 4A and 4B.

Contrary to those shown in FIGS. 4A and 4B, the coarse controller 400 of FIG. 4C includes a modified touch strip 422 fixedly coupled to the body 32 so that its sensing zone is exposed through the top part 33 of the body 32. The sensing zone of the modified touch strip 422 includes multiple sensors arranged in an annular rectangle defining an open area 424 where no sensors are disposed. The modified touch strip 422 is functionally identical or at least substantially similar to the stationary touch pads described in conjunction with FIGS. 2A and 2B, where the user taps, touches, presses or clicks the sensors disposed at the end of the estimated target direction. As described in conjunction with the embodiments of the above figures, such sensors generate the electrical signals in response to the user's input, and the information processing device determines the target path and moves the cursor 18 along the path 26 at a constant speed, at increasing speeds, continuously or intermittently, and/or directly to one of the edges, corners, and preset locations on the display screen 10. Although not shown in the figure, the modified touch strip 422 may also be identical to or at least substantially similar to the movable touch pads disclosed in conjunction with FIGS. 3A through 3G, where the user moves, displaces or toggles (or clicks) the cover 310 of the coarse controller 400 so that the sensors of the coarse controller 400 may generate the electrical signals in response to the movement of the cover 310, to the force applied to the cover 310, to a duration of the user's mechanical input onto the cover 310, and the like. The information processing device then similarly moves the cursor 18 along the target path 26 at a constant speed, at increasing speeds, continuously or intermittently or directly to one of the edges, corners, and preset locations on the display screen 10. In such an embodiment, the coarse controller 400 may include at least one elastic unit (not shown in the figure) which may be identical or at least substantially similar to those of FIGS. 3A through 3G so that the cover 310 of the coarse controller 400 recoils to its neutral position as the user releases the cover 310. The coarse controller 400 may include at least one detection unit 336 which is identical or at least substantially similar to those of FIGS. 3A through 3G and which prevents the backward movement of the cursor 18 to its original position during the recoiling movement of the cover 310. The coarse controller 400 and its touch strip 422 may further be disposed on any desirable locations on the top part 33 of the body 32. For example, in the embodiment of FIG. 4C, the center inner portions of the left and right selectors 110L, 110R may be indented so that the touch strip 422 may be disposed at a front portion of the body 32.

In a related aspect of this invention, another exemplary cursor control system also includes at least one fine controller and at least one coarse controller, where the fine controller is again identical or at least substantially similar to conventional mouses and where the coarse controller is a modified touch pad implemented around selectors of such mouses. FIG. 4D represents a schematic diagram of another exemplary embodiment of such a cursor control system with a movable fine cursor control member and a movable coarse cursor control member according to the present invention, where an exemplary composite cursor control system 100 is constructed similar to that of FIGS. 4A through 4C to form the body 32 having the top and bottom parts 33, 34. Such a cursor control system 100 also includes the fine controller 200 and selectors 110L, 110R which are identical or at least substantially similar to those of FIGS. 4A to 4C. To the contrary, the coarse controller 400 of FIG. 4D is in essence functionally equivalent to those of FIGS. 4A to 4C, and also includes another modified touch strip 432 which is fixedly coupled to the body 32 and, more particularly, disposed around the left selector 110L of the cursor control system 100. Other than the locational difference, the modified touch strip 432 is functionally identical to that of FIG. 4C.

In operation and still referring to FIGS. 4C and 4D, the user selects the target position 22 on the display screen 10 and determines the target direction 24 from the current cursor position to the target position 22 on the display screen 10. The user taps, touches or presses the sensors disposed at the end portion of the target direction so that those sensors of the touch strips 422, 432 disposed thereat are activated and generate the output signals. The information processing device receives the output signals, determines the locations of the signal-generating sensors of the sensing zone of the touch strips 422, 432 of the coarse controller 400, tracks the temporal sequence of such signals, calculates the target path 26 therefrom, and moves the cursor 18 in the target path 26 on the display screen 10 at the fast speed or at increasing speeds. When the cursor 18 approaches the vicinity of the target position 22, the user finishes the coarse maneuvering of the cursor 18 and deactivates the coarse controller 400 by releasing his or her finger tip from the touch strips 422, 432. The user then moves the fine controller 200 to precisely position the cursor 18 at the target position 22. When the coarse controller 400 may use the movable touch strips, the above elastic units may be employed to recoil the touch strips 422, 432 to their neutral positions. In addition, the detection unit 336 prevents the cursor 18 from moving backward to its original position by using any of the foregoing deactivation mechanisms described in conjunction with FIGS. 3A through 3G, and 4A through 4C.

Modifications and variations of the foregoing exemplary cursor control systems and methods of FIGS. 4C and 4D also fall within the scope of the present invention. First of all, the cursor control system and the fine and coarse controllers thereof may have similarly modified polygonal or curved shapes. For example, the touch strip of the coarse controller may define the sensing zones having different polygonal and/or curved shapes. In addition, the touch strip may also have various sizes depending upon, e.g., the number and/or sizes of the selectors, an area available on the top part of the cursor control system, the total number of sensors incorporated thereto, and the like. Secondly, the touch strip of the coarse controller may be shaped to be any annular polygons or curved objects as shown in the figures. Alternatively, an optional touch pad or strip may also be implemented in the central open area of the touch strip and used as an auxiliary fine or coarse controller. Thirdly and as described above in conjunction with FIGS. 2A, 2B, and 3A to 3G, the sensors of the touch strip may form a row, a column or an array of multiple sensors, and the sensing zone of the touch strip may be an angled or curved strip of sensors. One or more sensors may be located along each location of the touch strip as long as at least one sensor per each position along the annular touch strip is to be position-coded by the information processing device. Alternatively, the touch strip may include only a single sensor as described in conjunction with FIG. 2B and/or exemplified hereinabove in relation to other conventional cursor control devices. The information processing device finds the estimated target direction from the variable conductance or resistance. In addition, the touch strip may also be arranged to include multiple non-contiguous strip sections each of which may be a part of the touch strip and disposed around different regions of the body.

Although not shown in the figures, conventional touch pad-type cursor control devices may also be used as the coarse controllers for the embodiments of FIGS. 4C and 4D. For example, the touch pad-type device may be implemented on the top part as in FIG. 4C or, alternatively, within and on the left (or right) button as in FIG. 4C, respectively. In these embodiments, each location of the sensing zone of the touch pad-type device is preferably position-coded to the information processing device such that the cursor may move at the fast speed, at increasing speeds, and/or directly to one of the edges, corners, and inner positions of the display screen as the user places his or her finger tip on a given location of the sensing zone of the touch pad-type device. Such an embodiment may offer the benefit of allowing the user to move the cursor at variable fast speed, in which the variable cursor speed may be determined based upon the location on the sensing zone selected by the user and the current cursor position projected onto the sensing zone of the device. In the alternative, the cursor may be moved to the target position disposed inside or on the edges of the display screen in an at least substantially identical interval.

In addition, the touch strip of the coarse controller may be arranged to move with respect to the body. In this embodiment, such a touch strip may be arranged to recoil to its neutral position by various mechanisms identical or at least substantially similar to those movable parts of other coarse controllers of FIGS. 3A to 3G. The touch strip may be arranged to have the neutral position in which multiple elastic units are in an equilibrium, where some elastic units may be in their unstressed state but others may be in their stressed state by being stretched or squeezed, and the like. The coarse controller may also include at least one viscous unit to minimize or eliminate oscillation of the touch pad. Various sliding mechanisms may also be provided to minimize the frictional resistance during the movement of the cover.

The cursor control system and/or information processing device may similarly control speeds or movements of the cursor on the target screen by various embodiments. For example, the cursor may move at the constant fast speed, at increasing faster speeds, continuously, intermittently, to one of the edges, corners, and preset inner positions on the display screen, where such speeds may be defined as certain percentages of the length of the diagonal of the display screen per unit time, and where the user may optionally select such percentages. The sensors may detect the magnitudes of the force applied to the touch strip, the contact area between the user's finger tip and the sensors of the touch strip, the period of time elapsed after receiving the input signal such as, e.g., the horizontal, lateral or vertical displacement of the touch strip. The information processing device may receive various signals representing such input signals, and control the cursor speed or movement types at least partly based on such signals. The cursor control system and/or information processing device may construct various target paths as described hereinabove. In addition, the cursor controller may include multiple coarse controllers as described hereinabove as well.

Operation mechanisms of such a cursor control system and its fine and/or coarse controllers may be provided in various embodiments. The coarse controller may be activated when the external force, either horizontal, lateral or vertical, may be applied thereto with or without necessarily moving the touch strip or when the touch strip is moved horizontally or laterally by a minimum distance or is pushed down vertically by a minimum depth. The cursor may continue to move at the constant fast speed or at increasing faster speeds to the target point or directly to one of the edges, corners, and inner positions on the display screen. The cursor may move as far as the user holds the touch strip down or holds the touch strip away from its neutral position by applying the force thereto. The cursor may also move at the fast speed toward the target point or directly to one of the edges, corners, and preset inner positions on the display screen by the input signals such as, e.g., holding down such a touch strip, the displacement of the touch strip farther away from its neutral position, the duration of the displacement of the touch strip away from its neutral position, more stronger force, and the like. The cursor may continue to move even after the user stops to move the touch strip and/or to apply the force thereto. By incorporating the foregoing elastic units, the touch strip may recoil and return to its neutral position. The user may stop the cursor by moving the touch strip again or by applying the force thereto one more time. In all of the foregoing embodiments, the coarse controller may be deactivated when the user stops to apply the external force to the touch strip, when the magnitude of the external force falls below a minimum value, or when the user stops to move or to push the touch strip.

The cursor control system may also include similar selection mechanisms. For example, one or both of the left and right selectors may be implemented at various locations on the cursor control system. In the alternative, all or at least some functions of the selectors may be incorporated to the coarse and/or fine controllers. When the touch strip is pushed for a period longer than a threshold or pushed down consecutively or twice within a preset period, the touch strip may further be arranged to perform a preset operation on the information. In addition, pushing, pressing, touching or tapping the touch strip instead of clicking may also activate the touch strip to select the graphical object, hot zone or command or to perform the preset operations. The fine controller may include the foregoing clicking mechanism to select the graphical object, hot spot or command and/or to perform the preset operations.

Various detection units may be constructed for movable touch strips of the coarse controller. First, the backward movement of the touch strip may be detected by various mechanisms described hereinabove. The detection unit and/or the information processing device may calculate a vector for the movement of the touch strip, determine its direction, calculate the distance from the center of the touch strip (or its neutral position) to its displaced position, detect the external force applied thereto, and/or detect tapping, touching, pressing or clicking of the touch strip. Upon detecting the backward movement of the touch strip, the detection unit and/or the information processing device may stop the movement of the cursor during the backward or recoiling movement of the touch strip by various mechanisms such as, e.g., electrically isolating the sensors or other electrical circuits from a power unit, terminating processing of the signals by the information processing device, and the like. When the backward or recoiling movement of the touch strip is completed, the isolated sensors or circuits are closed back or the information processing device resumes the signal processing. To effect such, the detection unit may include at least one relay to open and close various electrical circuits, optional sensors to calculate the movement vectors for the touch strip, to measure the displacement from the touch strip to its neutral position, to sense the external force applied to the touch strip, and the like. A manual switch may also be provided so that the user may open the circuits, manipulate operations of the information processing device, and the like. Other provisions modifying the hardware and/or the software of the coarse controller and the information processing device may also be employed as long as they may prevent the backward movement of the cursor on the display screen while the touch strip recoils back to its neutral position.

The movable touch strip may also be shaped and sized to facilitate application of the external force thereto and enhance movement thereof. For example, the touch strip may include at least one separate handle therearound so that the user may readily move the touch pad using the handle. In the alternative, the touch strip may include at least one protrusion and/or groove in order to increase friction thereof. By forming multiple protrusions or grooves on the sensing zone of the touch pad, on the edges thereof, and/or along the side thereof, the user may readily move the touch strip along the intended direction. In addition, various portions of the coarse and/or fine controllers may be formed convex or concave to easily receive the user's finger tip. In addition to the above modifications and variations of the exemplary cursor control systems and methods associated with FIGS. 4C and 4D, other configurational details and/or operational characteristics of the cursor control system and fine and coarse controllers of FIGS. 4C and 4D are identical to or at least substantially similar to those of FIGS. 2A, 2B, 3A through 3G, 4A, and 4B. It is noted that the coarse controller of the embodiment of FIGS. 4C and 4D may be incorporated into other conventional cursor control devices such as the touch pad-type controllers, track ball-type controllers, joystick-type controllers, disk-type controllers, and other cursor controllers.

In yet another aspect of the present invention, an exemplary cursor control system includes at least one fine controller and at least one coarse controller, where the fine controller is similar to or identical to conventional track balls and where the coarse controller includes a row, a column, and/or an array of sensors which may function similar or identical to conventional touch pads. FIG. 5A is a schematic diagram of another exemplary embodiment of a cursor control system having a rotatable fine cursor control member and a coarse cursor control member disposed adjacent to the fine cursor control member according to the present invention. An exemplary composite cursor control system 100 is provided as a modified track ball-type cursor controller which includes a fine controller 200, a coarse controller 500, a pair of selectors (not shown in the figure), and a body 52. The fine controller 200 is generally identical to or at least substantially similar to a conventional track ball-type controller including a rollable ball 222 at least an upper portion of which is exposed through the body 52 and at least two transducers (not shown in the figure) physically contacting the ball 222 and generating the output signals in response to rotational movements of the ball 222 in a way similar to those disclosed in conjunction with FIGS. 3D and 3E. When the user rotates the ball 222 toward the estimated target path, the fine controller 200 generates the output signals which represent a rotational movement of the ball 222 projected onto a two dimensional domain. The information processing device receives and analyzes the output signals, calculates the target path 26 therefrom, and moves the cursor 18 at the slow or manual speed therealong. The selectors (not shown in the figure) generally allow the user to select a graphical object, hot spot or command and/or to perform a preselected operation of the information assigned to the graphical object, hot spot or command. Other configurational details and operational characteristics of the fine controller 200 are typically identical or at least substantially similar to those of conventional track ball-type controllers.

Similar to those of FIGS. 2A, 2B, and 3A through 3G, the coarse controller 500 is similar to or identical to those touch strips of FIGS. 4A to 4D, except that such a coarse controller 500 is shaped and/or sized differently to enclose a circular periphery of the fine controller 200 exposed through the body 52. More particularly, the coarse controller 500 may form an annular circular strip of sensors, where a single sensor or a column of sensors are radially arranged about a center of the rollable ball 222. Similar to those of the embodiments of FIGS. 2A, 2B, and 3A to 3G, the coarse controller 500 is activated by the input signal from the user such as, e.g., tapping, touching, pushing, and pressing at least one sensor of the coarse controller 500, applying the external force thereto by the user, and the like. Once activated, the coarse controller 500 generates the output signals in response to the input signal. The information processing device receives the output signals, obtains the locations of the signal-generating sensors, calculates the target direction 24, and moves the cursor 18 at the fast speed to the target position 22 in the target direction 24 and/or target path 26. The coarse controller 500 may be deactivated and stop to generate the output signals when the user releases at least one sensor thereof or when the user taps, touches or presses the sensor again.

In another aspect of this invention, an exemplary cursor control system is provided similar to that of FIG. 5A. FIG. 5B shows a schematic diagram of another exemplary embodiment of a cursor control system with a rotatable fine cursor control member and an assembly of coarse cursor control member disposed adjacent to the fine cursor control member according to the present invention. An exemplary composite cursor control system 100 includes the fine controller 200 and multiple coarse controllers 500A, 500B spaced apart from each other and symmetrically disposed on each side of the fine controller 200. The sensors of each coarse controller 500A, 500B are position-coded to the information processing device such that an upper part 512A (or 512B), a middle part 514A (or 514B), and a lower part 516A (or 516B) of the left coarse controller 500A (or right coarse controller 500B) correspond to a left (or right) half of the upper edge 12U, the left (or right) edge 12L (or 12R), and a left (or right) half of the lower edge 12D of the display screen 10, respectively. Other configurational details and operational characteristics of the fine and coarse controllers 200, 500A, 500B of FIG. 5B are typically identical or at least substantially similar to those of FIG. 5A.

In yet another aspect of this invention, an exemplary cursor control system is also provided similar to that of FIGS. 5A and 5B. FIG. 5C represents a schematic diagram of another exemplary embodiment of a cursor control system with a rotatable fine cursor control member and a movable coarse cursor control member disposed under such a fine cursor control member according to this invention. An exemplary composite cursor control system 100 also includes a fine controller 200 and a coarse controller 500, in which the fine controller 500 is identical to those of FIGS. 5A and 5B. However, the coarse controller 500 is disposed inside the body 52 of the input unit 50 and arranged to move with respect to such a body 52. Thus, any of the foregoing movable mechanisms described in conjunction with FIGS. 3A through 3G may be implemented to such a coarse controller 500. Other configurational details and operational characteristics of the fine and coarse controllers 200, 500 of FIG. 5C are typically identical or at least substantially similar to those of FIGS. 5A and 5B.

In operation and still referring to FIGS. 5A to 5C, the user selects the target position 22 on the display screen 10, finds the target direction 24 from the current cursor position to the target position 22 on the display screen 10, and calculates the estimated target direction upon the sensing zone of the fine controller 200. The user taps, touches or presses the sensors of the coarse controller 500A, 500B, 500 disposed at an end portion of the estimated target direction such that only those sensors of the coarse controller 500A, 500B, 500 may be activated and generate the electrical output signals. The information processing device receives such output signals, detects the locations of the signal-generating sensors of the coarse controller 500A, 500B, 500, keeps track of the temporal sequence of such signals, calculates the target path 26 therefrom, and moves the cursor 18 at the fast speed along the target path 26 on the display screen 10. When the cursor 18 approaches the vicinity of the target position 22 and the user finishes the coarse maneuver of the cursor 18, the user releases the coarse controller 500A, 500B, 500 and deactivates such. Thereafter, the user may manipulate the fine controller 200 to precisely position the cursor 18 at the target position 22 at the slow or manual speed. As discussed above, when the coarse controller is movable as is the case with FIG. 5C, the elastic units may be incorporated to exert the recoil force and bring the coarse controller 500A, 500B, 500 back to its neutral position. The detection unit may also be implemented in order to prevent the backward movement of the cursor 18 to its original position during the recoiling movement of such a coarse controller 500A, 500B, 500.

Modifications and variations of the foregoing exemplary cursor control systems and methods of FIGS. 5A to 5C also fall within the scope of this invention. First, the coarse controller of FIGS. 5A and 5B may have various polygonal and/or curved configurations such as, e.g., annular rectangular, square, hexagonal, octagonal, oval, and other polygonal or curved shapes. Such a coarse controller may also be disposed adjacent to or around the rollable ball or spaced apart therefrom by defining a gap therebetween. The coarse controller may be arranged to be level with the body of the input unit or raised above such a body to provide the user with an easier access. The raised coarse controller may include the sensors on its top edge, around its side, and the like. The cursor control system of FIG. 5B may include any number of parts of the coarse controllers disposed in any arrangements or any orientations. As long as the sensors of such parts of the coarse controllers are position-coded to the information processing device, each of such multiple coarse controllers may have the same or different number of sensors therein and may be disposed at any desirable locations on the body of the input unit. It is appreciated that the coarse controllers of the embodiment of FIGS. 5A to 5C may be incorporated into other conventional cursor control devices such as the mouse-type controllers, touch pad-type controllers, joystick-type controllers, disk-type controllers, and other cursor control devices. Other configurational details and/or operational characteristics of the cursor control system and fine and coarse controllers of FIGS. 5A through 5C are identical or at least substantially similar to those of FIGS. 2A, 2B, 3A to 3G, and 4A to 4D.

In another aspect of the present invention, a hybrid cursor control system may be comprised of at least one cursor control member and at least one variable range adjustor. Whereas the cursor control member allows the user to move the cursor 18 on the display screen 10, the variable range adjustor allows the user to select a desirable speed range for the cursor 18 from multiple preselected settings. Depending upon the setting selected by the user, the cursor control member may move the cursor 18 at one of a slow speed, a fast speed, increasing speeds, and a slower speed, and/or may move the cursor 18 directly to one of the edges, corners, and inner positions of the display screen 10 at least one of such speeds or at least substantially instantaneously. FIG. 6A is a schematic diagram of an exemplary embodiment of a hybrid cursor control system including a mouse-type cursor control member and an exemplary stationary adjustor spaced apart from the cursor controller according to the present invention. An exemplary hybrid cursor control system 600 typically includes at least one cursor control member 700 (abbreviated as a “cursor controller” hereinafter) as well as at least one variable range adjustor 800 (abbreviated as an “adjustor” hereinafter).

The cursor controller 700 may be similar or identical to a conventional cursor control device such as, e.g., a ball mouse-type controller or an optical mouse-type controller. The cursor controller 700 is arranged to receive at least one first input signal supplied by the user, and to generate at least one original output signal in response to the first input signal. The cursor controller 700 operatively couples with the adjustor 800 so that the cursor controller 700 may deliver the original output signal to the adjustor 800. In general, the user may supply various first input signals to the cursor controller 700, e.g., by moving the ball mouse-type controller over a mouse pad or a flat surface or by moving the optical mouse-type controller over a reflective surface. The cursor controller 700 also includes at least one signal generating unit which is capable of generating the original output signal in response to its movement effected by the user through the first input signal. In general, the signal generating unit may generate any kinds of electrical signals as the original output signal for in order to represent the movements of the cursor controller 700, although it is preferred that the original output signal be a pulse train which includes multiple electrical current pulses or electrical voltage pulses therealong so that such an original output signal may be compatible with the commonly used PS/2 ports of the conventional cursor controlling devices.

The adjustor 800 of such a hybrid cursor controller 600 includes at least one sensor 802 and at least one signal processor (not shown in the figure). The sensor 802 is disposed on one side 702 of the cursor controller 700, where its sensing surface is preferably exposed through such a side 702. Preferably, the sensor 802 is disposed in a location such that the sensing surface thereof may easily be accessed by a body part of the user such as his or her thumb, middle finger, and the like. To the contrary, the signal processor need not to be exposed through a body 704 of such a cursor controller 700 and, therefore, is preferably disposed inside the body 704. The signal processor is arranged to perform various modulations such as, e.g., as an augmentation, an inaction, and an attenuation, on the original output signal as will be described in greater detail below. The adjustor 800 is operatively coupled to the cursor controller 700 to receive the original output signal therefrom. The adjustor 800 is further arranged to have at least two different settings such as at least one inactive setting (or fine setting) and at least one active setting (or coarse setting). The adjustor 800 is arranged to move or operate between such settings, in which each of the inactive and active setting represents a preset range and/or a preset factor for a cursor speed for unchanging or for augmenting the original output signal and/or the cursor speed, respectively.

The sensor 802 of the adjustor 800 is arranged to receive a second input signal provided by the user through its sensing surface and to engage one of the inactive setting and the active settings for the user based upon the user's second input signal. Depending upon various characteristics of the sensor 802, the user may apply the second input signal by positioning or moving his or her body part (e.g., a thumb or body parts) and/or by contacting, pushing or pressing at least a portion of the sensing surface of the sensor 802. Any conventional sensors may be employed as the sensor 802 to detect the second input signal provided by the user, where examples of such sensors may include, but not be limited to, an optical sensor for detecting a presence and/or an absence of the body part of the user thereover, a capacitance sensor for monitoring a change in its capacitance, a resistance sensor for sensing a change in its resistance, a motion sensor for detecting a movement of the body part thereacross, a force transducer for monitoring an external force applied thereto, a deformation sensor for monitoring one-, two-, and/or three-dimensional deformations thereof, and the like. When the second input signal is not applied to the adjustor 800, the sensor 802 is arranged to be inactive or deactivated, and the adjustor 800 is arranged to be in the inactive setting. In contrary, when the user applies the second input signal to the adjustor 800, the sensor 802 is arranged to be active or activated, and the adjustor is arranged to be in the active setting.

After receiving the original output signal from the cursor controller 700, the signal processor is arranged to assess a number of current and/or voltage pulses (referred to as an “original” number hereinafter) included therein. Depending upon the setting selected by the user, the signal processor preferably generates a final output signal by processing the original output signal according to one of preset signal processing algorithms. For example, when the user selects the inactive setting of the adjustor 800, the signal processor unalters the original output signal. Therefore, such a final output signal has to be identical to the original output signal and includes therein the original number of the electrical pulses. The signal processor delivers the unaltered original output signal to the information processing device which then moves the cursor 18 on the display screen 10 at the slow or manual speed as if there were no adjustor. However, when the user selects the active setting of the adjustor 800, the signal processor is arranged to augment the original output signal according to a variety of embodiments, and to generate the final output signal which is an augmented version of the original output signal. In one exemplary embodiment, the signal processor is arranged to add a constant or variable number of electrical current and/or voltage pulses (referred to as an “augmenting number” hereinafter) to the original output signal so that the resulting final output signal is a pulse train having the original number of such pulses as well as the augmenting number of such pulses. Each of such added pulses is preferably identical or at least substantially similar to the pulses of the original output signals. Upon receiving the final output signal, the information processing device can not preferably tell a difference between the pulses of the original output signal and the pulses added thereto. Such an information processing device identifies the original number as well as the augmented number of the electrical pulses and, therefore, moves the cursor 18 on the display screen 10 at one of the fast speeds accordingly. In another exemplary embodiment, the signal processor is arranged to increase the number of pulses included in the original output signal by a constant or variable factor (referred to as an “augmenting factor” hereinafter). That is, the signal processor identifies the original number of the original output signal, and extends the original output signal by repeating by the augmenting-factor times. Accordingly, the resulting final output signal is a pulse train of which a total number of pulses is arranged to be equal to a product of the original number and augmenting factor. Similar to the previous embodiment, the information processing device then receives the final output signal, identifies a total number of the current or voltage pulses included therein, and moves the cursor 18 on the display screen 10 at one of such fast speeds accordingly.

As described in conjunction with various exemplary composite cursor control systems of this invention, the hybrid cursor control system 600 may also vary the speed of the cursor 18 and/or the movement pattern of the cursor 18 based on such an augmenting number and/or augmenting factor. For example, the augmenting factor may be selected as a preset constant such that the final output signal is always longer than the original output signal by the augmenting number of such pulses. In general, the original number of the electrical pulses included in the original output signal may be any arbitrary number. Accordingly, an increase in the cursor speed in such an embodiment is generally a variable percentage of the slow or manual speed of the cursor 18. Similarly, the augmenting factor may also be selected as a preset constant such that the final output signal is always longer than the original output signal by a factor of the augmenting factor and that the speed of the cursor 18 of this embodiment may be increased by a factor of the augmenting factor compared with the slow and/or manual speed according to the original output signal. A recommended range of such an augmenting number may be in a range of about tens, hundreds, and thousands of pulses, and/or may range from 10% to 1,000% of the original number of pulses such as, e.g., 25%, 50%, 75%, 100%, 125%, and so on. In addition, the constant augmenting factor may also vary between 2.0 and 20.0 such as, e.g., 2.0, 3.0, 4.0, 5.0, 6.0, and so on. Moreover, one of both of the constant augmenting number and the augmenting factor may be arranged to have a large value so that the information processing device may also move the cursor 10 to one of the edges, corners, and inner positions of the display unit 10 directly and/or at least substantially simultaneously. When desirable, a preset threshold number of pulses is set by a manufacturer and/or the user such that, when the final output signal includes more pulses than the threshold number, the information processing device moves the cursor 18 directly to one of the edges, corners, and inner positions on the display screen 10. A selection of the constant augmenting number and/or augmenting factor is generally a matter of choice of one of ordinary skill in the art to effect a desirable increase in the cursor speed 18.

Alternatively, both of the augmenting number and the augmenting factor may be arranged to be variable. More particularly, the augmenting number and factor may be determined at least partly based on at least one feature of the second input signal supplied by the user. Depending upon their characteristics, the second input signal or its features may include, but not limited to, a magnitude of the external force applied to at least a portion of the adjustor, a direction of the force, a first duration of the force, a number of applications of such forces, a temporal gap or interval between applications of the forces, a presence or absence of a contact between the user's body part and at least a portion of adjustor, an area of such a contact, a second duration of the contact, a displacement or distance of a movement of at least a portion of the adjustor, a speed of such a movement, an acceleration of the movement, a direction of the movement, a duration of the movement, a deformation of at least a portion of such an adjustor, a mechanical, chemical, electrical, magnetic, and/or optical property of at least a portion of the adjustor, a change in the property of the portion of the adjustor, a presence or absence of an article adjacent to at least a portion of the adjustor, electromagnetic or light waves impinging upon at least a portion of the adjustor, and the like. Accordingly, the signal processor may preferably move the cursor 18 on the display screen 10 at a constant or variable acceleration (i.e., at increasing speeds) by modulating the augmenting member and/or augmenting factor to increase at least partly based upon the first duration, the second duration, a difference between the first duration and a preset offset, a difference between the second duration and a preset offset, the magnitude of the external force, the presence or absence of the article adjacent to the portion of the adjustor, the changes in the capacitance and/or resistance of such a portion, the waves received by the portion, and the like. Such a second input signal may be applied to the adjustor 800 and/or its sensor 802 by, e.g., moving, translating, displacing, rotating, turning, swiveling, pushing, touching, tapping, pressing, tilting, dragging, clicking, and/or holding at least a portion of said adjustor.

The augmenting number and/or augmenting factor may also be arranged to increase at least substantially continuously with the foregoing feature of the second input signal, e.g., in proportion to such a feature of the second input signal, in a power relationship with the feature, in an exponential relationship with the feature, and the like. Alternatively, the augmenting number and/or number may also be arranged to increase intermittently, at intervals or in a step-wise fashion with such a feature. In one embodiment, the manufacturer and/or the user may provide multiple thresholds for the above feature, and the signal processor accelerates the movement of the cursor 18 by increasing such an augmenting number and/or augmenting factor at preset intervals. Accordingly, the signal processor may preferably increase the augmenting member and/or factor by a preset amount or ratio whenever the above feature exceeds one of the preset thresholds. In another embodiment, the manufacturer and/or user may provide another threshold for the above feature, and the signal processor generates the final output signal which is large enough to move the cursor 18 to the edges, corners, and inner positions on the display screen 10 when the foregoing feature exceeds the another threshold.

The cursor controller 700 and adjustor 800 operatively couple with the information processing device to send thereto the setting of the adjustor 800 selected by the user as well as the final output signal generated by the adjustor 800. The emulating software of the information processing device receives the final output signal, converts such an output signal into the distance of the movement or displacement of the cursor 18 on the display screen 10 at a preset ratio, and then moves the cursor 18 at one of multiple speeds depending upon the final output signal. The multiple cursor speed may be chosen as, e.g., a slow speed or a manual speed effected by the user, a fast speed which is to be faster than the slow or manual speed, increasing speeds which are to accelerate over time and to be faster than the slow, manual, and fast speed, a faster speed which is to be faster than the fast speed, and a slower speed which is to be slower than the slow speed or the manual speed. Such a hybrid cursor control system 600 may also include a left selector 110L and a right selector 110R to select an intended graphical object, hot spot or command from the display screen 10 and then to perform a preset operation on the information, respectively. Further details of such selectors 110L, 110R are identical or at least substantially similar to those described in conjunction with the above figures.

In operation, the user identifies the target position 22 on the display screen 10, confirms the current target position thereon, and constructs the target direction 24 and the target path 26 on the display screen 10 along which the cursor 18 has to be displaced. When the length of the target path 26 is less than or about, e.g., one half of the diagonal of the display screen 10 or a distance which is attainable by one stroke of moving the cursor controller 700 effected by the user, he or she leaves or moves the adjustor 800 in or to the inactive setting by applying thereto the second input signal which is arranged to not activate the sensor 802 of the adjustor 800. The user moves the cursor controller 700 along the target direction 24, and the signal generator of the cursor controller 700 generates the original output signal in response to the movement of the cursor controller 700. Because the sensor 802 of the adjustor 800 is not activated, the signal processor of the adjustor 800 unalters the original output signal and produces the final output signal which is identical to the original input signal. The information processing device receives the final output signal from the signal processor, and moves the cursor 18 to the target position 22 on the display screen 10 at the slow or manual speed. To the contrary, when the length of the target path 26 is longer than, e.g., a half of such a diagonal or such a distance attainable by the user's single stroke, the user then moves the adjustor 800 to the active setting by supplying thereto the second input signal which is arranged to activate the sensor 802 of the adjustor 800. The user moves the cursor controller 700 along the target direction 24 so that the signal processor generates the original output signal in response to such a movement of the cursor controller 700. Because the sensor 802 is activated by the second input signal, the signal processor generates the final output signal by augmenting the original output signal as described hereinabove. The information processing device receives the final output signal which is longer than the original output signal, and moves the cursor 18 coarsely to the vicinity of the target position at one of the fast speeds. When the user is finished with the coarse maneuver of the cursor 18, the user releases the cursor controller 700 and switches the adjustor 800 to the inactive setting. Following the foregoing steps, the user manipulates the cursor controller 700, and the information processing device moves the cursor 18 precisely to the target position 22 at the slow or manual speed.

The hybrid cursor control system 600 of the present invention offers numerous benefits over the prior art cursor control devices. First of all, the hybrid cursor control system 600 of this invention provides the adjustor 800 physically spaced apart from the cursor controller 700 such that they may be accessed by the user at least substantially independently. Therefore, the user can apply the first input signal to the cursor controller 700 and the second input signals to the adjustor 800 in any order or even simultaneously, thereby obviating the need for the user to displace the cursor control device along a preset distance to control the cursor speed. Secondly, such a hybrid cursor control system 600 provides separate elements for controlling the movement of the cursor 18 (i.e., cursor controller 700) and for controlling the speed of the cursor 18 (i.e., the adjustor 800). Therefore, such a hybrid cursor control system 600 can allow the user to control the cursor movement without controlling the cursor speed or to control the cursor speed without controlling the cursor movement. In addition, the cursor controller 700 of the hybrid cursor control system 600 is arranged to generate only one set of signals (i.e., the original output signals) which represents the movement direction of the cursor 18 at one preset cursor speed, i.e., the slow speed or the manual speed of the cursor 18. It is appreciated that such an original output signal does not carry any information related to variable cursor speeds at all. Accordingly, it is far easier to develop the hardware and/or software to analyze and process the original output signal. The original output signal is later modulated (i.e., unaltered or augmented) by the adjustor 800 depending upon one of its settings selected by the user, and converted into the final output signal. However, even such a final output signal is generally of the same type as the original output signal in that both of the original and final output signals are pulse trains including different or same number of pulses. Therefore, it is easier to apply the same hardware and/or software to treat both output signals. Moreover, the hybrid cursor control system 600 may readily be implemented to new or used current cursor control devices. Because the signal processor can process the original output signal to generate the final output signal by itself, the hybrid cursor control system 600 may be applied without any specific drivers or without modifying the operation systems of the computer. Furthermore, the hybrid cursor control system of this invention allows the user to move the cursor controller on the surface along the same distance but to move the cursor on the display screen for different distances depending upon the setting selected by the user. Accordingly, the user can move the cursor on the display screen even along its longest diagonal by minimally displacing the cursor controller while switching the adjustor from the active setting to the inactive setting and vice versa.

Modifications and variations of the foregoing exemplary cursor control systems and methods of FIG. 6A fall within the scope of the present invention. First, various hybrid cursor control systems may be provided by incorporating the adjustor of the present invention to other conventional cursor control devices such as, e.g., a touch pad-type controller, a joystick-type controller, a track ball-type controller, a disk-type controller, a key-type controller, and the like. When of these devices are used as the cursor controller of such a hybrid cursor control system, corresponding first input signals may include, but not limited to, the movement of the body part of the user on or across the sensing zone of the touch pad-type controller, the movement of the handle of the joystick-type controller effected by the user, the rotation of the rotatable or rollable ball of the track ball-type controller effected by the user, the movement of the disk of the disk-type controller effected by the user, the depression of the key effected by the user, and so on. Depending upon other operational characteristics of the cursor control devices, such first input signals may include the external force applied to the cursor controller (including its magnitude, direction, frequency, phase angle, number of applications of such forces, intervals between such applications, and so on), duration of applying the first input signal thereto, the movement of the cursor controller (including its direction, direction, path, and the like), the presence or the absence of an object (including the user's body part) adjacent to or over the cursor controller, the waves impinged upon the cursor controller, and the like. Accordingly, the cursor controller may include any of the foregoing sensors to detect and to receive any of the foregoing first input signals, where some examples of such sensors may include, but not be limited to, force transducer, speed meters, displacement sensors, accelerometers, motion sensors, voltage sensors, current sensors, magnetic sensors, variable resistors, resistance sensors, variable capacitors, capacitance sensors, photodetectors, torque sensors, and so on.

The hybrid cursor control system of the present invention may dispose the adjustor in almost any location on or around the cursor controller. For example, such an adjustor may be disposed in positions where the fingers or other body parts of the user can be easily positioned, where examples of such locations may include a top surface of the body of the cursor controller including vicinities of the left and/or right selectors, sides of such a body, and so on. In addition, the adjustor is preferably spaced apart from at least a portion of the cursor controller, adjacent to such a portion, around such a portion, within the portion, underneath or below the portion, on or over the portion, or contiguously with the portion. When desirable, multiple adjustors may also be disposed or, alternatively, multiple switches may be disposed which can activate the adjustor upon receiving the foregoing second input signal from the user. As described above, the sensor or sensors of the adjustor may be arranged to receive various second input signals and any conventional sensors may be employed to detect such second input signals. Furthermore, when the hybrid cursor control system includes more than two selectors, the above adjustor, its sensor, and/or switch may also be disposed in almost any locations including on or around the selectors as far as such a location provides the uses with an easy access thereto.

The adjustor provides the user with multiple settings at least two of which are the active and inactive settings. In general, the adjustor needs only one inactive setting in which the original output signal is unaltered and delivered to the information processing device. To the contrary, the adjustor may provide multiple active settings denoting different functions. For example, each of such active settings may denote a different speed range and may be assigned with a preset augmenting number and/or factor. Thus, the signal processor may generate the final output signal using the augmenting number and/or factor assigned to one of the active settings selected by the user, and the information processing device may move the cursor on or across the display screen at one of the above slow or manual speed, fast speed, faster speed, increasing speeds, slower speed, and the like. In another example, at least some of the foregoing active settings may represent different movement patterns of the cursor on or across the display screen. For example, one of the multiple active settings may be assigned to move the cursor along the target path at one or more of the above speeds, whereas another of the active settings may move the cursor at least substantially directly to one of the edges, corners, and inner positions of the display screen. Such multiple active settings of the adjustor may be provided discretely, incrementally or at large intervals such that there exists a non-negligible gap between the augmenting numbers and/or the augmenting factors assigned to two adjacent settings. Accordingly, the cursor may move at a different, disparate fast speed when the adjustor is switched from one to the other of the active settings. Alternatively, numerous active settings may be provided at very small intervals or at least substantially continuously so that the gap between the augmenting numbers and/or factors assigned to two adjacent settings is sufficiently small. In this embodiment, the cursor may move at numerous different speeds as the adjustor moves among different settings.

The adjustor, its sensor, and/or signal processor may generate various original output signals and final output signals. As described hereinabove, such output signals are preferably pulse trains of electrical current and/or voltage pulses, where such pulse trains may include a series of square waveforms, half sinusoidal waveforms, impulse waveforms or other commonly used waveforms. In general, the pulses included in each pulse train are preferably arranged to be at least substantially similar or identical to each other so that the information processing device identifies the distance and the direction of the cursor movement from the number of pulses included in such a final output signal. Although this embodiment is commonly used in the PS/2 port of conventional cursor control devices, it is also feasible that the adjustor, its sensor, and/or its signal processor generate the output signals which may be relatively continuous electrical signals. In this alternative embodiment, the information processing device may be arranged to detect the distance and the direction of the cursor movement from various features of the electrical signals, where examples of such features may include, but not limited to, amplitudes or frequencies (e.g., as in amplitude or frequency modulation), phase angles, and the like.

The augmenting number and/or the augmenting factors may be selected depending upon the user's need and/or characteristics of the input unit, display unit, and/or information processing device. In general, the slow or manual speed may be a preset constant speed or may be one effected by the movement of the user. The fast speed is typically faster than the slow speed by a factor of, e.g., two, three, five, seven, ten, fifteen, twenty, and the like. In the alternative, the fast speed may be defined as the one which is fast enough to move the cursor to one of the edges, corners, and inner positions of the display screen within a preset duration of time, where such a duration may be less than, e.g., one second, 500 milliseconds, 300 milliseconds, 100 milliseconds, 50 milliseconds, and so on. As to the increasing speeds, its starting value may be slower than, equal to or faster than the above slow speed or manual speed. Thereafter, the speed of the cursor may increase or accelerate at a preset constant acceleration or, alternatively, such an acceleration may increase in response to the second input signal and/or its various features supplied to the adjustor by the user as described above. The cursor speed may also be arranged to increase continuously or incrementally. Based on the above characteristics, the signal processor selects and applies the appropriate augmenting number and/or factor to the original output signal to generate the final output signal effecting such a cursor speed. In contrary, the adjustor and/or its signal processor may also control the cursor speed to be a preset constant value. The adjustor and/or its signal processor may further control the speed of the cursor adaptively depending upon the distance of the target path. Accordingly, the signal processor may be arranged to augment the original output signal into the final output signal such that the cursor moves along the target distance in a preset period regardless of the length of the target distance.

In addition to the inactive and active setting, the adjustor may provide at least one subactive setting such that the user may select one of the inactive setting, active setting, and subactive setting and switch the adjustor among these settings. When the adjustor is set in the subactive setting, the signal processor of the adjustor may be arranged to attenuate the original output signal to generate the final output signal. The information processing device is then arranged to move the cursor at the slower speed which may preferably be slower than the slow speed of the inactive setting. The signal processor may attenuate the original output signal by various means. In one embodiment, the signal processor subtracts a certain number of pulses (referred to as an “attenuating number” hereinafter) from the original output signal. As long as the pulses of the original output are similar or identical, it does not matter which pulses are cut out from the original output signal. However, when the pulses of the original output signal are different, the signal processor may be arranged to delete the pulses from a specific portion of the original output signal as well. Because of such a subtraction, the final output signal has to be shorter than the original output signal, and the information processing device receives the final output signal, counts the number of pulses therein, and then moves the cursor at the slower speed. In another embodiment, the signal processor is arranged to shorten the original output signal by a certain factor (referred to as an “attenuating factor” hereinafter). More particularly, the signal processor divides the original number (i.e., the number of pulses included in the original output signal) by the attenuating factor, obtains a “ratio number,” and then generates the final output signal which includes the ratio number of pulses. In this sense, such a signal processor is deemed to subtract a number of pulses from the original output signal, where the number is determined as a difference between the original number and the ratio number. Similar to the previous embodiment, the information processing device receives such a shortened final output signal, counts the number of pulses therein, and then moves the cursor at the slower speed. Such an attenuating number and the attenuating factor may be selected similar to the augmenting number and augmenting the factor. For example, the attenuating number and/or the attenuating factor may be arranged to be a preset constant regardless of the length of the original output signal. Alternatively, the attenuating number and/or factor may be arranged to be variable and determined by the second input signal or at least one feature thereof as described in conjunction with the augmenting number and factor. Moreover, the adjustor may also generate the final output signal by attenuating various features of the original output signal, where such features may include, but not limited to, amplitudes of the pulses included in the original output signal, frequencies thereof, and phase angles thereof. Further characteristics of the signal attenuation may also be identical or at least substantially similar to those of the signal augmentation.

The hybrid cursor control system may include any number of adjustors each of which may or may not perform identical functions. In one embodiment and as shown in FIG. 6A, a single adjustor may be disposed on various locations of the cursor controller. Alternatively, the single adjustor may be incorporated into the cursor controller such that the user may move the adjustor between different settings by supplying the second input signal to at least a portion of the cursor controller. In another embodiment, such a hybrid cursor control system may also include multiple adjustors each of which may perform similar or identical functions. Such adjustors may be symmetrically or asymmetrically disposed with respect to the cursor controller, may have same or different shapes and sizes, and/or may even operate according to non-identical mechanisms. For example, at least one adjustor may be fixedly disposed and include at least one of the foregoing sensors, whereas at least one another adjustor may be movably disposed and include at least one movable sensor as will be described in greater detail below. In yet another embodiment, the hybrid cursor control system may also include multiple adjustors performing different functions. For example, at least one of such adjustors may be for the inactive setting, while at least another thereof may be for the active setting. In the alternative, at least one of the adjustors may be dedicated solely to provide multiple settings for different cursor speeds such as, e.g., the slow or manual speed, fast speed, increasing speeds, faster speed, and/or slower speed as described above. In contrary, at least another of such adjustors may be dedicated solely to provide multiple settings of different cursor movement patterns such as, e.g., for moving the cursor along the target path at one or more of the foregoing speeds, for moving the cursor at least substantially directly to one of the edges, corners, and inner positions of the display screen, and the like. In yet another embodiment, multiple adjustors may further be arranged to receive and to detect different second input signals from the user regardless of whether the adjustors may have similar or different configurations, whether they may provide similar or different settings, or whether they may perform similar or different functions. Therefore, some adjustors may be fixedly disposed, whereas others may be movably disposed. Any other conventional mechanisms may further be incorporated into the adjustors as long as such mechanisms allow the user to select one of multiple settings each of which denotes the different cursor speed or movement patterns. In general, the shapes and sizes of the adjustors are not material to the scope of the present invention as far as the shapes and sizes facilitate the user to handle the adjustors.

In addition, one of multiple settings of the adjustor selected by the user may also be detected by various embodiments. First of all and as described above, the adjustor may modulate the original output signal into the final output signal, and the information processing device may move the cursor solely based on the final output signal without necessarily having to receive and analyze one of the settings selected by the user. In the alternative, the adjustor may be arranged to generate an index signal independently of the original output signal, where the index signal denotes one of the settings selected by the user. The information processing device may receive the index signal along with the original output signal, identify the selected setting, and process such an original output signal based on the selected setting. Therefore, such an information processing device is arranged to replace the signal processor of the adjustor and, therefore, requires additional software and/or hardware in order to perform the functions of the signal processor described herein. The adjustor of this embodiment, however, may not require the signal processor and may not have to convert the original output signal into the final output signal. In another alternative, the adjustor may be arranged to generate such an index signal and incorporate such an index signal to the original output signal. For example, such an index signal may be appended at the end of the original output signal, placed in front of the original output signal, and/or inserted into the original output signal. The information processing device may locate the index signal, analyze the original output signal, and move the cursor along the target path determined by the original output signal at the speed determined by the index signal. In yet another alternative, the adjustor may also generate the final output signal by modulating at least one feature of the original output signal, where such features may include, but not be limited to, the amplitudes, frequencies, and phase angles of the original output signal. In particular, the adjustor may increase (or unalter) the amplitudes or frequencies of the signal when the user selects the active (or inactive) setting. The information processing device receives the final output signal, extracts the information leading to the selected setting, identifies the selected setting, and then demodulates the final output signal to extract the original output signal. The device then moves the cursor along the target path determined by the original output signal at the speed determined by the selected setting.

The hybrid cursor control system may also include at least one selection mechanism similar to those described hereinabove. For example, one or both selectors may be incorporated in various locations on the hybrid cursor control system. All or at least some functions of the selectors may be incorporated into the adjustor and/or curse controller so that, e.g., multiple clicking of the adjustor or holding down the adjustor for a period longer than a preset threshold may allow the user to perform to select the graphical object, hot spot or command and/or to perform a preset operation associated therewith. In addition, multiple tapping, touching, pushing, or pressing with a stronger force or for a longer period may also select such an object, spot or command and/or perform the operation.

In yet another aspect of this invention, a hybrid cursor control system may also be comprised of at least one cursor control member and at least one variable range adjustor, in which the adjustor includes a movable part which may be arranged to receive an input signal from the user by detecting a movement of such a movable part. FIG. 6B is a schematic diagram of an exemplary embodiment of a hybrid cursor control system including a mouse-type cursor control member and an exemplary movable adjustor according to the present invention, where such an exemplary hybrid cursor control system 610 includes a cursor controller 710 and an adjustor 810.

The cursor controller 710 of such a hybrid system 610 is similar or identical to a conventional cursor control device such as, e.g., a ball mouse-type controller or an optical mouse-type controller. Accordingly, the cursor controller 710 of FIG. 6B is identical or at least substantially identical to that of FIG. 6A. The adjustor 810 of the hybrid system 610 is also similar to that of FIG. 6A, except that the adjustor 810 does not include any sensor exposed through the body 704 of the cursor controller 710. Rather, such an adjustor 810 includes a movable knob 812 which is disposed on the side 702 of cursor controller 710 and arranged to be pushed into and recoiled out along a direction normal to such a side 702. The movable knob 812 is disposed in a location easily accessible by the user such as his or her thumb, middle finger, and the like. The adjustor 810 also includes the signal processor (not shown in the figure) which is identical or at least substantially similar to that of FIG. 6A. Such an adjustor 810 operatively couples with the cursor controller 710 and receives the original output signal therefrom. The adjustor 810 further has at least one inactive setting (or fine setting) and at least one active setting (or coarse setting), and is arranged to move or operate between such settings.

The movable knob 812 generally includes at least one sensor (not shown in the figure) which is arranged to receive the second input signal supplied by the user and to engage one of the inactive and active settings for the user based upon the user's second input signal. Depending upon various characteristics of the sensor, the user may apply the second input signal by, e.g., moving, displacing, pressing, pushing, rotating, turning, swiveling or clicking at least a portion of the movable knob 812. In general, the movable knob 812 employs the same sensor as the one described in FIG. 6A, where examples of such a sensor may include, but not limited to, an optical sensor for detecting a presence and/or an absence of the body part of the user thereover, a capacitance sensor to monitor a change in its capacitance, a resistance sensor to sense a change in its resistance, a motion sensor to detect a movement of the body part thereacross, a force transducer for monitoring an external force applied thereto, a deformation sensor to monitor one-, two-, and/or three-dimensional deformations thereof, and the like. When the second input signal is not applied to the adjustor 810, the movable knob 812 is arranged to be positioned in its neutral position and to be inactive or deactivated, and the adjustor 810 is arranged to be in the inactive setting. To the contrary, when the user applies the second input signal to the adjustor 810, the movable knob 812 is displaced from its neutral position and arranged to be active or activated, and the adjustor 810 is arranged to be in the active setting. After receiving the original output signal from the cursor controller 710, the signal processor of such an adjustor 810 assesses the number of current and/or voltage pulses and to generate the final output signal based upon the setting selected by the user as described hereinabove. The information processing device receives the final output signal and moves the cursor 18 on the display screen 10 at one of the slow or manual speed, fast speed, increasing speeds, faster speed, and slower speed and/or may move the cursor 18 directly to one of the edges, corners, and inner positions of the display screen 10.

The hybrid cursor control system 610 of the present invention offers the same benefits as the one shown in FIG. 6A. For example, the adjustor 810 is spaced apart from the cursor controller 710 so that the user can access them independently or in any order and that the user does not need to move the cursor controller along a preset distance to control the speed of the cursor 18. The hybrid cursor control system 610 also provides separate elements to control the movement of the cursor 18 (i.e., cursor controller 710) and to control the speed of the cursor 18 (i.e., the adjustor 810), thereby allowing the user to control the cursor movement without having to control the cursor speed and/or to control the cursor speed without having to control the cursor movement. The cursor controller 710 is also arranged to generate the original output signal representing the cursor movement direction at the preset cursor speed, thereby facilitating development of the hardware and/or software to analyze and process the original output signal. The hybrid cursor control system 610 can be implemented to new or used current cursor control devices, without any specific drivers or without having to modify the operation systems of the computers. The hybrid cursor control system 610 also allows the user to move the cursor controller 710 on the surface along the same distance but to move the cursor 18 on the display screen along different distances based on the setting selected by the user. Moreover, the movable knob 812 of the adjustor 810 may be arranged to supply the user with a distinct tactile sense so that the user may be aware of which setting the adjustor 810 is in while moving the cursor 18 on the display screen 10.

Modifications and variations of the foregoing exemplary cursor control systems and methods of FIG. 6B fall within the scope of the present invention. First, various hybrid cursor control systems may be provided by incorporating the adjustor of the present invention to other conventional cursor control devices such as, e.g., a touch pad-type controller, a joystick-type controller, a track ball-type controller, a disk-type controller, a key-type controller, and so on. Second, the adjustor may include at least one of the foregoing elastic units. When the adjustor is in the inactive setting, the movable knob is in its neutral position in which the elastic units are in a static equilibrium. When the movable knob is moved to the active or subactive setting in response to the second input signal from the user, the elastic units are perturbed from their equilibrium and begin to exert the recoiling force to the knob. When the user stops to supply the second input signal, the elastic units recoil and bias the movable knob to its neutral position. When desirable, the adjustor may also include at least one viscous unit to minimize oscillation of the adjustor, thereby switching the adjustor back to its inactive setting and maintaining the adjustor therein until the user supplies the next second input signal.

In addition, the movable knob of the adjustor may be shaped and sized according to various embodiments. In one embodiment, such a movable knob may include a toggling mechanism so that the user may switch the adjustor from one to the other setting by repeatedly pushing or pressing the movable knob in an alternating manner. When desirable, the toggling mechanism may include more than two settings so that the user may switch the settings of the adjustor, e.g., between the inactive, active, and subactive settings and/or between the inactive setting and multiple active (or subactive) settings. The adjustor may preferably include the foregoing elastic units to bias the movable knob to its neutral position, therefore biasing the adjustor to its inactive setting. In another embodiment, the movable knob may be arranged to move between multiple locations each of which is associated with different settings so that moving the knob to the left, middle, and right render the adjustor engage the subactive, inactive, and active settings, respectively. The adjustor may include the foregoing elastic units for the same reasons as well. In yet another embodiment, the movable knob may be arranged to rotate continuously or at intervals such that the user can control the cursor speeds by turning the knob in a clockwise or counter-clockwise direction. In any of the foregoing embodiments, one of the multiple settings of the adjustor may be arranged to displace the cursor directly to one of the edges, corners, and inner positions on the display screen at the fast or faster speed or instantaneously. In all of such embodiments, the adjustor may also be arranged to allow the movable knob to move in at least one preset direction. For example, such a movable knob may be arranged to be in an elevated position and depressed position when the adjustor is in the inactive setting and active (or subactive) setting, respectively. In the alternative, the movable knob may be rotated, turned or pushed along one angular direction to switch the adjustor to its active (or subactive) setting, and recoiled back to its neutral position to return the adjustor to its inactive setting.

The movable knob of the adjustor may be shaped and/or sized to facilitate the user to readily apply the second input signal thereto. Such a movable knob may form at least one handle thereon with which the user may readily move the movable knob to switch the settings of the adjustor. In the alternative, the movable knob may form at least one protrusion and/or groove thereon to provide the user with a better grip and to move the adjustor to an intended setting. In addition, various parts of the movable knob of the adjustor and/or the cursor controller may also be formed convex or concave to easily receive the second input signal. In addition to the foregoing modifications and variations of the exemplary cursor control systems and methods of FIG. 6B, other configurational details and/or operational characteristics of such a hybrid cursor control system of FIG. 6B are identical or at least substantially similar to those of FIG. 6A.

In yet another aspect of this invention, a hybrid cursor control system may also be comprised of at least one cursor control member and multiple variable range adjustors, in which each adjustor includes a movable part which may be arranged to receive an input signal from the user by detecting a movement of such a movable part. FIG. 6C is a schematic diagram of an exemplary embodiment of a hybrid-type cursor control system having a touch pad-type cursor control member and a pair of exemplary adjustors according to the present invention. As shown in the figure, an exemplary hybrid cursor control system 620 includes a cursor controller 720 as well as a pair of adjustors 820A, 820B disposed on each side of the cursor controller 720 substantially symmetrically. The cursor controller 720 is generally a conventional touch pad-type controller, and the adjustors 820A, 820B are identical or at least substantially similar to those of FIGS. 6A and 6B. Therefore, configurational details and/or operational characteristics of such a hybrid cursor control system of FIG. 6C are identical or at least substantially similar to those of FIGS. 6A and 6B.

In yet another aspect of this invention, a hybrid cursor control system may also be comprised of at least one cursor control member and at least one variable range adjustor, in which the adjustor includes a movable part which may be arranged to receive an input signal from the user by detecting a movement of such a movable part. FIG. 6D is a schematic diagram of an exemplary embodiment of a hybrid-type cursor control system with a joystick-type cursor control member and an exemplary adjustor incorporated to an input unit according to the present invention. As shown in the figure, an exemplary hybrid cursor control system 630 includes a cursor controller 730 disposed on a far-right upper corner of a wireless keyboard 50 and an adjustor 830 disposed on a far-left upper corner of the keyboard 50. The cursor controller 730 is in essence a miniature joystick-type controller, and the adjustor 830 is identical or at least substantially similar to those of FIGS. 6A through 6C. Therefore, congifurational details and/or operational characteristics of such a hybrid cursor control system of FIG. 6D are identical or at least substantially similar to those of FIGS. 6A through 6C.

Modifications and/or variations of the foregoing cursor control systems (including both of the composite cursor control systems and the hybrid control systems) may further fall within the scope of the present invention.

The composite cursor control system as well as the hybrid cursor control system may employ various operation mechanisms for activating or deactivating the fine controller and coarse controller of the composite cursor control system and for switching the adjustor between multiple settings and activating or deactivating the cursor controller of the hybrid cursor control system. For example, the fine controller of the hybrid system and/or the cursor controller of the hybrid system may be activated upon receiving the first input signal from the user, and then deactivated when the user stops to apply such a first signal. Similarly, the coarse controller of the composite system and/or the adjustor of the hybrid system may also be activated upon receiving the second input signal from the user, and then deactivated when the user ceases to apply the second signal. In addition to the exemplary first and second input signals and their features which have been described hereinabove, other features may be used to activate and deactivate the foregoing controllers and/or adjustor (all collectively referred to as “components”) of the composite and hybrid systems. For example, such components may be activated upon immediately receiving the first input signals or in a period after receiving the first input signals. The components may also be arranged to be activated only when at least one feature of the first input signal exceeds a threshold but without necessarily having to move at least a portion of the controller and/or adjustor. For example, such a controller and/or adjustor may be activated when the magnitude of the external force exceeds a certain value, when the displacement of at least a portion of such a controller and/or adjustor exceeds a minimum distance in a horizontal or vertical direction, when the stationary sensor of the controller and/or adjustor senses the area of contact or obstruction larger than a threshold area, when the first input signal is applied for a period longer than a threshold, when such a first input signal is applied consecutively or more than once within a threshold period, and so on. Once activated, the foregoing components may be arranged to remain activated until the user applies another first input signal to the same or different component. During such an activated period, the information processing device may move the cursor at one of the slow or manual speed, the fast speed, the faster speed, increasing speeds, and slower speed and/or may move the cursor directly to one of the edges, corners, and inner positions of the display screen. In this embodiment, the information processing device continues to move the cursor across the display screen even after the user ceases to apply the first and/or second input signals to one or more of the components. In the alternative, the components may be arranged to remain activated as long as the user maintains to apply such a first signal thereto. For example, the user may continue to move the cursor at one of the foregoing speeds, e.g., by continuing to exert the force to at least one of such components, by maintaining a minimum displacement of at least a portion of the component from its neutral position, by continuing to position an article or the body part of the adjacent to the sensor of the component, and so on.

As described above, the fine and coarse controllers and/or the cursor controller and adjustor may be incorporated into any conventional cursor control devices such as, e.g., the touch pad-type controllers, track ball-type controllers, joystick-type controllers, ball or optical mouse-type controllers, key-type controllers, disk-type controllers, and other devices specifically applied to various industrial equipment. Therefore, the foregoing coarse controllers and/or adjustors exemplified in the context of a particular conventional cursor control device may readily be applied to the foregoing conventional cursor control devices without departing from the scope of the present invention. For example, the touch pad-type coarse controllers of FIGS. 2A, 2B, and 3A to 3G may be incorporated into the track ball-type controllers of FIGS. 5A through 5D and/or joystick-type controllers which are not illustrated with figures but function at least substantially similar to the joystick-type controllers, except that the handles of such controllers is to be swiveled around their neutral upright positions. It is appreciated that the cursor control systems of the present invention may also employ multiple (identical, similar or different) conventional cursor control devices as multiple fine controllers and/or cursor controllers. In the alternative, multiple conventional cursor control devices may be used, where one conventional device is used as a fine controller or cursor controller, whereas the other conventional device is used with or without modification as a coarse controller or adjustor. It is also appreciated that the cursor control system of the present invention can also be equally applied to the conventional cursor control devices whether they are coupled to the input unit and/or the information processing device through a cable or wirelessly. When desirable, the cursor control system of the present invention may also be implemented directly to the conventional input unit such as a keyboard which is connected to the information processing device through a cable or wirelessly.

The cursor control system of the present invention is typically provided as a combination of a hardware and a software. The hardware of the cursor control system is generally implemented into the input unit of the information processing device (except those embodiments involving peripheral devices such as mouses), where several exemplary aspects and embodiments of such a hardware have been disclosed herein. The software of the cursor control system is desirably implemented into the information processing device such as, e.g., its processor, where some features of the software have been disclosed herein, e.g., as various steps of related methods of controlling the movement patterns and/or speeds of the cursor. In particular, the software includes various emulation control algorithms to effect various speeds and/or movement patterns of the cursor. In addition, the cursor control system of this invention may be incorporated during the manufacturing processes of the new information processing devices or, alternatively, may be retrofit into existing information processing devices by installing the software followed by hooking up the hardware thereto. When applicable, the software of the cursor control system may be implemented into the hardware thereof so that the cursor control system may be operated without having to negotiate with the processors and/or preexisting software of the information processing device.

The cursor control system of the present invention may further be arranged to perform other auxiliary functions. For example, the system may include a memory to store coordinate information provided by the user. This embodiment allows the user to move the cursor to at an intended position (e.g., the target position) and to store the x- and y-coordinates of the position. Thereafter, the user may jump to such a position regardless of the current position of the cursor by activating a desirable switch. The cursor control system may also be arranged to include zoom capabilities such that the user may zoom in or zoom out the information displayed on the display screen. By combining such zooming capabilities with the speed control capabilities of the coarse controller or adjustor, the user can move and position the cursor more conveniently and more accurately in the target position. The cursor control system may also be provided with tactile capabilities to make sounds and/or to allow the user to feel different senses as the cursor moves across variable graphical objects on the display screen such as, e.g., icons, borders thereof, hot spots, commands, characters, figures, and the like. This embodiment generally allows the user to better recognize the movement of the cursor as well as to more precisely move the cursor on the display screen. As described above, the cursor control system of the present invention may readily be applicable to move and to position the cursor in the target position in the three-dimensional display environment. When desirable, such a cursor control system may also include a power supply capable of supplying electrical energy thereto for a preset period of time. When the cursor control system of the present invention is incorporated to wireless cursor control devices or wireless input units, the system may include a wake-up function in order to save the electrical energy.

It is appreciated that, while the present invention has been described in conjunction with the detailed description thereof, the description herein is intended to illustrate and not to limit the scope of the present invention. It is also appreciated that the present invention is defined by the following claims, with equivalents of such claims to be included herein. Thus, other aspects, embodiments, advantages, and/or modifications are also within the scope of the following claims.

What is claimed is:

1. A cursor control system capable of moving at least one cursor at a plurality of speeds along a target path to a target position, wherein said cursor, target path, and target position are defined on a display screen of a display unit of an information processing device, and wherein said target position and target path are selected on said display screen by an user of said information processing device, said cursor control system comprising:
at least one cursor controller which is configured to receive at least one first input signal from said user and to generate at least one original output signal in response to said first input signal; and
at least one adjustor which is configured to have at least two settings, to receive said original output signal from said cursor controller, to receive at least one second input signal provided by said user independently from said first input signal to select one of said settings, to process said original output signal based on said one of said settings selected by said user, and to generate at least one final output signal based on said original output signal and said one of said settings selected by said user,
wherein said information processing device is configured to receive said final output signal from said adjustor and to move said cursor on said display screen at one of said of speeds based on said final output signal.

2. The system of claim 1, wherein said cursor controller includes one of a mouse-type controller, a touch pad-type controller, a track ball-type controller, a key-type controller, a disk-type controller, and a joystick-type controller.

3. The system of claim 1, wherein said adjustor is spaced apart from said cursor controller.

4. The system of claim 1, wherein said adjustor has at least one sensor which is configured to detect said second input signal applied by said user, wherein said adjustor is configured to be in an inactive setting when said sensor does not detect said second input signal and to generate said final output signal which is unaugmented and at least substantially identical to said original output signal, wherein said adjustor is configured to be in an active setting when said sensor detects said second input signal and to generate said final output signal which is augmented compared with said original output signal, and wherein said information processing device is configured to move said cursor at a slow speed in response to said unaugmented final output signal and configured to move said cursor at a fast speed in response to said augmented final output signal.

5. The system of claim 4, wherein said second input signal is at least one of a movement of at least a portion of said adjustor, at least one of a mechanical, electrical, and magnetic contact with a portion of said adjustor, an external force applied to at least a portion of said adjustor, a deformation of at least a portion of said adjustor, a change in at least one of a mechanical, chemical, electrical, magnetic, and optical property of at least a portion of said adjustor, at least one of presence and an absence of an article adjacent at least a portion of said adjustor, one of a displacement, speed, and acceleration of said movement, and light rays impinging upon at least a portion of said adjustor.

6. The system of claim 4, wherein said slow speed is one of a manual speed effected by said user and a preset constant speed.

7. The system of claim 6, wherein said slow speed is said preset constant speed and wherein said fast speed is at least twice as fast as said slow speed.

8. The system of claim 6, wherein said slow speed is said manual speed of which a nominal value is defined as a nominal speed to move said cursor from a current position of said cursor near a lower right corner of said display screen precisely to said target position near an upper left corner of said display screen using said cursor controller in said inactive setting.

9. The system of claim 4, wherein said adjustor is configured to adjust a movement pattern of said cursor on said display screen.

10. The system of claim 9, wherein said adjustor is configured to augment said original output signal to said augmented final output signal to a preset extent and wherein said device is configured to move said cursor at a preset constant fast speed regardless of a period of time during which said input signal is applied to said sensor.

11. The system of claim 9, wherein said adjustor is configured to augment said original output signal to said augmented final output signal to an extent enough to move said cursor to one of edges, corners, and inner positions of said display screen within a preset duration.

12. The system of claim 11, wherein said adjustor is configured to augment said original output signal to said augmented final output signal in proportion to a period of time during which said input signal is applied to said sensor.

13. The system of claim 11, wherein said adjustor is configured to augment said original output signal one of continuously and incrementally in proportion to said period of time.

14. The system of claim 4, wherein said sensor is configured to engage said adjustor into said active setting upon detecting a body part of said user therearound.

15. The system of claim 1, wherein said adjustor is configured to be moved between at least one inactive setting and at least one active setting and wherein said original output signal has an original number of pulses of at least one of electrical currents and voltages.

16. The system of claim 15, wherein said adjustor in its inactive setting is configured to not alter said original output signal, to generate said final output signal identical to said original output signal, and to allow said information processing device to move said cursor at a slow speed on said display screen, and wherein said adjustor in its active setting is configured to modulate one of a number of said pulses, amplitudes of said pulses, and frequencies of said pulses of said original output signal, to generate said final output signal that is different from said original output signal, and to allow said information processing device to move said cursor at a fast speed on said display screen.

17. The system of claim 16, wherein said adjustor is configured to modulate said original output signal at least one of by adding thereto an augmenting number of said pulses and generating said final output signal having said original number plus said augmenting number of said pulses therein and by multiplying an augmenting factor thereto and generating said final output signal having a total number of said pulses which equals to a product of said original number and said augmenting factor.

18. The system of claim 17, wherein one of said augmenting number and said augmenting factor is one of a preset constant and a variable which is determined at least partly based on said second input signal.

19. A cursor control system capable of moving at least one cursor at a plurality of speeds along a target path to a target position, wherein said cursor, target path, and target position are defined on a display screen of a display unit of an information processing device, and wherein said target position and target path are selected on said display screen by an user of said information processing device, said cursor control system comprising:
at least one cursor controller which is configured to receive at least one first input signal from said user and to generate at least one original output signal in response to said first input signal;
at least one adjustor which is configured to have at least two settings, to receive said original output signal from said cursor controller, to receive at least one second input signal provided by said user independently from said first input signal to select one of said settings, to process said original output signal based on said one of said settings selected by said user, and to generate at least one final output signal based on said original output signal and said one of said settings selected by said user; and
at least one emulator which is configured to receive said final output signal from said adjustor and to move said cursor on said display screen for said display unit of information processing device at one of said of speeds at least partly based on said final output signal.

20. A cursor control system capable of moving at least one cursor defined on a display screen of a display unit for an information processing device along a target path defined on said display screen and selected by an user of said device, said cursor control system comprising:
at least one adjustor configured provide at least two settings for at least one of speeds and movement patterns of said cursor; and
at least one cursor controller configured to operatively couple with said adjustor and to move said cursor in at least one of different speeds and different movement patterns at least partly based on one of said settings of said adjustor selected by said user,
wherein both of said adjustor and cursor controller are disposed to be accessed by said user independently.
